(19) United States
(12) Patent Application Publication
(10) Pub. No.: US 2026/0099031 A1
(43) Pub. Date: Apr. 9, 2026

(54) PHOTOGRAPHY OPTICAL SYSTEM AND IMAGE CAPTURING UNIT

(71) Applicant: LARGAN INDUSTRIAL OPTICS CO., LTD., Taichung City (TW)

(72) Inventors: Jih Chung HUANG, Taichung City (TW); Yu-Han SHIH, Taichung City (TW)

(73) Assignee: LARGAN INDUSTRIAL OPTICS CO., LTD., Taichung City (TW)

(21) Appl. No.: 18/968,701

(22) Filed: Dec. 4, 2024

(30) Foreign Application Priority Data
Oct. 9, 2024 (TW) 113138391

(51) Int. Cl. G02B 9/64; G02B 7/10; G02B 13/00; G02B 13/02

(52) U.S. Cl. CPC G02B 9/64; G02B 7/10; G02B 13/0045; G02B 13/02

(57) ABSTRACT

A photography optical system sequentially includes a first lens assembly, an aperture stop, and a second lens assembly. The first lens assembly has a total number of lens elements being one to three and includes a first lens element closest to an object side. The second lens assembly has a total number of lens elements being five to eight and includes a last lens element closest to an image side. The photography optical system further includes second through fifth lens elements between the first lens element and the last lens element. The first lens assembly has positive refractive power, and the second lens assembly has negative refractive power. The second lens element has an object-side surface being convex in a paraxial region thereof. The third lens element has an object-side surface being convex in a paraxial region thereof and an image-side surface being concave in a paraxial region thereof.

### RELATED APPLICATIONS

This application claims priority to Taiwan Application 113138391, filed on Oct. 9, 2024, which is incorporated by reference herein in its entirety.

### BACKGROUND

### Technical Field

The present disclosure relates to a photography optical system and an image capturing unit, more particularly to a photography optical system applicable to an image capturing unit.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, a photography optical system includes, in order from an object side to an image side along an optical path, a first lens assembly, an aperture stop and a second lens assembly. Each lens element of the photography optical system has an object-side surface facing toward the object side and an image-side surface facing toward the image side.

Preferably, the total number of lens elements of the first lens assembly is one to three. Preferably, the total number of lens elements of the second lens assembly is five to eight. Preferably, there is no additional lens element disposed between the first lens assembly and the second lens assembly.

Preferably, the first lens assembly includes a first lens element closest to the object side. Preferably, the second lens assembly includes a last lens element closest to the image side. Preferably, the photography optical system further comprises, in order from the first lens element to the last lens element along the optical path, a second lens element, a third lens element, a fourth lens element and a fifth lens element, and there is no additional lens element disposed between the first lens element and the fifth lens element.

Preferably, the first lens assembly has positive refractive power. Preferably, the second lens assembly has negative refractive power.

Preferably, the object-side surface of the first lens element is convex in a paraxial region thereof. Preferably, the object-side surface of the second lens element is convex in a paraxial region thereof. Preferably, the object-side surface of the third lens element is convex in a paraxial region thereof. Preferably, the image-side surface of the third lens element is concave in a paraxial region thereof. Preferably, at least one of the fifth lens element and a sixth lens element counting from the object side among the photography optical system is a negative lens element.

When a focal length of the photography optical system when corresponding to an infinite object distance is fL, a focal length of i-th lens element counting from the object side among the photography optical system is fi, a minimum value of fL/fi is MIN (fL/fi), a curvature radius of the object-side surface of the third lens element is R5, a curvature radius of the image-side surface of the third lens element is R6, a maximum value among axial distances between each of all adjacent lens elements of the photography optical system when corresponding to the infinite object distance is ATLmax, and a maximum image height of the photography optical system is ImgH, the following conditions are preferably satisfied:
−13.80<MIN (fL/fi)<−3.80, wherein i is a positive integer, and 1≤i≤the total number of lens elements of the photography optical system;

$$0 < ( R 5 + R 6 ) / fL < 3.5 ; and$$

$$1. < AT L max / Img H < 6. .$$

According to another aspect of the present disclosure, a photography optical system includes, in order from an object side to an image side along an optical path, a first lens assembly, an aperture stop and a second lens assembly. Each lens element of the photography optical system has an object-side surface facing toward the object side and an image-side surface facing toward the image side.

Preferably, the total number of lens elements of the first lens assembly is one to three. Preferably, the total number of lens elements of the second lens assembly is five to eight. Preferably, there is no additional lens element disposed between the first lens assembly and the second lens assembly.

Preferably, the first lens assembly includes a first lens element closest to the object side. Preferably, the second lens assembly includes a last lens element closest to the image side. Preferably, the photography optical system further comprises, in order from the first lens element to the last lens element along the optical path, a second lens element, a third lens element, a fourth lens element and a fifth lens element, and there is no additional lens element disposed between the first lens element and the fifth lens element.

Preferably, the first lens assembly has positive refractive power. Preferably, the second lens assembly has negative refractive power.

Preferably, the object-side surface of the first lens element is convex in a paraxial region thereof. Preferably, the object-side surface of the second lens element is convex in a paraxial region thereof. Preferably, the object-side surface of the third lens element is convex in a paraxial region thereof. Preferably, the image-side surface of the third lens element is concave in a paraxial region thereof. Preferably, the object-side surface of the fourth lens element is convex in a paraxial region thereof.

When a focal length of the photography optical system when corresponding to an infinite object distance is fL, a focal length of i-th lens element counting from the object side among the photography optical system is fi, a minimum value of fL/fi is MIN (fL/fi), a focal length of the first lens assembly is fA1, a maximum value among central thicknesses of all lens elements of the photography optical system is CTmax, and a maximum value among axial distances between each of all adjacent lens elements of the photography optical system when corresponding to the infinite object distance is ATLmax, the following conditions are preferably satisfied:
−15.00<MIN (fL/fi)<−2.80, wherein i is a positive integer, and 1≤i≤the total number of lens elements of the photography optical system;

$$1.2 < fL / fA 1 < 3. ; and$$

$$0.2 < CT max / ATL max < 1.5 .$$

According to another aspect of the present disclosure, a photography optical system includes a plurality of lens elements. Preferably, the total number of the plurality of lens elements is eight to nine. Preferably, the plurality of lens elements includes, in order from an object side to an image side along an optical path, a first lens element, a second lens element, a third lens element, a fourth lens element, a fifth lens element, a sixth lens element, a seventh lens element and an eighth lens element, and each lens element of the plurality of lens elements having an object-side surface facing toward the object side and an image-side surface facing toward the image side.

Preferably, the first lens element is a lens element closest to the object side among all lens elements of the photography optical system. Preferably, there is no additional lens element disposed between the first lens element through the eighth lens element.

Preferably, the first lens element has positive refractive power. Preferably, the object-side surface of the second lens element is convex in a paraxial region thereof. Preferably, the object-side surface of the third lens element is convex in a paraxial region thereof. Preferably, the image-side surface of the third lens element is concave in a paraxial region thereof. Preferably, the object-side surface of the fourth lens element is convex in a paraxial region thereof.

Preferably, the photography optical system further includes an aperture stop located between the first lens element and the fourth lens element.

When a focal length of the photography optical system when corresponding to an infinite object distance is fL, a focal length of i-th lens element counting from the object side among the photography optical system is fi, a minimum value of fL/fi is MIN (fL/fi), a focal length of the second lens element is f2, a curvature radius of the object-side surface of the third lens element is R5, a curvature radius of the object-side surface of a first lens element counting from the image side among the photography optical system is Rlast2, and half of a maximum field of view of the photography optical system when corresponding to the infinite object distance is HFOVL, the following conditions are preferably satisfied:
−13.80<MIN (fL/fi)<−3.80, wherein i is a positive integer, and 1≤i≤the total number of lens elements of the photography optical system;

$$- 1. < R 5 / Rlast 2 < 4.5 ;$$

$$- 1.5 < fL / f 2 < 4.5 ; and$$

$$1. degrees < HFOVL < 7.5 degrees .$$

According to another aspect of the present disclosure, an image capturing unit includes one of the aforementioned photography optical systems and an image sensor, wherein the image sensor is disposed on an image surface of the photography optical system.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit at a first photography state and at a second photography state according to the 1st embodiment of the present disclosure;

FIG. 2 shows spherical aberration curves, astigmatic field curves and a distortion curve of the image capturing unit at the first photography state according to the 1st embodiment;

FIG. 3 shows spherical aberration curves, astigmatic field curves and a distortion curve of the image capturing unit at the second photography state according to the 1st embodiment;

FIG. 4 is a schematic view of an image capturing unit at a first photography state and at a second photography state according to the 2nd embodiment of the present disclosure;

FIG. 5 shows spherical aberration curves, astigmatic field curves and a distortion curve of the image capturing unit at the first photography state according to the 2nd embodiment;

FIG. 6 shows spherical aberration curves, astigmatic field curves and a distortion curve of the image capturing unit at the second photography state according to the 2nd embodiment;

FIG. 7 is a schematic view of an image capturing unit at a first photography state and at a second photography state according to the 3rd embodiment of the present disclosure;

FIG. 8 shows spherical aberration curves, astigmatic field curves and a distortion curve of the image capturing unit at the first photography state according to the 3rd embodiment;

FIG. 9 shows spherical aberration curves, astigmatic field curves and a distortion curve of the image capturing unit at the second photography state according to the 3rd embodiment;

FIG. 10 is a schematic view of an image capturing unit at a first photography state and at a second photography state according to the 4th embodiment of the present disclosure;

FIG. 11 shows spherical aberration curves, astigmatic field curves and a distortion curve of the image capturing unit at the first photography state according to the 4th embodiment;

FIG. 12 shows spherical aberration curves, astigmatic field curves and a distortion curve of the image capturing unit at the second photography state according to the 4th embodiment;

FIG. 13 is a schematic view of an image capturing unit at a first photography state and at a second photography state according to the 5th embodiment of the present disclosure;

FIG. 14 shows spherical aberration curves, astigmatic field curves and a distortion curve of the image capturing unit at the first photography state according to the 5th embodiment;

FIG. 15 shows spherical aberration curves, astigmatic field curves and a distortion curve of the image capturing unit at the second photography state according to the 5th embodiment;

FIG. 16 is a schematic view of an image capturing unit at a first photography state and at a second photography state according to the 6th embodiment of the present disclosure;

FIG. 17 shows spherical aberration curves, astigmatic field curves and a distortion curve of the image capturing unit at the first photography state according to the 6th embodiment;

FIG. 18 shows spherical aberration curves, astigmatic field curves and a distortion curve of the image capturing unit at the second photography state according to the 6th embodiment;

FIG. 19 is a schematic view of an image capturing unit at a first photography state and at a second photography state according to the 7th embodiment of the present disclosure;

FIG. 20 shows spherical aberration curves, astigmatic field curves and a distortion curve of the image capturing unit at the first photography state according to the 7th embodiment;

FIG. 21 shows spherical aberration curves, astigmatic field curves and a distortion curve of the image capturing unit at the second photography state according to the 7th embodiment;

FIG. 22 is a schematic view of an image capturing unit at a first photography state and at a second photography state according to the 8th embodiment of the present disclosure;

FIG. 23 shows spherical aberration curves, astigmatic field curves and a distortion curve of the image capturing unit at the first photography state according to the 8th embodiment;

FIG. 24 shows spherical aberration curves, astigmatic field curves and a distortion curve of the image capturing unit at the second photography state according to the 8th embodiment;

FIG. 25 is a schematic view of an image capturing unit at a first photography state and at a second photography state according to the 9th embodiment of the present disclosure;

FIG. 26 shows spherical aberration curves, astigmatic field curves and a distortion curve of the image capturing unit at the first photography state according to the 9th embodiment;

FIG. 27 shows spherical aberration curves, astigmatic field curves and a distortion curve of the image capturing unit at the second photography state according to the 9th embodiment;

FIG. 28 is a schematic view of an image capturing unit at a first photography state and at a second photography state according to the 10th embodiment of the present disclosure;

FIG. 29 shows spherical aberration curves, astigmatic field curves and a distortion curve of the image capturing unit at the first photography state according to the 10th embodiment;

FIG. 30 shows spherical aberration curves, astigmatic field curves and a distortion curve of the image capturing unit at the second photography state according to the 10th embodiment;

FIG. 31 is a schematic view of an image capturing unit at a first photography state and at a second photography state according to the 11th embodiment of the present disclosure;

FIG. 32 shows spherical aberration curves, astigmatic field curves and a distortion curve of the image capturing unit at the first photography state according to the 11th embodiment;

FIG. 33 shows spherical aberration curves, astigmatic field curves and a distortion curve of the image capturing unit at the second photography state according to the 11th embodiment;

FIG. 34 is a perspective view of an image capturing unit according to the 12th embodiment of the present disclosure;

FIG. 35 is one perspective view of an electronic device according to the 13th embodiment of the present disclosure;

FIG. 36 is another perspective view of the electronic device in FIG. 35;

FIG. 37 is one perspective view of an electronic device according to the 14th embodiment of the present disclosure;

FIG. 38 is another perspective view of the electronic device in FIG. 37;

FIG. 39 is a block diagram of the electronic device in FIG. 37;

FIG. 40 is one perspective view of an electronic device according to the 15th embodiment of the present disclosure;

FIG. 41 is a schematic view of an electronic device according to the 16th embodiment of the present disclosure;

FIG. 42 shows a schematic view of YLIR1, YLAIRlast, YLA2R1, YL8R2, YLmin, ETL12, ETLA12, ETL3 and ETLlast of the image capturing unit at the first photography state according to the 1st embodiment of the present disclosure;

FIG. 43 shows a schematic view of CRAL of the image capturing unit at the first photography state according to the 1st embodiment of the present disclosure;

FIG. 44 shows a schematic view of a configuration of a reflective element in a photography optical system according to one embodiment of the present disclosure;

FIG. 45 shows a schematic view of another configuration of a reflective element in a photography optical system according to one embodiment of the present disclosure;

FIG. 46 shows a schematic view of further another configuration of a reflective element in a photography optical system according to one embodiment of the present disclosure;

FIG. 47 shows a schematic view of a configuration of two reflective elements in a photography optical system according to one embodiment of the present disclosure; and

FIG. 48 shows a schematic view of another configuration of two reflective elements in a photography optical system according to one embodiment of the present disclosure.

### DETAILED DESCRIPTION

In one configuration of the present disclosure, a photography optical system can include, in order from an object side to an image side along an optical path, a first lens assembly, an aperture stop and a second lens assembly. Therefore, it is favorable for specifying the location of the aperture stop so as to ensure sufficient light incident amount of the photography optical system, thereby increasing image illumination.

The total number of lens elements of the first lens assembly can be one to three, and the total number of lens elements of the second lens assembly can be five to eight. Therefore, it is favorable for providing sufficient lens number variation to improve image quality while preventing an excessive long total track length and an excessive weight of the photography optical system. Moreover, the total number of lens elements of the first lens assembly can be two. Moreover, the total number of lens elements of the second lens assembly can be at least six. Moreover, the total number of lens elements of the second lens assembly can be six. Moreover, the total number of lens elements of the photography optical system can be at least seven. Moreover, the total number of lens elements of the photography optical system can be eight. Moreover, the total number of lens elements of the photography optical system can be nine.

The first lens assembly can include a first lens element closest to the object side, the second lens assembly can include a last lens element closest to the image side, and there is no additional lens element disposed between the first lens assembly and the second lens assembly. Therefore, it is favorable for simplifying the mechanism.

The photography optical system can further include, in order from the first lens element to the last lens element along the optical path, a second lens element, a third lens element, a fourth lens element and a fifth lens element, and there is no additional lens element disposed between the first lens element and the fifth lens element.

In the photography optical system, i-th lens element counting from the object side is considered as i-th lens element, N-th lens element counting from the object side is considered as the last lens element, and i-th lens element counting from the image side is considered as (N+1−i)-th lens element, wherein N is the total number of lens elements of the photography optical system, i is a positive integer ranging from 1 to the total number of lens elements of the photography optical system (from 1 to N).

For example, when the total number of lens elements of the photography optical system is eight, a sixth lens element counting from the object side is considered as a sixth lens element, a seventh lens element counting from the object side is considered as a seventh lens element, an eighth lens element counting from the object side is considered as an eighth lens element or a last lens element, and first through eighth lens elements counting from the image side are respectively considered as eighth through first lens elements [from (8+1−1)-th lens element to (8+1−8)-th lens element, and N=8]. When the total number of lens elements of the photography optical system is nine, a sixth lens element counting from the object side is considered as a sixth lens element, a seventh lens element counting from the object side is considered as a seventh lens element, an eighth lens element counting from the object side is considered as an eighth lens element, a ninth lens element counting from the object side is considered as a ninth lens element or a last lens element, and first through ninth lens elements counting from the image side are respectively considered as ninth through first lens elements [from (9+1−1)-th lens element to (9+1−9)-th lens element, and N=9].

In another configuration of the present disclosure, the photography optical system can include a plurality of lens elements. The total number of the plurality of lens elements can be eight.

In the photography optical system, the plurality of lens elements can include, in order from an object side to an image side along an optical path, a first lens element, a second lens element, a third lens element, a fourth lens element, a fifth lens element, a sixth lens element, a seventh lens element and an eighth lens element, wherein a first lens element counting from the object side is considered as the first lens element, a second lens element counting from the object side is considered as the second lens element, a third lens element counting from the object side is considered as the third lens element, a fourth lens element counting from the object side is considered as the fourth lens element, a fifth lens element counting from the object side is considered as the fifth lens element, a sixth lens element counting from the object side is considered as the sixth lens element, a seventh lens element counting from the object side is considered as the seventh lens element, an eighth lens element counting from the object side is considered as the eighth lens element, and the eighth lens element can also be considered as a last lens element. First through eighth lens elements counting from the image side are respectively considered as the eighth lens element through the first lens element.

Moreover, the photography optical system can further include an aperture stop that can be located between the first lens element and the fourth lens element. Therefore, it is favorable for specifying the location of the aperture stop so as to ensure sufficient light incident amount of the photography optical system, thereby increasing image illumination.

In further another configuration of the present disclosure, the photography optical system can include a plurality of lens elements. The total number of the plurality of lens elements can be nine.

In the photography optical system, the plurality of lens elements can include, in order from an object side to an image side along an optical path, a first lens element, a second lens element, a third lens element, a fourth lens element, a fifth lens element, a sixth lens element, a seventh lens element, an eighth lens element and a ninth lens element, wherein a first lens element counting from the object side is considered as the first lens element, a second lens element counting from the object side is considered as the second lens element, a third lens element counting from the object side is considered as the third lens element, a fourth lens element counting from the object side is considered as the fourth lens element, a fifth lens element counting from the object side is considered as the fifth lens element, a sixth lens element counting from the object side is considered as the sixth lens element, a seventh lens element counting from the object side is considered as the seventh lens element, an eighth lens element counting from the object side is considered as the eighth lens element, a ninth lens element counting from the object side is considered as the ninth lens element, and the ninth lens element can also be considered as a last lens element. First through ninth lens elements counting from the image side are respectively considered as the ninth lens element through the first lens element.

Moreover, the photography optical system can further include an aperture stop that can be located between the first lens element and the fourth lens element. Therefore, it is favorable for specifying the location of the aperture stop so as to ensure sufficient light incident amount of the photography optical system, thereby increasing image illumination.

In the present disclosure, each lens element of the photography optical system has an object-side surface facing toward the object side and an image-side surface facing toward the image side. The first lens element can also be considered as a lens element closest to the object side among all lens elements of the photography optical system, and the last lens element can also be considered as a lens element closest to the image side among all lens elements of the photography optical system.

The first lens assembly can have positive refractive power. Therefore, it is favorable for collaborating with the location of the aperture stop so as to adjust refractive power configuration of lens elements, thereby reducing the total track length at the front end of the photography optical system.

The second lens assembly can have negative refractive power. Therefore, it is favorable for collaborating with the configuration of the aperture stop so as to adjust the focal length at the rear end of the photography optical system, thereby forming telephoto structure.

The first lens element can have positive refractive power. Therefore, it is favorable for reducing the overall size and controlling photography viewing angle. The object-side surface of the first lens element can be convex in a paraxial region thereof. Therefore, it is favorable for collaborating with application specifications, thereby adjusting light incident into the photography optical system in a proper viewing angle.

The second lens element can have positive refractive power. Therefore, it is favorable for collaborating with the refractive power of the first lens element, thereby increasing light convergence ability at the front end of the photography optical system and reducing aberrations. The object-side surface of the second lens element can be convex in a paraxial region thereof. Therefore, it is favorable for collaborating with the first lens element to correct aberrations such as spherical aberration, and it is also favorable for enlarging aperture and improving image quality.

The object-side surface of the third lens element can be convex in a paraxial region thereof. Therefore, it is favorable for providing light convergence ability on the object-side surface of the third lens element so as to achieve compactness. The image-side surface of the third lens element can be concave in a paraxial region thereof. Therefore, it is favorable for adjusting light emitting direction from the third lens element, thereby balancing optical path direction and correcting spherical aberration of the photography optical system.

The fourth lens element can have positive refractive power. Therefore, it is favorable for correcting aberrations such as spherical aberration and chromatic aberration at the front end and the rear end of the photography optical system. The object-side surface of the fourth lens element can be convex in a paraxial region thereof. Therefore, it is favorable for adjusting the refractive power of the fourth lens element for light convergence.

The fifth lens element can have negative refractive power. Therefore, it is favorable for balancing the overall refractive power configuration of the photography optical system, thereby elongating the focal length. The image-side surface of the fifth lens element can be concave in a paraxial region thereof. Therefore, it is favorable for harmonizing the direction of the optical path, thereby obtaining a proper balance between image quality and the total track length of the photography optical system.

In the photography optical system, at least one of the fifth lens element counting from the object side (the fifth lens element) and the sixth lens element counting from the object side (the sixth lens element) can be a negative lens element.

When the total number of lens elements of the photography optical system is seven or more, the seventh lens element counting from the object side (the seventh lens element) can have negative refractive power. Therefore, it is favorable for maintaining a proper back focal length while correcting field curvature.

When the total number of lens elements of the photography optical system is eight or more, the eighth lens element counting from the object side (the eighth lens element) can have positive refractive power. Therefore, it is favorable for adjusting the back focal length, and it is also favorable for increasing convergence quality of light from various fields of view onto the image surface and for correcting aberrations.

Please be noted that in the present disclosure, the focal length of a lens element or the focal length of a lens assembly is calculated based on the assumption that the medium both in the most front and the most rear of the lens element or the lens assembly is air. Moreover, the present disclosure is not limited to application light of the photography optical system; besides visible light, the photography optical system can also be applied to infrared light.

All lens elements of the photography optical system can include at least two glass lens elements and at least one plastic lens element. Therefore, it is favorable for obtaining a proper balance between the mass production possibility, temperature effect, overall size, overall weight and total cost, thereby enlarging application range of products. Moreover, all lens elements of the photography optical system can also include at least two glass lens elements and at least two plastic lens elements.

All lens elements of the photography optical system can include at least one spherical lens element and at least one aspheric lens element. Therefore, a proper selection of glass material collaborating with a selection of the spherical lens element is favorable for prevent image distortion caused by temperature effect, and a proper selection of plastic material collaborating with a selection of the aspheric lens element is favorable for correcting aberrations, reducing overall weight and being productive.

The photography optical system can perform a focus process for focusing by moving at least one lens element thereof. Therefore, it is favorable for having both telephoto and close-up photography capabilities, thereby effectively enhancing functionality of the photography optical system. Moreover, the photography optical system can also perform a focus process for focusing by moving at least one lens element of the second lens assembly.

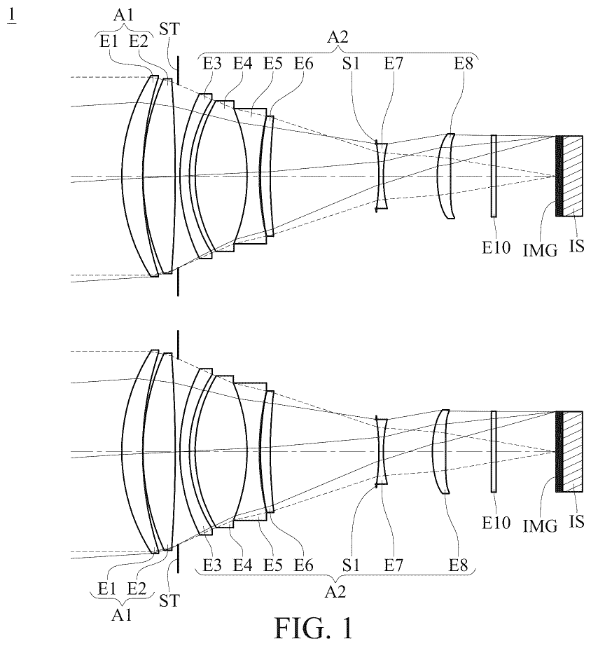

The photography optical system can have at least two photography states through the focus process. Moreover, the at least two photography states can include a first photography state corresponding to an infinite object distance and a second photography state corresponding to a finite object distance, wherein the first photography state can refer to a state of the photography optical system with an imaged object at an infinite distance (the infinite object distance), and the second photography state can refer to a state of the photography optical system with an imaged object at a finite distance (the finite object distance). Please refer to FIG. 1, which is a schematic view of an image capturing unit in which the photography optical system is respectively at a first photography state and at a second photography state according to the 1st embodiment of the present disclosure. The upper part of FIG. 1 shows the photography optical system at the first photography state, and the lower part of FIG. 1 shows the photography optical system at the second photography state.

In the present disclosure, the finite object distance can refer to a position of an imaged object which is obviously closer to the photography optical system than infinity. Moreover, the infinite object distance refers to an axial distance between an imaged object and the object-side surface of one lens element of the photography optical system closest to the object side (e.g., the first lens element) being equal to or greater than 1000 meters. Moreover, the finite object distance refers to an axial distance between an imaged object and the object-side surface of one lens element of the photography optical system closest to the object side (e.g., the first lens element) being equal to or less than 50 meters. Moreover, the finite object distance also refers to an axial distance between an imaged object and the object-side surface of one lens element of the photography optical system closest to the object side (e.g., the first lens element) being equal to or less than 15 meters (15000 millimeters).

When an imaged object at the infinite object distance moves to the finite object distance, the photography optical system can perform the focus process to change the first photography state to the second photography state thereof. Conversely, when an imaged object at the finite object distance moves to the infinite object distance, the photography optical system can also perform the focus process to change the second photography state to the first photography state thereof.

Please be noted that the first lens assembly and the second lens assembly are distinguished only by the aperture stop. Please be noted that co-movement (together moving) between any two lens elements of each of the first lens assembly and the second lens assembly during the focus process is not necessary.

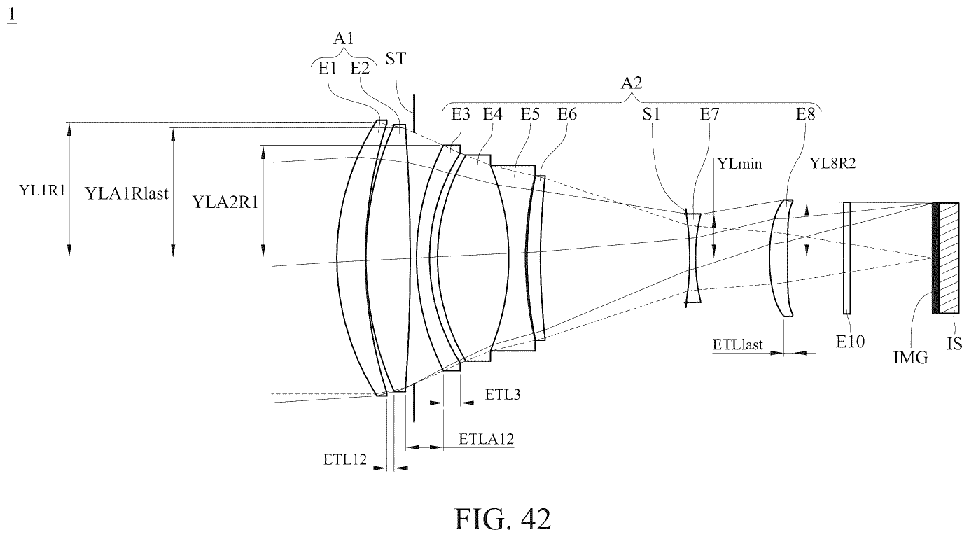

A lens element having the minimum effective radius among all lens elements of the photography optical system when corresponding to the infinite object distance can be the second lens element counting from the image side among the photography optical system or the third lens element counting from the image side among the photography optical system. Therefore, it is favorable for assisting in reducing the overall size of the photography optical system and forming an ultra-telephoto structure having an internal-focusing function. Moreover, a lens element having the minimum effective radius among all lens elements of the photography optical system when corresponding to the infinite object distance can be the second lens element counting from the image side among the photography optical system. Please refer to FIG. 42, which shows a schematic view of the minimum effective radius YLmin of the photography optical system at the first photography state according to the 1st embodiment of the present disclosure.

The maximum axial distance among axial distances between each of all adjacent lens elements of the photography optical system can be located in the second lens assembly. Therefore, it is favorable for ensuring sufficient space for moving lens elements during photography for various object distances, and it is also favorable for increasing manufacturability.

At least two adjacent lens elements of the second lens assembly can be cemented to each other. Therefore, it is favorable for reducing the size and preventing problems such as total reflection and ghost image, thereby improving image quality.

The second lens assembly can include, in order from the object side to the image side along the optical path, a convex-concave lens element, a chromatic-aberration-correction lens assembly having negative refractive power, and an aspheric lens element. Therefore, it is favorable for collaboration between lens elements so as to correct filed curvature, chromatic aberration and astigmatism at various fields of view, thereby improving light convergence quality at all fields of view. Moreover, the chromatic-aberration-correction lens assembly can consist of, in order from the object side to the image side along the optical path, a biconvex positive lens element and a biconcave negative lens element. Moreover, the chromatic-aberration-correction lens assembly at the second lens assembly is favorable for chromatic correction during photography for various object distances, thereby effectively improving image quality.

According to the present disclosure, the photography optical system can include at least one reflective element with an optical path folding function located between an imaged object and the image surface, such as a prism, a reflective mirror, etc. The reflective element can have at least one reflective surface. The optical path can be deflected at least once through the at least one reflective surface of the at least one reflective element, which is favorable for reducing the overall size, such that the photography optical system can have a deflected optical path and can be more flexible in space arrangement, and therefore the dimensions of an electronic device are not restricted by the total track length of the photography optical system, thereby reducing mechanical limitation, miniaturizing the photography optical system, and thus achieving various specification requirements.

An angle between the optical axis and the normal direction of the at least one reflective surface of the at least one reflective element is not limited to 45 degrees, but can be other angles depending on the space arrangement. The optical path along an optical axis at the object side can be redirected to an optical axis at the image side by the at least one reflective element. An angle between a vector of the optical axis at the object side and that at the image side can be any angle, but not limited to 0, 90 or 180 degrees. In addition, in order to reduce the size of the photography optical system, the length and the width of the reflective mirror may be different from each other, and the length, the width and the height of the prism may be different from one another. The surface of the at least one reflective element (e.g., the surface of the prism or the reflective mirror) can be planar, spherical, aspheric or have a freeform shape according to the optical design requirements, but the present disclosure is not limited thereto. The at least one reflective element can consist of more than one prism depending on the design requirements. The prism can be made of glass material or plastic material depending on the design requirements. In addition, the prism with optical path folding function is not one of the lens elements; that is, the prism with the optical path folding function is not included in the lens elements of the photography optical system.

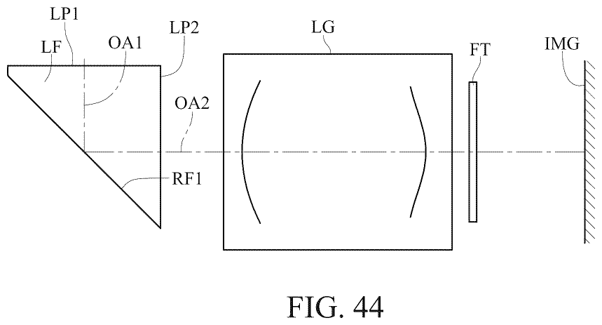

Furthermore, please refer to FIG. 44 to FIG. 46, each of which shows a schematic view of a configuration of one reflective element in a photography optical system according to one embodiment of the present disclosure. As shown in FIG. 44 to FIG. 46, the photography optical system can include, in order from an imaged object (not shown in the drawings) to an image surface IMG along a travelling direction of an optical path, a reflective element LF, a lens group LG, a filter FT and the image surface IMG. Moreover, the lens group LG can correspond to the two lens groups disclosed in the present disclosure.

In FIG. 44, the reflective element LF is a prism and has, in sequence along a travelling direction of light on the optical path, a first light passable surface LP1, a reflective surface RF1 and a second light passable surface LP2. The optical path enters the reflective element LF through the first light passable surface LP1 and reaches the reflective surface RF1 along a first optical axis OA1. The reflective surface RF1 deflects the optical path from the first optical axis OA1 to a second optical axis OA2, and the optical path then passes through the second light passable surface LP2, travels through the lens group LG and the filter FT, and ultimately arrives at the image surface IMG along the second optical axis OA2. As shown in FIG. 44, both of the first light passable surface LP1 and the second light passable surface LP2 of the reflective element LF can be planar.

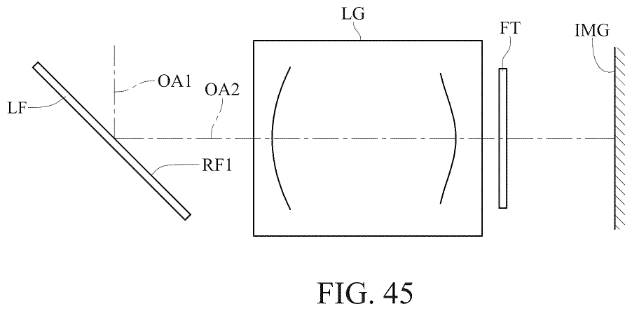

In FIG. 45, the reflective element LF is a flat reflective mirror having a reflective surface RF1. The optical path reaches the reflective surface RF1 along a first optical axis OA1. The reflective surface RF1 deflects the optical path from the first optical axis OA1 to a second optical axis OA2. Subsequently, the optical path travels through the lens group LG and the filter FT, and ultimately arrives at the image surface IMG along the second optical axis OA2.

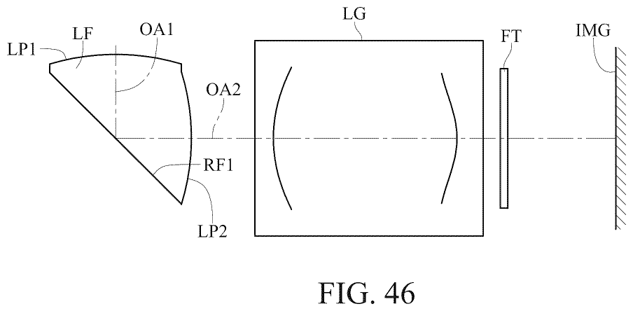

In FIG. 46, the reflective element LF is a prism and has, in sequence along a travelling direction of light on the optical path, a first light passable surface LP1, a reflective surface RF1, and a second light passable surface LP2. The optical path enters the reflective element LF through the first light passable surface LP1 and reaches the reflective surface RF1 along a first optical axis OA1. The reflective surface RF1 deflects the optical path from the first optical axis OA1 to a second optical axis OA2, and the optical path then passes through the second light passable surface LP2, travels through the lens group LG and the filter FT, and ultimately arrives at the image surface IMG along the second optical axis OA2. As shown in FIG. 46, both of the first light passable surface LP1 and the second light passable surface LP2 of the reflective element LF can be curved.

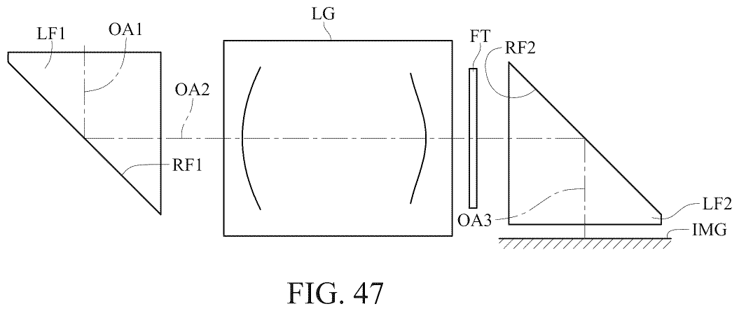

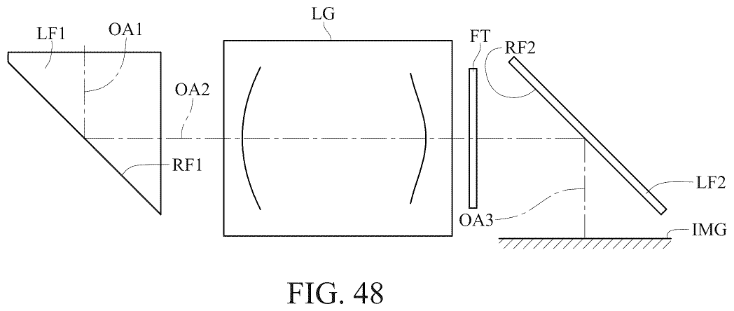

Moreover, please refer to FIG. 47 and FIG. 48, each of which shows a schematic view of a configuration of two reflective elements in a photography optical system according to one embodiment of the present disclosure. As shown in FIG. 47 and FIG. 48, the photography optical system can include, in order from an imaged object (not shown in the figures) to an image surface IMG along a travelling direction of an optical path, a first reflective element LF1, a lens group LG, a filter FT, a second reflective element LF2 and the image surface IMG. The optical path enters the first reflective element LF1 and reaches the first reflective surface RF1 along a first optical axis OA1, and the first reflective surface RF1 deflects the optical path from the first optical axis OA1 to a second optical axis OA2. The optical path travels through the lens group LG and the filter FT along the second optical axis OA2. Subsequently, the optical path enters the second reflective element LF2 and reaches the second reflective surface RF2 along the second optical axis OA2, and the second reflective surface RF2 deflects the optical path from the second optical axis OA2 to a third optical axis OA3. The optical path ultimately arrives at the image surface IMG along the third optical axis OA3. In FIG. 47, each of the first reflective element LF1 and the second reflective element LF2 can be a prism. In FIG. 48, the first reflective element LF1 and the second reflective element LF2 can be a prism and a flat reflective mirror, respectively.

When a focal length of the photography optical system when corresponding to an infinite object distance is fL, a focal length of i-th lens element counting from the object side among the photography optical system is fi, and a minimum value of fL/fi is MIN (fL/fi), the following condition can be satisfied: −15.00<MIN (fL/fi)<−2.80, wherein i is a positive integer, and 1≤i≤the total number of lens elements of the photography optical system. Therefore, adjustment to the refractive power configuration is favorable for reducing sensitivity and forming an ultra-telephoto configuration. Moreover, the following condition can also be satisfied: −13.80<MIN (fL/fi)<−3.80, wherein i is a positive integer, and 1≤i≤the total number of lens elements of the photography optical system. Moreover, the following condition can also be satisfied: −12.50<MIN (fL/fi)<−4.30, wherein i is a positive integer, and 1≤i≤the total number of lens elements of the photography optical system. Moreover, the following condition can also be satisfied: −11.70<MIN (fL/fi)<−5.00, wherein i is a positive integer, and 1<i≤the total number of lens elements of the photography optical system. Moreover, the following condition can also be satisfied: −11.51≤MIN (fL/fi)≤−5.16, wherein i is a positive integer, and 1≤i≤the total number of lens elements of the photography optical system.

When a curvature radius of the object-side surface of the third lens element is R5, a curvature radius of the image-side surface of the third lens element is R6, and the focal length of the photography optical system when corresponding to the infinite object distance is fL, the following condition can be satisfied: 0< (R5+R6)/fL<3.50. Therefore, restriction to the curvature degrees of lens shapes of the third lens element is favorable for guiding light, thereby obtaining a proper balance between the size of the aperture stop, the total track length and the long-focal-length structure. Moreover, the following condition can also be satisfied: 0.05< (R5+R6)/fL<3.00. Moreover, the following condition can also be satisfied: 0.10<(R5+R6)/fL<2.50. Moreover, the following condition can also be satisfied: 0.20< (R5+R6)/fL<1.20. Moreover, the following condition can also be satisfied: 0.32≤(R5+R6)/fL≤0.95.

When a maximum value among axial distances between each of all adjacent lens elements of the photography optical system when corresponding to the infinite object distance is ATLmax, and a maximum image height of the photography optical system (which can be half of a diagonal length of an effective photosensitive area of an image sensor) is ImgH, the following condition can be satisfied: 1.00<ATLmax/ImgH<6.00. Therefore, it is favorable for preventing excessive difficulty in assembly caused by excessive intervals of lens elements, and it is also favorable for improving the telephoto function of the photography optical system. Moreover, the following condition can also be satisfied: 1.10<ATLmax/ImgH<5.00. Moreover, the following condition can also be satisfied: 1.15<ATLmax/ImgH<4.50. Moreover, the following condition can also be satisfied: 1.20<ATLmax/ImgH<3.50. Moreover, the following condition can also be satisfied: 1.30≤ATLmax/ImgH≤3.30.

When the focal length of the photography optical system when corresponding to the infinite object distance is fL, and a focal length of the first lens assembly is fA1, the following condition can be satisfied: 1.20<fL/fA1<3.00. Therefore, it is favorable for adjusting the refractive power at the front end of the photography optical system so as to reduce the overall size and correct aberrations such as spherical aberration, thereby improving image quality. Moreover, the following condition can also be satisfied: 1.25<fL/fA1<2.80. Moreover, the following condition can also be satisfied: 1.35<fL/fA1<2.65. Moreover, the following condition can also be satisfied: 1.49≤fL/fA1≤2.48.

When a maximum value among central thicknesses of all lens elements of the photography optical system is CTmax, and the maximum value among axial distances between each of all adjacent lens elements of the photography optical system when corresponding to the infinite object distance is ATLmax, the following condition can be satisfied: 0.20<CTmax/ATLmax<1.50. Therefore, it is favorable for balancing the space arrangement, thereby ensuring the long focal length while controlling the total track length of the photography optical system. Moreover, the following condition can also be satisfied: 0.20<CTmax/ATLmax<1.25. Moreover, the following condition can also be satisfied: 0.25<CTmax/ATLmax<1.00. Moreover, the following condition can also be satisfied: 0.38≤CTmax/ATLmax≤0.86.

When the curvature radius of the object-side surface of the third lens element is R5, and a curvature radius of the object-side surface of the first lens element counting from the image side among the photography optical system is Rlast2, the following condition can be satisfied: −1.50<R5/Rlast2<5.00. Therefore, it is favorable for balancing the optical path direction during the focus process while correcting field curvature, thereby reducing stray light. Moreover, the following condition can also be satisfied: −1.00<R5/Rlast2<4.50. Moreover, the following condition can also be satisfied: −0.80<R5/Rlast2<3.50. Moreover, the following condition can also be satisfied: −0.60<R5/Rlast2<2.30. Moreover, the following condition can also be satisfied: −0.29≤R5/Rlast2≤1.91.

When the focal length of the photography optical system when corresponding to the infinite object distance is fL, and a focal length of the second lens element is f2, the following condition can be satisfied: −1.50<fL/f2<4.50. Therefore, it is favorable for controlling convergence or divergence of light at the second lens element so as to correct aberrations, thereby improving convergence quality at all fields of view. Moreover, the following condition can also be satisfied: −1.20<fL/f2<4.00. Moreover, the following condition can also be satisfied: −1.00<fL/f2<3.00. Moreover, the following condition can also be satisfied: −0.80<fL/f2<2.20. Moreover, the following condition can also be satisfied: −0.50≤fL/f2≤1.87.

When half of a maximum field of view of the photography optical system when corresponding to the infinite object distance is HFOVL, the following condition can be satisfied: 1.0 degrees (deg.)<HFOVL<7.5 degrees. Therefore, it is favorable for featuring the telephoto function of the photography optical system, and it is also favorable for maintaining the overall size. Moreover, the following condition can also be satisfied: 1.5 degrees<HFOVL<6.5 degrees. Moreover, the following condition can also be satisfied: 1.5 degrees<HFOVL<6.0 degrees. Moreover, the following condition can also be satisfied: 3.0 degrees≤HFOVL≤4.9 degrees.

When the focal length of the photography optical system when corresponding to the infinite object distance is fL, and an entrance pupil diameter of the photography optical system is EPD, the following condition can be satisfied: 1.40<fL/EPD<3.50. Therefore, it is favorable for obtaining a proper balance between the focal length, the light incident amount and the total weight of the photography optical system. Moreover, the following condition can also be satisfied: 1.70<fL/EPD<3.30.

When a composite focal length of the first lens element and the second lens element is f12, and a composite focal length of the second lens element and the third lens element is f23, the following condition can be satisfied: −0.35<f12/f23<3.00. Therefore, it is favorable for adjusting the lens element configuration at the front end of the photography optical system so as to specify the viewing angle and collaborate with the design of the aperture stop, thereby adjusting the travelling direction of light. Moreover, the following condition can also be satisfied: −0.30<f12/f23<2.70. Moreover, the following condition can also be satisfied: −0.25<f12/f23<2.40.

When a curvature radius of the object-side surface of the first lens element is R1, and a curvature radius of the object-side surface of the second lens element is R3, the following condition can be satisfied: −0.50< (R1−R3)/(R1+R3)<0.70. Therefore, it is favorable for collaborating the lens shape of the object-side surface of the first lens element with the lens shape of the object-side surface of the second lens element, thereby harmonizing the optical path and correcting spherical aberration. Moreover, the following condition can also be satisfied: −0.40< (R1−R3)/(R1+R3)<0.60.

When the focal length of the photography optical system when corresponding to the infinite object distance is fL, a focal length of the fifth lens element is f5, a focal length of the sixth lens element counting from the object side among the photography optical system is f6, and a minimum value of fL/f5 and fL/f6 is MIN (fL/f5,fL/f6), the following condition can be satisfied: −13.50<MIN (fL/f5,fL/f6)<−1.00. Therefore, it is favorable for adjusting the refractive power configuration at the middle portion of the photography optical system, thereby facilitating the formation of the telephoto structure. Moreover, the following condition can also be satisfied: −12.50<MIN (fL/f5,fL/f6)<−1.50. Moreover, the following condition can also be satisfied: −11.20<MIN (fL/f5,fL/f6)<−2.00. Moreover, the following condition can also be satisfied: −11.51≤MIN (fL/f5,fL/f6)≤−2.33.

When a central thickness of the first lens element is CT1, and a central thickness of the second lens element counting from the image side among the photography optical system is CTlast2, the following condition can be satisfied: 0.03<CTlast2/CT1<0.80. Therefore, it is favorable for controlling the central thickness ratio of the first lens element to the penultimate lens element, thereby reducing the size of the photography optical system while taking into account limitation of the lens manufacturing process. Moreover, the following condition can also be satisfied: 0.04<CTlast2/CT1<0.70.

When the focal length of the photography optical system when corresponding to the infinite object distance is fL, and an axial distance between the object-side surface of the first lens element and the image surface is TL, the following condition can be satisfied: 1.15<fL/TL<2.00. Therefore, it is favorable for reducing the total track length under the long-focal-length specification, and it is favorable for obtaining a proper balance between the focal length, the depth of view, the viewing angle and the total track length. Moreover, the following condition can also be satisfied: 1.20<fL/TL<1.80. Moreover, the following condition can also be satisfied: 1.25<fL/TL<1.60.

When the focal length of the photography optical system when corresponding to the infinite object distance is fL, and a focal length of the third lens element is f3, the following condition can be satisfied: 0<|fL/f3|<2.20. Therefore, it is favorable for adjusting the refractive power of the third lens element, thereby balancing the refractive power distribution of the photography optical system and reducing sensitivity of the photography optical system. Moreover, the following condition can also be satisfied: 0.01<|fL/f3|<2.10. Moreover, the following condition can also be satisfied: 0.03<|fL/f3|<2.00.

When the focal length of the third lens element is f3, and a focal length of the second lens element counting from the image side among the photography optical system is flast2, the following condition can be satisfied: −6.50<flast2/f3<0.70. Therefore, it is favorable for balancing light at different photography states, and it is also favorable for correcting aberrations and distortion. Moreover, the following condition can also be satisfied: −5.00<flast2/f3<0.50.

When an axial distance between the first lens element and the second lens element is T12, and an axial distance between the second lens element and the third lens element is T23, the following condition can be satisfied: 0<T12/T23<4.00. Therefore, it is favorable for simplifying the structure design and increasing yield rate of lens assembly. Moreover, the following condition can also be satisfied: 0.01<T12/T23<3.00. Moreover, the following condition can also be satisfied: 0.01<T12/T23<2.00.

When the focal length of the photography optical system when corresponding to the infinite object distance is fL, the following condition can be satisfied: 50.00 mm (millimeters)<fL<80.00 mm. Therefore, it is favorable for featuring telephoto with the long focal length of the photography optical system so as to meet requirements of product application. Moreover, the following condition can also be satisfied: 52.00 mm<fL<75.00 mm.

When the maximum image height of the photography optical system is ImgH, the following condition can be satisfied: 3.00 mm<ImgH<5.50 mm. Therefore, it is favorable for adjusting the size arrangement of the photography optical system, thereby adjusting viewing angle and the size of the image surface. Moreover, the following condition can also be satisfied: 3.50 mm<ImgH<5.30 mm.

When the composite focal length of the first lens element and the second lens element is f12, and a composite focal length of the fifth lens element and the sixth lens element counting from the object side among the photography optical system is f56, the following condition can be satisfied: −4.30<f12/f56<0.30. Therefore, it is favorable for adjusting the refractive power distribution of the photography optical system, thereby balancing optical path direction and enhancing the telephoto with the long focal length. Moreover, the following condition can also be satisfied: −4.00<f12/f56<0.10. Moreover, the following condition can also be satisfied: −3.30<f12/f56<0.

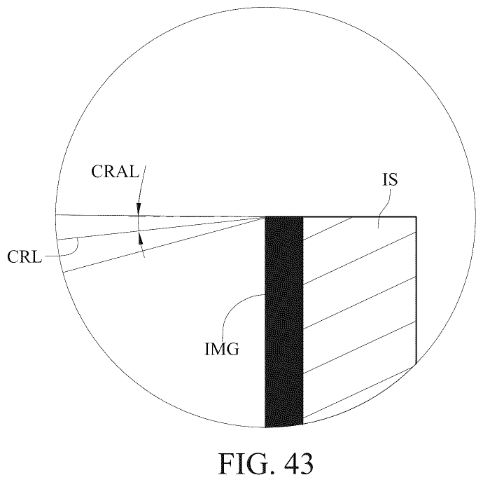

When the focal length of the photography optical system when corresponding to the infinite object distance is fL, a chief ray angle at the maximum image height of the photography optical system when corresponding to the infinite object distance is CRAL, and half of the maximum field of view of the photography optical system when corresponding to the infinite object distance is HFOVL, the following condition can be satisfied: 3.00 [mm/degrees]<fL/(CRAL+HFOVL)<15.00 [mm/degrees]. Therefore, it is favorable for specifying a proper viewing angle and a proper focal length, and it is also favorable for increasing response efficiency of image sensor. Please refer to FIG. 43, which shows a schematic view of CRAL according to the 1st embodiment of the present disclosure, wherein a chief ray CRL, at the first photography state, is projected on the image surface IMG at the maximum image height, and the angle between a normal line of the image surface IMG and the chief ray CRL is the chief ray angle CRAL.

When a maximum effective radius of a lens surface of the first lens assembly closest to the image side among the photography optical system when corresponding to the infinite object distance is YLA1Rlast, a maximum effective radius of a lens surface of the second lens assembly closest to the object side among the photography optical system when corresponding to the infinite object distance is YLA2R1, and a distance in parallel with an optical axis between a maximum effective radius position of the lens surface of the first lens assembly closest to the image side and a maximum effective radius position of the lens surface of the second lens assembly closest to the object side among the photography optical system when corresponding to the infinite object distance is ETLA12, the following condition can be satisfied: 0.27< (YLA1Rlast−YLA2R1)/ETLA12<0.75. Therefore, it is favorable for collaborating with the optical path of the central field of view to effectively control the deflecting angle of the peripheral optical path at the periphery of the aperture stop, thereby improving convergence quality of imaging light. Please refer to FIG. 42, which shows a schematic view of YLA1Rlast, YLA2R1 and ETLA12 at the first photography state according to the 1st embodiment of the present disclosure.

When the focal length of the second lens element is f2, and a focal length of the fourth lens element is f4, the following condition can be satisfied: −0.20<f4/f2<0.85. Therefore, it is favorable for collaboration in refractive power between the second and fourth lens elements, thereby correcting aberrations such as chromatic aberration and spherical aberration. Moreover, the following condition can also be satisfied: 0<f4/f2<0.75.

When the entrance pupil diameter of the photography optical system is EPD, the following condition can be satisfied: 15.00 mm<EPD<32.00 mm. Therefore, it is favorable for enlarging the aperture so as to extend application range. Moreover, the following condition can also be satisfied: 17.00 mm<EPD<30.00 mm.

When a distance in parallel with the optical axis between a maximum effective radius position of the object-side surface of the third lens element and a maximum effective radius position of the image-side surface of the third lens element among the photography optical system when corresponding to the infinite object distance is ETL3, and a central thickness of the third lens element is CT3, the following condition can be satisfied: 0.15<ETL3/CT3<3.00. Therefore, it is favorable for adjusting the ratio of the central thickness to the peripheral thickness of the third lens element, thereby harmonizing the peripheral optical path while strengthening the mechanical strength of the third lens element. Please refer to FIG. 42, which shows a schematic view of ETL3 at the first photography state according to the 1st embodiment of the present disclosure.

When a distance in parallel with the optical axis between a maximum effective radius position of the object-side surface of the last lens element and a maximum effective radius position of the image-side surface of the last lens element among the photography optical system when corresponding to the infinite object distance is ETLlast, and a central thickness of the last lens element is CTlast, the following condition can be satisfied: 0.15<ETLlast/CTlast<2.00. Therefore, it is favorable for adjusting the ratio of the central thickness to the peripheral thickness of the last lens element, thereby assisting in formation of the lens element while reducing sensitivity of the photography optical system. Please refer to FIG. 42, which shows a schematic view of ETLlast at the first photography state according to the 1st embodiment of the present disclosure.

When the axial distance between the first lens element and the second lens element is T12, and a distance in parallel with the optical axis between a maximum effective radius position of the image-side surface of the first lens element and a maximum effective radius position of the object-side surface of the second lens element among the photography optical system when corresponding to the infinite object distance is ETL12, the following condition can be satisfied: 0.05<10×T12/ETL12<3.50. Therefore, it is favorable for effectively controlling the interval between the first and second lens elements, thereby reducing the overall size while reducing stray light. Please refer to FIG. 42, which shows a schematic view of ETL12 at the first photography state according to the 1st embodiment of the present disclosure.

When the maximum image height of the photography optical system is ImgH, and the entrance pupil diameter of the photography optical system is EPD, the following condition can be satisfied: 0.10<2×ImgH/EPD<0.70. Therefore, it is favorable for adjusting the size of the aperture and the size of the image surface, thereby increasing light incident amount into the photography optical system. Moreover, the following condition can also be satisfied: 0.15<2×ImgH/EPD<0.55.

When a maximum effective radius of the object-side surface of the first lens element of the photography optical system when corresponding to the infinite object distance is YL1R1, and a maximum effective radius of the image-side surface of the eighth lens element of the photography optical system when corresponding to the infinite object distance is YL8R2, the following condition can be satisfied: 2.00<YL1R1/YL8R2<4.00. Therefore, it is favorable for adjusting the ratio of outer diameters both at the object end and the image end of the photography optical system, thereby obtaining a proper balance between the field of view and the overall size. Moreover, the following condition can also be satisfied: 2.10<YL1R1/YL8R2<3.85. Please refer to FIG. 42, which shows a schematic view of YL1R1 and YL8R2 at the first photography state according to the 1st embodiment of the present disclosure.

When an Abbe number of the sixth lens element is V6, and a refractive index of the sixth lens element is N6, the following condition can be satisfied: 5.00<V6/N6<14.80. Therefore, it is favorable for effectively correcting chromatic aberration, thereby increasing convergence quality at various photography states. Moreover, the following condition can also be satisfied: 5.50<V6/N6<13.80.

When the focal length of the photography optical system when corresponding to the infinite object distance is fL, and the focal length of the fourth lens element is f4, the following condition can be satisfied: 2.50<fL/f4<5.20. Therefore, it is favorable for enhancing light convergence ability of the fourth lens element so as to facilitate balance in the ultra-telephoto structure and size compactness. Moreover, the following condition can also be satisfied: 2.60<fL/f4<5.00.

When an axial distance between the fifth lens element and the sixth lens element is T56, a central thickness of the fourth lens element is CT4, a central thickness of the fifth lens element is CT5, and a central thickness of the sixth lens element is CT6, the following condition can be satisfied: 0.05< (T56+CT6)/(CT4+CT5)<0.75. Therefore, it is favorable for increasing space utilization so as to reduce tolerance. Moreover, the following condition can also be satisfied: 0.10< (T56+CT6)/(CT4+CT5)<0.65.

According to the present disclosure, the aforementioned features and conditions can be utilized in numerous combinations so as to achieve corresponding effects.

According to the present disclosure, the lens elements of the photography optical system can be made of either glass or plastic material. When the lens elements are made of glass material, the refractive power distribution of the photography optical system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the photography optical system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, the image surface of the photography optical system, based on the corresponding image sensor, can be flat or curved, especially a curved surface being concave facing towards the object side of the photography optical system.

According to the present disclosure, an image correction unit, such as a field flattener, can be optionally disposed between the lens element closest to the image side of the photography optical system along the optical path and the image surface for correction of aberrations such as field curvature. The optical characteristics of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, the photography optical system can include at least one stop, such as an aperture stop, a glare stop or a field stop. Said glare stop or said field stop can be disposed between an imaged object and the first lens element, between adjacent lens elements, or between the last lens element and the image surface, and is set for eliminating the stray light and thereby improving image quality thereof.

According to the present disclosure, the photography optical system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the photography optical system can include one or more optical elements for limiting the form of light passing through the photography optical system. Each optical element can be, but not limited to, a filter, a polarizer, etc., and each optical element can be, but not limited to, a single-piece element, a composite component, a thin film, etc. The optical element can be located at the object side or the image side of the photography optical system or between any two adjacent lens elements so as to allow light in a specific form to pass through, thereby meeting application requirements.

According to the present disclosure, the photography optical system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the photography optical system can further include a light-blocking element. The light-blocking element can have a non-circular opening, and the non-circular opening can have different effective radii in different directions which are perpendicular to the optical axis. Therefore, it is favorable for coordinating with the shape of non-circular lens elements or aperture stop so as to effectively save the space and make full use of the light passing through said non-circular lens elements or aperture stop, thereby reducing stray light. Moreover, the light-blocking element can be provided with a wavy structure or a jagged structure at a periphery of an inner hole portion thereof.

According to the present disclosure, the object side and image side are defined in accordance with the direction of the optical axis, and the axial optical data are calculated along the optical axis. Furthermore, if the optical axis is folded by a light-folding element, the axial optical data are also calculated along the folded optical axis.

According to the above description of the present disclosure, the following specific embodiments are provided for further explanation.

### 1st Embodiment

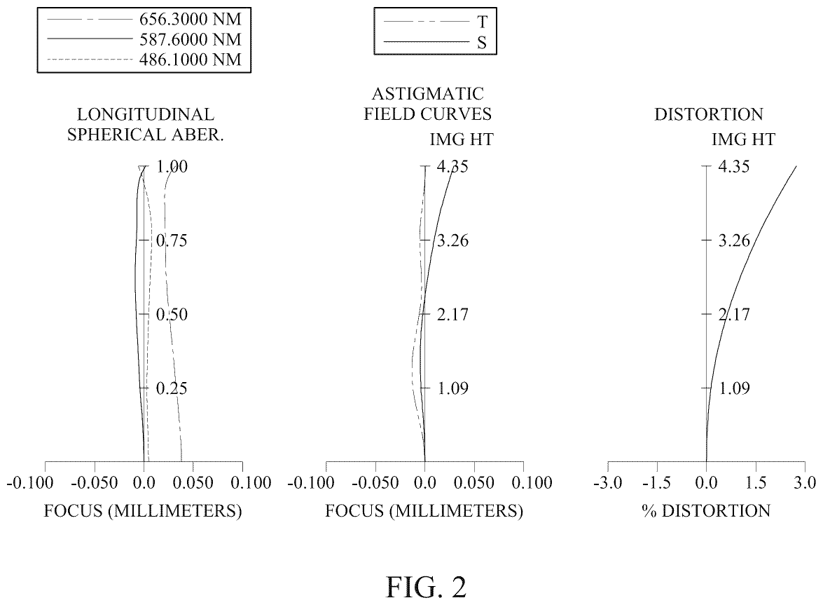

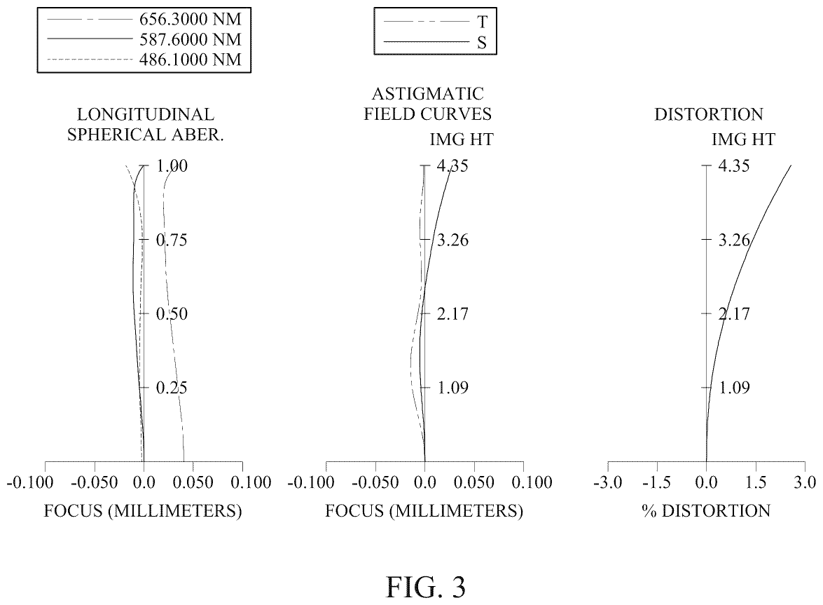

FIG. 1 is a schematic view of an image capturing unit at a first photography state and at a second photography state according to the 1st embodiment of the present disclosure. FIG. 2 shows, in order from left to right, spherical aberration curves, astigmatic field curves and a distortion curve of the image capturing unit at the first photography state according to the 1st embodiment. FIG. 3 shows, in order from left to right, spherical aberration curves, astigmatic field curves and a distortion curve of the image capturing unit at the second photography state according to the 1st embodiment. The upper part of FIG. 1 shows the photography optical system at the first photography state, and the lower part of FIG. 1 shows the photography optical system at the second photography state. In FIG. 1, the image capturing unit 1 includes the photography optical system (its reference numeral is omitted) of the present disclosure and an image sensor IS. The photography optical system includes, in order from an object side to an image side along an optical path, a first lens element E1, a second lens element E2, an aperture stop ST, a third lens element E3, a fourth lens element E4, a fifth lens element E5, a sixth lens element E6, a stop S1, a seventh lens element E7, an eighth lens element E8, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1 and the second lens element E2, and the second lens assembly A2 includes the third lens element E3, the fourth lens element E4, the fifth lens element E5, the sixth lens element E6, the seventh lens element E7 and the eighth lens element E8. The photography optical system includes eight lens elements (E1, E2, E3, E4, E5, E6, E7 and E8) with no additional lens element disposed between each of the adjacent eight lens elements.

In the photography optical system of the 1st embodiment, first through eighth lens elements counting from the object side are respectively the first lens element E1 through the eighth lens element E8, and first through eighth lens elements counting from the image side are respectively the eighth lens element E8 through the first lens element E1, wherein the eighth lens element E8 is also be considered as a last lens element.

The photography optical system of the 1st embodiment perform a focus process for focusing by moving at least one lens element thereof. Through the focusing process, the photography optical system has a first photography state corresponding to an infinite object distance and a second photography state corresponding to a finite object distance as being 10000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the eighth lens element E8 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being convex in a paraxial region thereof. The second lens element E2 is made of glass material and has the object-side surface and the image-side surface being both spherical.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical. The object-side surface of the fifth lens element E5 is cemented to the image-side surface of the fourth lens element E4.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with negative refractive power has an object-side surface being concave in a paraxial region thereof and an image-side surface being concave in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric.

The filter E10 is made of glass material and located between the eighth lens element E8 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the sixth lens element E6 and the seventh lens element E7.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with the optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14 and 16.

When a focal length of the photography optical system when corresponding to the infinite object distance is fL, an f-number of the photography optical system when corresponding to the infinite object distance is FnoL, half of a maximum field of view of the photography optical system when corresponding to the infinite object distance is HFOVL, and the maximum field of view of the photography optical system when corresponding to the infinite object distance is FOVL, the following conditions are satisfied: fL=64.50 millimeters (mm); FnoL=3.00; HFOVL=3.8 degrees (deg.); and FOVL=7.6 deg.

When a focal length of the photography optical system when corresponding to the finite object distance (10000.000 mm) is fS, an f-number of the photography optical system when corresponding to the finite object distance (10000.000 mm) is FnoS, half of a maximum field of view of the photography optical system when corresponding to the finite object distance (10000.000 mm) is HFOVS, and the maximum field of view of the photography optical system when corresponding to the finite object distance (10000.000 mm) is FOVS, the following conditions are satisfied: fS=63.82 mm; FnoS=2.97; HFOVS=3.8 deg.; and FOVS=7.6 deg.

In this embodiment, D0 is an axial distance between an imaged object and the object-side surface of the first lens element E1 (which approximates an object distance of the photography optical system), D1 is an axial distance between the image-side surface of the seventh lens element E7 and the object-side surface of the eighth lens element E8, and D2 is an axial distance between the image-side surface of the eighth lens element E8 and the filter E10. The photography optical system is changeable between the first photography state and the second photography state through the focus process, and the values of D0 to D2 vary accordingly. When the photography optical system is at the first photography state, the aforementioned parameters have the following values: the object distance=∞ (infinity); D0=∞; D1=5.855 mm; and D2=4.445 mm. When the photography optical system is at the second photography state, the aforementioned parameters have the following values: the object distance=10000.000 mm; D0=10000.000 mm; D1=5.330 mm; and D2=4.970 mm.

When an entrance pupil diameter of the photography optical system is EPD, the following condition is satisfied: 21.50 mm.

When a maximum image height of the photography optical system is ImgH, the following condition is satisfied: ImgH=4.35 mm.

When a focal length of the first lens assembly A1 is fA1, the following condition is satisfied: fA1=29.52 mm.

When a focal length of the second lens assembly A2 is fA2, the following condition is satisfied: fA2=−27.65 mm.

When the focal length of the photography optical system when corresponding to the infinite object distance is fL, and the entrance pupil diameter of the photography optical system is EPD, the following condition is satisfied: fL/EPD=3.00.

When the focal length of the photography optical system when corresponding to the infinite object distance is fL, a focal length of the first lens element E1 is f1, a focal length of the second lens element E2 is f2, a focal length of the third lens element E3 is f3, a focal length of the fourth lens element E4 is f4, a focal length of the fifth lens element E5 is f5, a focal length of the sixth lens element E6 is f6, a focal length of the seventh lens element E7 is f7, a focal length of the eighth lens element E8 is f8, a focal length of i-th lens element counting from the object side among the photography optical system is fi, and a minimum value of fL/fi is MIN (fL/fi), the following condition is satisfied: MIN (fL/fi)=−5.78, wherein i is a positive integer, and 1≤i≤8. In this embodiment, among the first lens element E1 through the eighth lens element E8, fL/f7 is smaller than each of fL/f1, fL/f2, fL/f3, fL/f4, fL/f5, fL/f6 and fL/f8, and therefore MIN (fL/fi) equals to fL/f7.

When the focal length of the photography optical system when corresponding to the infinite object distance is fL, the focal length of the fifth lens element E5 is f5, the focal length of the sixth lens element E6 is f6, and a minimum value of fL/f5 and fL/f6 is MIN (fL/f5,fL/f6), the following condition is satisfied: MIN (fL/f5,fL/f6)=−4.85. In this embodiment, among the first lens element E1 through the eighth lens element E8, fL/f5 is smaller than fL/f6, and therefore MIN (fL/f5,fL/f6) equals to fL/f5.

When the focal length of the photography optical system when corresponding to the infinite object distance is fL, and an axial distance between the object-side surface of the first lens element E1 and the image surface IMG is TL, the following condition is satisfied: fL/TL=1.37.

When the focal length of the photography optical system when corresponding to the infinite object distance is fL, and the focal length of the first lens assembly A1 is fA1, the following condition is satisfied: fL/fA1=2.19.

When the focal length of the photography optical system when corresponding to the infinite object distance is fL, and the focal length of the second lens element E2 is f2, the following condition is satisfied: fL/f2=1.48.

When the focal length of the photography optical system when corresponding to the infinite object distance is fL, and the focal length of the third lens element E3 is f3, the following condition is satisfied: |fL/f3|=0.73.

When the focal length of the photography optical system when corresponding to the infinite object distance is fL, and the focal length of the fourth lens element E4 is f4, the following condition is satisfied: fL/f4=3.65.

When the focal length of the second lens element E2 is f2, and the focal length of the fourth lens element E4 is f4, the following condition is satisfied: f4/f2=0.41.

When the focal length of the third lens element E3 is f3, and a focal length of a second lens element counting from the image side among the photography optical system is flast2, the following condition is satisfied: flast2/f3=0.13. In this embodiment, the second lens element counting from the image side among the photography optical system is the seventh lens element E7.

When a composite focal length of the first lens element E1 and the second lens element E2 is f12, and a composite focal length of the second lens element E2 and the third lens element E3 is f23, the following condition is satisfied: f12/f23=0.38.

When the composite focal length of the first lens element E1 and the second lens element E2 is f12, and a composite focal length of the fifth lens element E5 and a sixth lens element counting from the object side among the photography optical system is f56, the following condition is satisfied: f12/f56=−2.00. In this embodiment, the sixth lens element counting from the object side among the photography optical system is the sixth lens element E6.

When a curvature radius of the object-side surface of the third lens element E3 is R5, a curvature radius of the image-side surface of the third lens element E3 is R6, and the focal length of the photography optical system when corresponding to the infinite object distance is fL, the following condition is satisfied: (R5+R6)/fL=0.55.

When a curvature radius of the object-side surface of the first lens element E1 is R1, and a curvature radius of the object-side surface of the second lens element E2 is R3, the following condition is satisfied: (R1-R3)/(R1+R3)=−0.12.

When the curvature radius of the object-side surface of the third lens element E3 is R5, and a curvature radius of the object-side surface of a first lens element counting from the image side among the photography optical system is Rlast2, the following condition is satisfied: R5/Rlast2=1.43. In this embodiment, the first lens element counting from the image side among the photography optical system is the eighth lens element E8.

When a maximum value among central thicknesses of all lens elements of the photography optical system is CTmax, and a maximum value among axial distances between each of all adjacent lens elements of the photography optical system when corresponding to the infinite object distance is ATLmax, the following condition is satisfied: CTmax/ATLmax=0.48. In this embodiment, an axial distance between two adjacent lens elements is a distance in a paraxial region between two adjacent lens surfaces of the two adjacent lens elements. In this embodiment, among the first lens element E1 through the eighth lens element E8, a central thickness of the fourth lens element E4 is larger than that of each of the other lens elements, so CTmax equals the central thickness of the fourth lens element E4. In this embodiment, among the first lens element E1 to the eighth lens element E8, an axial distance between the sixth lens element E6 and the seventh lens element E7 is larger than other axial distances between each of adjacent lens elements of the photography optical system when corresponding to the infinite object distance, and ATLmax equals the axial distance between the sixth lens element E6 and the seventh lens element E7 of the photography optical system when corresponding to the infinite object distance.

When a central thickness of the first lens element E1 is CT1, and a central thickness of a second lens element counting from the image side among the photography optical system is CTlast2, the following condition is satisfied: CTlast2/CT1=0.20. In this embodiment, the second lens element counting from the image side among the photography optical system is the seventh lens element E7.

When an axial distance between the first lens element E1 and the second lens element E2 is T12, and an axial distance between the second lens element E2 and the third lens element E3 is T23, the following condition is satisfied: T12/T23=0.07.

When an axial distance between the fifth lens element E5 and the sixth lens element E6 is T56, the central thickness of the fourth lens element E4 is CT4, a central thickness of the fifth lens element E5 is CT5, and a central thickness of the sixth lens element E6 is CT6, the following condition is satisfied: (T56+CT6)/(CT4+CT5)=0.17.

When the maximum value among axial distances between each of all adjacent lens elements of the photography optical system when corresponding to the infinite object distance is ATLmax, and the maximum image height of the photography optical system is ImgH, the following condition is satisfied: ATLmax/ImgH=2.71.

When an Abbe number of the sixth lens element E6 is V6, and a refractive index of the sixth lens element E6 is N6, the following condition is satisfied: V6/N6=8.21.

When the maximum image height of the photography optical system is ImgH, and the entrance pupil diameter of the photography optical system is EPD, the following condition is satisfied: 2×ImgH/EPD=0.40.

When the focal length of the photography optical system when corresponding to the infinite object distance is fL, a chief ray angle at the maximum image height of the photography optical system when corresponding to the infinite object distance is CRAL, and half of the maximum field of view of the photography optical system when corresponding to the infinite object distance is HFOVL, the following condition can be satisfied: fL/(CRAL+HFOVL)=6.51 [mm/degrees].

When a distance in parallel with the optical axis between a maximum effective radius position of the object-side surface of the third lens element E3 and a maximum effective radius position of the image-side surface of the third lens element E3 among the photography optical system when corresponding to the infinite object distance is ETL3, and a central thickness of the third lens element E3 is CT3, the following condition is satisfied: ETL3/CT3=1.31.

When a distance in parallel with the optical axis between a maximum effective radius position of the object-side surface of the last lens element and a maximum effective radius position of the image-side surface of the last lens element among the photography optical system when corresponding to the infinite object distance is ETLlast, and a central thickness of the last lens element is CTlast, the following condition is satisfied: ETLlast/CTlast=0.49. In this embodiment, the last lens element is the eighth lens element E8.

When the axial distance between the first lens element E1 and the second lens element E2 is T12, and a distance in parallel with the optical axis between a maximum effective radius position of the image-side surface of the first lens element E1 and a maximum effective radius position of the object-side surface of the second lens element E2 among the photography optical system when corresponding to the infinite object distance is ETL12, the following condition is satisfied: 10×T12/ETL12=0.58.

When a maximum effective radius of the object-side surface of the first lens element E1 of the photography optical system when corresponding to the infinite object distance is YL1R1, and a maximum effective radius of the image-side surface of the eighth lens element E8 of the photography optical system when corresponding to the infinite object distance is YL8R2, the following condition is satisfied: YL1R1/YL8R2=2.45.

When a maximum effective radius of a lens surface of the first lens assembly A1 closest to the image side among the photography optical system when corresponding to the infinite object distance is YLA1Rlast, a maximum effective radius of a lens surface of the second lens assembly A2 closest to the object side among the photography optical system when corresponding to the infinite object distance is YLA2R1, and a distance in parallel with the optical axis between a maximum effective radius position of the lens surface of the first lens assembly A1 closest to the image side and a maximum effective radius position of the lens surface of the second lens assembly A2 closest to the object side among the photography optical system when corresponding to the infinite object distance is ETLA12, the following condition is satisfied: (YLA1Rlast−YLA2R1)/ETLA12=0.42. In this embodiment, the lens surface of the first lens assembly A1 closest to the image side is the image-side surface of the second lens element E2, and the lens surface of the second lens assembly A2 closest to the object side is the object-side surface of the third lens element E3.

The detailed optical data of the 1st embodiment are shown in Table 1A and Table 1B, and the aspheric surface data are shown in Table 1C below.

TABLE 1A
1st Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 20.3611 | (SPH) | 2.267 | Glass | 1.561 | 58.3 | 83.77 |
| 2 | | 34.5049 | (SPH) | 0.033 | | | | |
| 3 | Lens 2 | 26.1437 | (SPH) | 3.505 | Glass | 1.511 | 60.5 | 43.54 |
| 4 | | −142.8571 | (SPH) | 0.300 | | | | |
| 5 | Ape. Stop | Plano | | 0.200 | | | | |
| 6 | Lens 3 | 19.7808 | (SPH) | 1.032 | Glass | 1.904 | 31.4 | −88.00 |
| 7 | | 15.4481 | (SPH) | 0.625 | | | | |
| 8 | Lens 4 | 15.9625 | (SPH) | 5.642 | Glass | 1.523 | 58.7 | 17.65 |
| 9 | Lens 5 | −19.2491 | (SPH) | 1.311 | Glass | 1.850 | 30.1 | −13.30 |
| 10 | | 28.2741 | (SPH) | 0.126 | | | | |
| 11 | Lens 6 | 29.7459 | (ASP) | 1.060 | Plastic | 1.705 | 14.0 | 128.71 |
| 12 | | 43.6060 | (ASP) | 11.505 | | | | |
| 13 | Stop | Plano | | 0.300 | | | | |
| 14 | Lens 7 | −22.9103 | (SPH) | 0.455 | Glass | 1.804 | 46.6 | −11.17 |
| 15 | | 14.8981 | (SPH) | D1 | | | | |
| 16 | Lens 8 | 13.8123 | (ASP) | 1.434 | Plastic | 1.614 | 26.0 | 23.09 |
| 17 | | 522.4417 | (ASP) | D2 | | | | |

| | | | | | | | |
|---|---|---|---|---|---|---|---|
| 18 | Filter | Plano | 0.510 | Glass | 1.517 | 64.2 | — |
| 19 | | Plano | 6.505 | | | | |
| 20 | Image | Plano | — | | | | |

Note:
Reference wavelength is 587.6 nm (d-line).
An effective radius of the stop S1 (Surface 13) is 3.510 mm.

In Table 1A, the curvature radius, the thickness and the focal length are shown in millimeters (mm). Surface numbers 0-20 represent the surfaces sequentially arranged from the object side to the image side along the optical axis.

TABLE 1B
Optical data for photography optical system at the first
photography state and the second photography state

| | first photography | | second photography |
|---|---|---|---|
| | state | | state |
| fL [mm] | 64.50 | fS [mm] | 63.82 |
| FnoL | 3.00 | FnoS | 2.97 |
| HFOVL [deg.] | 3.8 | HFOVS [deg.] | 3.8 |
| Object distance | infinity | Object distance | 10000.000 |
| [mm] | | [mm] | |
| D0 [mm] | infinity | D0 [mm] | 10000.000 |
| D1 [mm] | 5.855 | D1 [mm] | 5.330 |
| D2 [mm] | 4.445 | D2 [mm] | 4.970 |

Table 1B shows optical data of the photography optical system at the first photography state and the second photography state in different focus conditions. It should be understood that only two focus conditions (i.e., the first photography state and the second photography state) are disclosed in this embodiment, but the present disclosure is not limited thereto. The photography optical system of this embodiment can further have other focal lengths corresponding to other photography states in other focus conditions besides the first photography state and the second photography state for different object distances.

It can be known from Table 1A and Table 1B, the eighth lens element E8 moves along a direction parallel to the optical axis during the focus process.

TABLE 1C
Aspheric Coefficients

| Surface # | 11 | 12 | 16 | 17 |
|---|---|---|---|---|
| k= | −2.92320E+00 | −4.56667E+01 | 2.66046E+00 | 9.90000E+01 |
| A4= | −4.3913E−05 | −2.1970E−05 | 2.0580E−04 | 4.5554E−04 |
| A6= | −1.5809E−06 | −2.8242E−06 | 5.3709E−06 | 2.2429E−05 |
| A8= | 1.1903E−07 | 1.6842E−07 | 5.2569E−07 | −2.2003E−06 |
| A10= | −3.5854E−09 | −5.3715E−09 | 2.2145E−08 | 3.4340E−07 |
| A12= | 7.6255E−11 | 1.1925E−10 | −3.9107E−09 | −2.3977E−08 |
| A14= | −8.4896E−13 | −1.4260E−12 | 2.0826E−10 | 8.5086E−10 |
| A16= | 5.0141E−15 | 8.6501E−15 | −2.7096E−12 | −9.9586E−12 |

In Table 1C, k represents the conic coefficient of the equation of the aspheric surface profiles. A4-A16 represent the aspheric coefficients ranging from the 4th order to the 16th order. The tables presented below for each embodiment are the corresponding schematic parameter and aberration curves, and the definitions of the tables are the same as Table 1A to Table 1C of the 1st embodiment. Therefore, an explanation in this regard will not be provided again.

### 2nd Embodiment

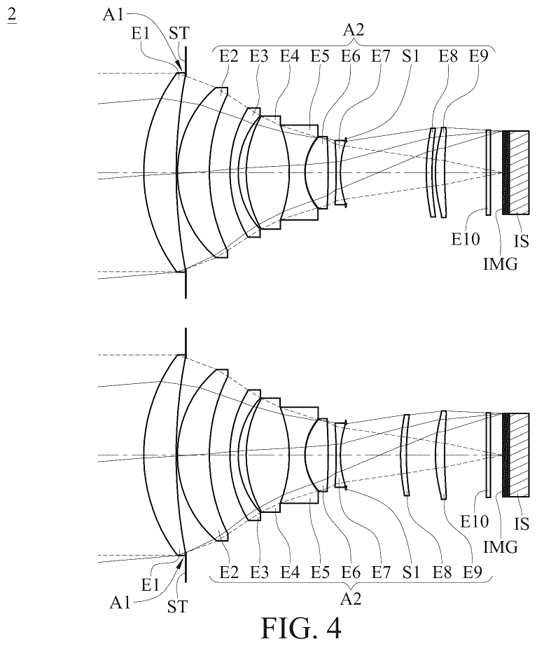

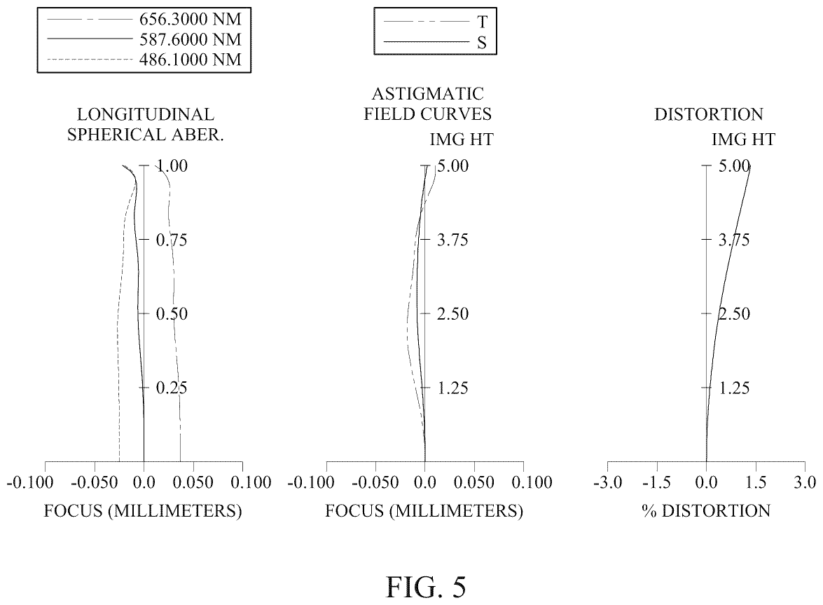

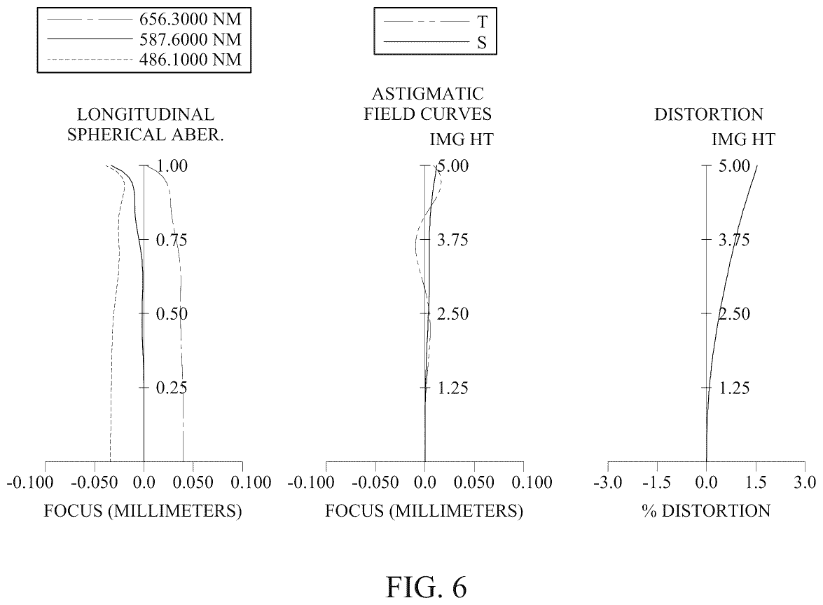

FIG. 4 is a schematic view of an image capturing unit at a first photography state and at a second photography state according to the 2nd embodiment of the present disclosure. FIG. 5 shows, in order from left to right, spherical aberration curves, astigmatic field curves and a distortion curve of the image capturing unit at the first photography state according to the 2nd embodiment. FIG. 6 shows, in order from left to right, spherical aberration curves, astigmatic field curves and a distortion curve of the image capturing unit at the second photography state according to the 2nd embodiment. The upper part of FIG. 4 shows the photography optical system at the first photography state, and the lower part of FIG. 4 shows the photography optical system at the second photography state. In FIG. 4, the image capturing unit 2 includes the photography optical system (its reference numeral is omitted) of the present disclosure and an image sensor IS. The photography optical system includes, in order from an object side to an image side along an optical path, a first lens element E1, an aperture stop ST, a second lens element E2, a third lens element E3, a fourth lens element E4, a fifth lens element E5, a sixth lens element E6, a seventh lens element E7, a stop S1, an eighth lens element E8, a ninth lens element E9, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1, and the second lens assembly A2 includes the second lens element E2, the third lens element E3, the fourth lens element E4, the fifth lens element E5, the sixth lens element E6, the seventh lens element E7, the eighth lens element E8 and the ninth lens element E9. The photography optical system includes nine lens elements (E1, E2, E3, E4, E5, E6, E7, E8 and E9) with no additional lens element disposed between each of the adjacent nine lens elements.

In the photography optical system of the 2nd embodiment, first through ninth lens elements counting from the object side are respectively the first lens element E1 through the ninth lens element E9, and first through ninth lens elements counting from the image side are respectively the ninth lens element E9 through the first lens element E1, wherein the ninth lens element E9 is also be considered as a last lens element.

The photography optical system of the 2nd embodiment perform a focus process for focusing by moving at least one lens element thereof. Through the focusing process, the photography optical system has a first photography state corresponding to an infinite object distance and a second photography state corresponding to a finite object distance as being 10000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the eighth lens element E8 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical. The object-side surface of the fifth lens element E5 is cemented to the image-side surface of the fourth lens element E4.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric.

The seventh lens element E7 with negative refractive power has an object-side surface being concave in a paraxial region thereof and an image-side surface being concave in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric.

The ninth lens element E9 with positive refractive power has an object-side surface being convex in a paraxial region thereof and an image-side surface being concave in a paraxial region thereof. The ninth lens element E9 is made of plastic material and has the object-side surface and the image-side surface being both aspheric.

The filter E10 is made of glass material and located between the ninth lens element E9 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the seventh lens element E7 and the eighth lens element E8.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 2nd embodiment are shown in Table 2A and Table 2B, and the aspheric surface data are shown in Table 2C below.

TABLE 2A
2nd Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 19.9601 | (SPH) | 3.889 | Glass | 1.729 | 54.7 | 38.76 |
| 2 | | 62.3656 | (SPH) | 1.161 | | | | |
| 3 | Ape. Stop | Plano | | −1.001 | | | | |
| 4 | Lens 2 | 13.8848 | (ASP) | 3.831 | Plastic | 1.511 | 56.8 | 64.63 |
| 5 | | 21.7243 | (ASP) | 2.463 | | | | |
| 6 | Lens 3 | 14.9512 | (SPH) | 1.002 | Glass | 1.923 | 18.9 | −38.49 |
| 7 | | 10.1836 | (SPH) | 0.962 | | | | |
| 8 | Lens 4 | 13.7279 | (SPH) | 5.168 | Glass | 1.639 | 55.4 | 12.32 |
| 9 | Lens 5 | −15.7194 | (SPH) | 1.867 | Glass | 1.904 | 31.4 | −5.03 |
| 10 | | 6.7538 | (SPH) | 0.030 | | | | |
| 11 | Lens 6 | 6.3549 | (ASP) | 2.766 | Plastic | 1.669 | 19.5 | 8.89 |
| 12 | | −76.1158 | (ASP) | 0.974 | | | | |
| 13 | Lens 7 | −57.3437 | (SPH) | 0.502 | Glass | 1.946 | 17.9 | −10.36 |
| 14 | | 11.8677 | (SPH) | 0.640 | | | | |
| 15 | Stop | Plano | | D1 | | | | |
| 16 | Lens 8 | 27.2825 | (ASP) | 0.687 | Plastic | 1.705 | 14.0 | 143.01 |
| 17 | | 37.0186 | (ASP) | D2 | | | | |
| 18 | Lens 9 | 17.1843 | (ASP) | 1.104 | Plastic | 1.705 | 14.0 | 36.64 |
| 19 | | 50.0073 | (ASP) | 5.000 | | | | |

| | | | | | | | |
|---|---|---|---|---|---|---|---|
| 20 | Filter | Plano | 0.510 | Glass | 1.517 | 64.2 | — |
| 21 | | Plano | 1.464 | | | | |
| 22 | Image | Plano | — | | | | |

Note:
Reference wavelength is 587.6 nm (d-line).
An effective radius of the stop S1 (Surface 15) is 3.756 mm.

TABLE 2B
Optical data for photography optical system at the first
photography state and the second photography state

| | first photography | | second photography |
|---|---|---|---|
| | state | | state |
| fL [mm] | 57.89 | fS [mm] | 57.41 |
| FnoL | 2.43 | FnoS | 2.41 |
| HFOVL [deg.] | 4.9 | HFOVS [deg.] | 4.9 |
| Object distance | infinity | Object distance | 10000.000 |
| [mm] | | [mm] | |
| D0 [mm] | infinity | D0 [mm] | 10000.000 |
| D1 [mm] | 9.678 | D1 [mm] | 6.596 |
| D2 [mm] | 0.410 | D2 [mm] | 3.492 |

In Table 2B, except for D1 being an axial distance between the stop S1 and the object-side surface of the eighth lens element E8, and D2 being an axial distance between the image-side surface of the eighth lens element E8 and the object-side surface of the ninth lens element E9, the other optical data is the same as the data of the 1st embodiment. Moreover, photography optical system of this embodiment can further have other focal lengths corresponding to other photography states in other focus conditions besides the first photography state and the second photography state for different object distances.

It can be known from Table 2A and Table 2B, the eighth lens element E8 moves along a direction parallel to the optical axis during the focus process.

TABLE 2C
Aspheric Coefficients

| Surface # | 4 | 5 | 11 | 12 |
|---|---|---|---|---|
| k= | 4.20405E−02 | 3.43578E−01 | −3.26418E−01 | −9.90000E+01 |
| A4= | 3.8365E−06 | 4.3189E−06 | 2.5073E−05 | −5.7152E−05 |
| A6= | −1.6992E−08 | −1.1977E−07 | 5.8357E−06 | 1.4429E−05 |
| A8= | 5.4309E−10 | 2.0050E−09 | −4.7992E−07 | −2.8119E−06 |
| A10= | 2.0575E−13 | −1.1689E−11 | −4.7173E−09 | 3.0386E−07 |
| A12= | 1.0802E−14 | −1.1776E−14 | 4.0226E−09 | −1.7705E−08 |
| A14= | — | — | −2.5719E−10 | 5.1396E−10 |
| A16= | — | — | 5.3371E−12 | −5.3062E−12 |
| Surface # | 16 | 17 | 18 | 19 |
| k= | −3.98983E+00 | 3.27462E+01 | −1.01468E+01 | 3.18283E+01 |
| A4= | 3.7315E−04 | 3.5615E−04 | 3.6269E−04 | −3.8430E−06 |
| A6= | −4.9775E−05 | −6.7730E−05 | −3.2135E−05 | −1.7031E−05 |
| A8= | 5.7475E−06 | 7.4792E−06 | 2.5720E−06 | 1.3919E−06 |
| A10= | −4.0134E−07 | −5.0556E−07 | −1.3768E−07 | −8.1538E−08 |
| A12= | 1.5187E−08 | 1.8607E−08 | 4.6635E−09 | 3.4379E−09 |
| A14= | −2.9010E−10 | −3.4820E−10 | −9.1695E−11 | −8.8869E−11 |
| A16= | 2.1801E−12 | 2.5575E−12 | 6.5292E−13 | 8.4928E−13 |

Moreover, these parameters shown in Table 2D can be calculated from Table 2A to Table 2C as the following values and satisfy the following conditions:

TABLE 2D
Schematic Parameters

| | | | |
|---|---|---|---|
| fL [mm] | 57.89 | f4/f2 | 0.19 |
| FnoL | 2.43 | flast2/f3 | −3.72 |
| HFOVL [deg.] | 4.9 | f12/f23 | −0.15 |
| FOVL [deg.] | 9.8 | f12/f56 | −1.84 |
| fS [mm] | 57.41 | (R5 + R6)/fL | 0.43 |
| FnoS | 2.41 | (R1 − R3)/(R1 + R3) | 0.18 |
| HFOVS [deg.] | 4.9 | R5/Rlast2 | 0.87 |
| FOVS [deg.] | 9.8 | CTmax/ATLmax | 0.50 |
| EPD [mm] | 23.82 | CTlast2/CT1 | 0.18 |
| ImgH [mm] | 5.00 | T12/T23 | 0.06 |
| fA1 [mm] | 38.76 | (T56 + CT6)/(CT4 + CT5) | 0.40 |
| fA2 [mm] | −63.19 | ATLmax/ImgH | 2.06 |
| fL/EPD | 2.43 | V6/N6 | 11.68 |
| MIN(fL/fi) | −11.51 | 2 × ImgH/EPD | 0.42 |
| MIN(fL/f5, fL/f6) | −11.51 | fL/(CRAL + HFOVL) [mm/deg.] | 5.75 |
| fL/TL | 1.34 | ETL3/CT3 | 1.50 |
| fL/fA1 | 1.49 | ETLlast/CTlast | 0.46 |
| fL/f2 | 0.90 | 10 × T12/ETL12 | 0.42 |
| \|fL/f3\| | 1.50 | YL1R1/YL8R2 | 2.25 |
| fL/f4 | 4.70 | (YLA1Rlast − | 0.34 |
| | | YLA2R1)/ETLA12 | |

In the 2nd embodiment, the equation of the aspheric surface profiles of the aforementioned lens elements is the same as the equation of the 1st embodiment.

### 3rd Embodiment

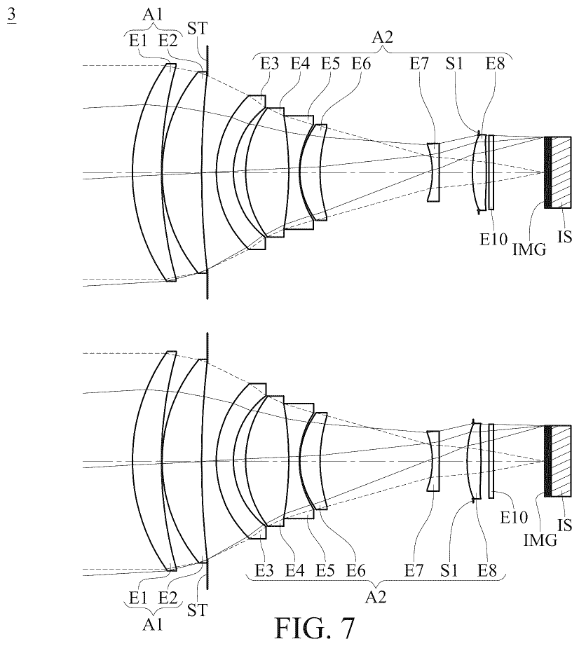

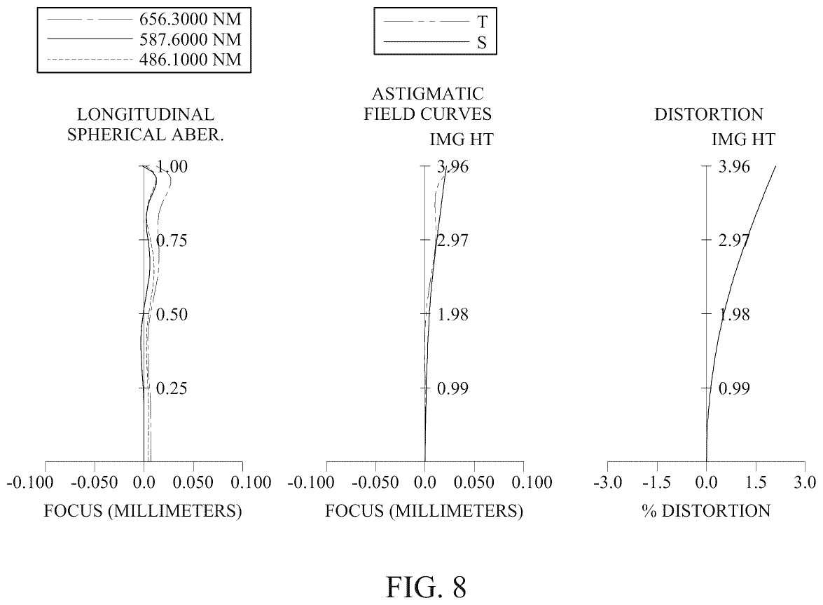

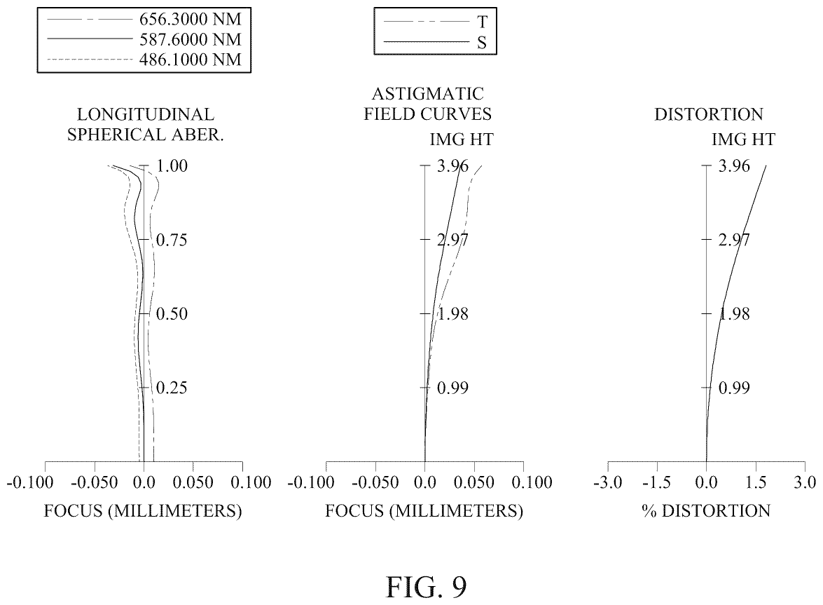

FIG. 7 is a schematic view of an image capturing unit at a first photography state and at a second photography state according to the 3rd embodiment of the present disclosure. FIG. 8 shows, in order from left to right, spherical aberration curves, astigmatic field curves and a distortion curve of the image capturing unit at the first photography state according to the 3rd embodiment. FIG. 9 shows, in order from left to right, spherical aberration curves, astigmatic field curves and a distortion curve of the image capturing unit at the second photography state according to the 3rd embodiment. The upper part of FIG. 7 shows the photography optical system at the first photography state, and the lower part of FIG. 7 shows the photography optical system at the second photography state. In FIG. 7, the image capturing unit 3 includes the photography optical system (its reference numeral is omitted) of the present disclosure and an image sensor IS. The photography optical system includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, a stop S1, an eighth lens element E8, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1 and the second lens element E2, and the second lens assembly A2 includes the third lens element E3, the fourth lens element E4, the fifth lens element E5, the sixth lens element E6, the seventh lens element E7 and the eighth lens element E8. The photography optical system includes eight lens elements (E1, E2, E3, E4, E5, E6, E7 and E8) with no additional lens element disposed between each of the adjacent eight lens elements.

In the photography optical system of the 3rd embodiment, first through eighth lens elements counting from the object side are respectively the first lens element E1 through the eighth lens element E8, and first through eighth lens elements counting from the image side are respectively the eighth lens element E8 through the first lens element E1, wherein the eighth lens element E8 is also be considered as a last lens element.

The photography optical system of the 3rd embodiment perform a focus process for focusing by moving at least one lens element thereof. Through the focusing process, the photography optical system has a first photography state corresponding to an infinite object distance and a second photography state corresponding to a finite object distance as being 10000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the eighth lens element E8 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical. The object-side surface of the fifth lens element E5 is cemented to the image-side surface of the fourth lens element E4.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with negative refractive power has an object-side surface being concave in a paraxial region thereof and an image-side surface being convex in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being convex in a paraxial region thereof. The eighth lens element E8 is made of plastic material and has the object-side surface and the image-side surface being both aspheric.

The filter E10 is made of glass material and located between the eighth lens element E8 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the sixth lens element E6 and the seventh lens element E7.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 3rd embodiment are shown in Table 3A and Table 3B, and the aspheric surface data are shown in Table 3C below.

TABLE 3A
3rd Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 21.2440 | (SPH) | 3.240 | Glass | 1.497 | 81.6 | 78.01 |
| 2 | | 44.6151 | (SPH) | 0.076 | | | | |
| 3 | Lens 2 | 17.7382 | (SPH) | 4.414 | Glass | 1.437 | 95.1 | 48.60 |
| 4 | | 99.5304 | (SPH) | 0.636 | | | | |
| 5 | Ape. Stop | Plano | | 1.001 | | | | |
| 6 | Lens 3 | 11.9876 | (SPH) | 1.916 | Glass | 1.911 | 35.2 | −64.88 |
| 7 | | 9.2067 | (SPH) | 1.359 | | | | |
| 8 | Lens 4 | 11.9780 | (SPH) | 4.825 | Glass | 1.497 | 81.6 | 18.79 |
| 9 | Lens 5 | −36.7354 | (SPH) | 1.165 | Glass | 1.904 | 31.3 | −8.50 |
| 10 | | 9.8649 | (SPH) | 0.073 | | | | |
| 11 | Lens 6 | 8.6824 | (ASP) | 2.255 | Plastic | 1.661 | 20.4 | 24.94 |
| 12 | | 16.4359 | (ASP) | 12.541 | | | | |
| 13 | Lens 7 | −9.0218 | (SPH) | 0.784 | Glass | 1.850 | 32.3 | −11.24 |
| 14 | | −167.4416 | (SPH) | D1 | | | | |
| 15 | Stop | Plano | | −0.700 | | | | |
| 16 | Lens 8 | 15.3038 | (ASP) | 1.553 | Plastic | 1.661 | 20.4 | 16.32 |
| 17 | | −35.1048 | (ASP) | D2 | | | | |

| | | | | | | | |
|---|---|---|---|---|---|---|---|
| 18 | Filter | Plano | 0.510 | Glass | 1.517 | 64.2 | — |
| 19 | | Plano | 5.710 | | | | |
| 20 | Image | Plano | — | | | | |

Note:
Reference wavelength is 587.6 nm (d-line).
An effective radius of the stop S1 (Surface 15) is 4.210 mm.

TABLE 3B
Optical data for photography optical system at the first
photography state and the second photography state

| | first photography | | second photography |
|---|---|---|---|
| | state | | state |
| fL [mm] | 65.64 | fS [mm] | 64.29 |
| FnoL | 2.75 | FnoS | 2.69 |
| HFOVL [deg.] | 3.4 | HFOVS [deg.] | 3.4 |
| Object distance | infinity | Object distance | 10000.000 |
| [mm] | | [mm] | |
| D0 [mm] | infinity | D0 [mm] | 10000.000 |
| D1 [mm] | 4.388 | D1 [mm] | 3.791 |
| D2 [mm] | 0.296 | D2 [mm] | 0.893 |

In Table 3B, except for D1 being an axial distance between the image-side surface of the seventh lens element E7 and the stop S1, the other optical data is the same as the data of the 1st embodiment. Moreover, photography optical system of this embodiment can further have other focal lengths corresponding to other photography states in other focus conditions besides the first photography state and the second photography state for different object distances.

It can be known from Table 3A and Table 3B, the stop S1 and the eighth lens element E8 move along a direction parallel to the optical axis during the focus process.

TABLE 3C
Aspheric Coefficients

| Surface # | 11 | 12 | 16 | 17 |
|---|---|---|---|---|
| k= | −6.38277E−02 | 6.90202E−01 | 8.27428E+00 | 1.52538E+01 |
| A4= | 3.8853E−06 | −9.0953E−06 | −7.2809E−05 | 4.0993E−04 |
| A6= | −5.5466E−07 | −1.5266E−06 | 7.9445E−06 | 1.2727E−05 |
| A8= | −5.7191E−08 | −6.9651E−09 | −3.3694E−07 | 6.3072E−07 |
| A10= | 1.9122E−09 | −1.4977E−09 | 9.3186E−10 | −6.6690E−08 |
| A12= | −7.4801E−11 | −2.1013E−11 | 5.1382E−10 | 3.1567E−09 |

Moreover, these parameters shown in Table 3D can be calculated from Table 3A to Table 3C as the following values and satisfy the following conditions:

TABLE 3D
Schematic Parameters

| | | | |
|---|---|---|---|
| fL [mm] | 65.64 | f4/f2 | 0.39 |
| FnoL | 2.75 | flast2/f3 | 0.17 |
| HFOVL [deg.] | 3.4 | f12/f23 | 0.27 |
| FOVL [deg.] | 6.8 | f12/f56 | −2.55 |
| fS [mm] | 64.29 | (R5 + R6)/fL | 0.32 |
| FnoS | 2.69 | (R1 − R3)/(R1 + R3) | 0.09 |
| HFOVS [deg.] | 3.4 | R5/Rlast2 | 0.78 |
| FOVS [deg.] | 6.8 | CTmax/ATLmax | 0.38 |
| EPD [mm] | 23.88 | CTlast2/CT1 | 0.24 |
| ImgH [mm] | 3.96 | T12/T23 | 0.05 |
| fA1 [mm] | 30.76 | (T56 + CT6)/(CT4 + CT5) | 0.39 |
| fA2 [mm] | −34.59 | ATLmax/ImgH | 3.17 |
| fL/EPD | 2.75 | V6/N6 | 12.28 |
| MIN(fL/fi) | −7.72 | 2 × ImgH/EPD | 0.33 |
| MIN(fL/f5, fL/f6) | −7.72 | fL/(CRAL + HFOVL) [mm/deg.] | 8.12 |
| fL/TL | 1.43 | ETL3/CT3 | 0.99 |
| fL/fA1 | 2.13 | ETLlast/CTlast | 0.49 |
| fL/f2 | 1.35 | 10 × T12/ETL12 | 0.30 |
| \|fL/f3\| | 1.01 | YL1R1/YL8R2 | 2.92 |
| fL/f4 | 3.49 | (YLA1Rlast − | 0.43 |
| | | YLA2R1)/ETLA12 | |

In the 3rd embodiment, the equation of the aspheric surface profiles of the aforementioned lens elements is the same as the equation of the 1st embodiment.

### 4th Embodiment

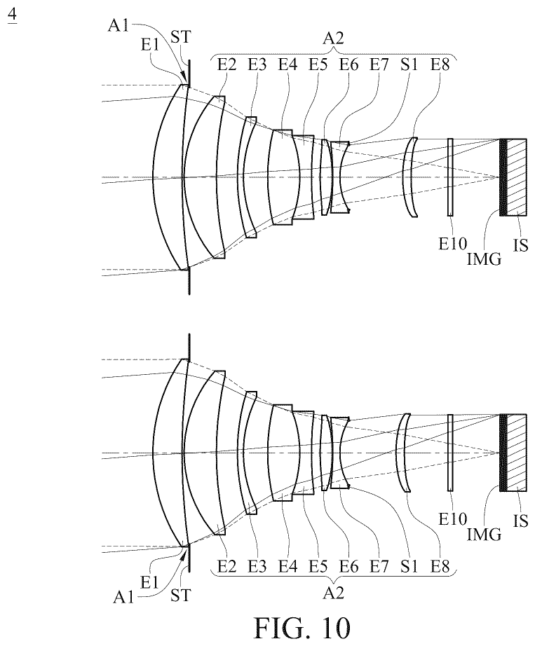

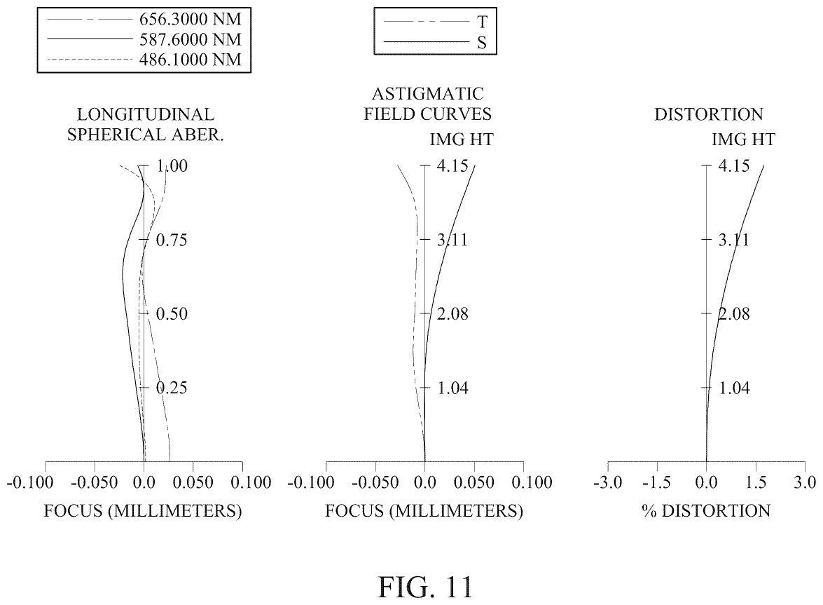

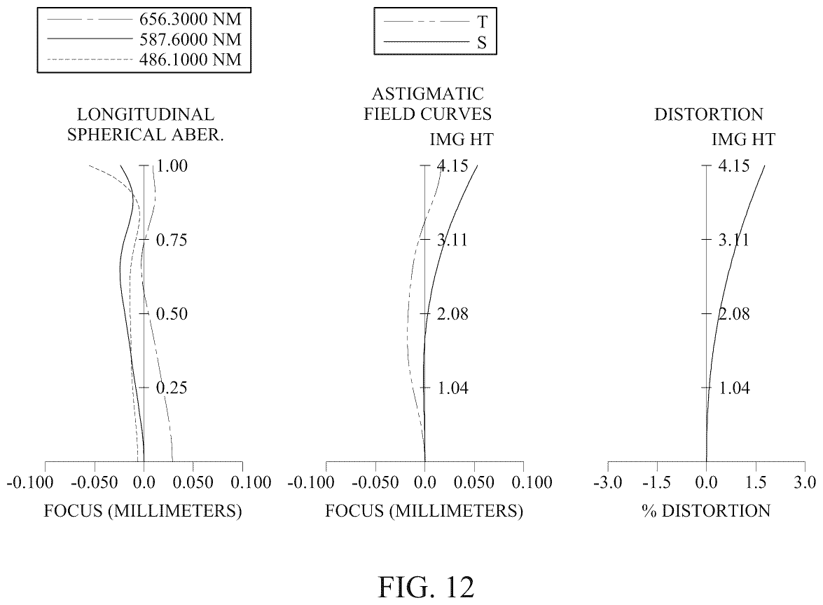

FIG. 10 is a schematic view of an image capturing unit at a first photography state and at a second photography state according to the 4th embodiment of the present disclosure. FIG. 11 shows, in order from left to right, spherical aberration curves, astigmatic field curves and a distortion curve of the image capturing unit at the first photography state according to the 4th embodiment. FIG. 12 shows, in order from left to right, spherical aberration curves, astigmatic field curves and a distortion curve of the image capturing unit at the second photography state according to the 4th embodiment. The upper part of FIG. 10 shows the photography optical system at the first photography state, and the lower part of FIG. 10 shows the photography optical system at the second photography state. In FIG. 10, the image capturing unit 4 includes the photography optical system (its reference numeral is omitted) of the present disclosure and an image sensor IS. The photography optical system includes, in order from an object side to an image side along an optical path, a first lens element E1, an aperture stop ST, a second lens element E2, a third lens element E3, a fourth lens element E4, a fifth lens element E5, a sixth lens element E6, a seventh lens element E7, a stop S1, an eighth lens element E8, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1, and the second lens assembly A2 includes the second lens element E2, the third lens element E3, the fourth lens element E4, the fifth lens element E5, the sixth lens element E6, the seventh lens element E7 and the eighth lens element E8. The photography optical system includes eight lens elements (E1, E2, E3, E4, E5, E6, E7 and E8) with no additional lens element disposed between each of the adjacent eight lens elements.

In the photography optical system of the 4th embodiment, first through eighth lens elements counting from the object side are respectively the first lens element E1 through the eighth lens element E8, and first through eighth lens elements counting from the image side are respectively the eighth lens element E8 through the first lens element E1, wherein the eighth lens element E8 is also be considered as a last lens element.

The photography optical system of the 4th embodiment perform a focus process for focusing by moving at least one lens element thereof. Through the focusing process, the photography optical system has a first photography state corresponding to an infinite object distance and a second photography state corresponding to a finite object distance as being 9000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the eighth lens element E8 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical. The object-side surface of the fifth lens element E5 is cemented to the image-side surface of the fourth lens element E4.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric.

The seventh lens element E7 with negative refractive power has an object-side surface being concave in a paraxial region thereof and an image-side surface being concave in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric.

The filter E10 is made of glass material and located between the eighth lens element E8 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the seventh lens element E7 and the eighth lens element E8.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 4th embodiment are shown in Table 4A and Table 4B, and the aspheric surface data are shown in Table 4C below.

TABLE 4A
4th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 18.1585 | (SPH) | 3.162 | Glass | 1.729 | 54.7 | 32.59 |
| 2 | | 71.3679 | (SPH) | 0.787 | | | | |
| 3 | Ape. Stop | Plano | | −0.557 | | | | |
| 4 | Lens 2 | 13.5050 | (SPH) | 3.494 | Glass | 1.511 | 60.5 | 39.35 |
| 5 | | 37.5036 | (SPH) | 2.268 | | | | |
| 6 | Lens 3 | 22.2147 | (SPH) | 0.660 | Glass | 1.946 | 17.9 | −39.40 |
| 7 | | 13.7173 | (SPH) | 2.628 | | | | |
| 8 | Lens 4 | 22.1527 | (SPH) | 3.475 | Glass | 1.511 | 60.5 | 16.28 |
| 9 | Lens 5 | −12.6183 | (SPH) | 1.254 | Glass | 1.923 | 18.9 | −10.03 |
| 10 | | 36.4309 | (SPH) | 0.951 | | | | |
| 11 | Lens 6 | 20.4555 | (ASP) | 1.299 | Plastic | 1.705 | 14.0 | 13.90 |
| 12 | | −18.3195 | (ASP) | 0.068 | | | | |
| 13 | Lens 7 | −31.6613 | (SPH) | 0.767 | Glass | 1.802 | 45.5 | −7.26 |
| 14 | | 7.2114 | (SPH) | 0.950 | | | | |
| 15 | Stop | Plano | | D1 | | | | |
| 16 | Lens 8 | 12.2711 | (ASP) | 0.909 | Plastic | 1.642 | 22.5 | 43.79 |
| 17 | | 21.1544 | (ASP) | D2 | | | | |

| | | | | | | | |
|---|---|---|---|---|---|---|---|
| 18 | Filter | Plano | 0.510 | Glass | 1.517 | 64.2 | — |
| 19 | | Plano | 5.124 | | | | |
| 20 | Image | Plano | — | | | | |

Note:
Reference wavelength is 587.6 nm (d-line).
An effective radius of the stop S1 (Surface 15) is 3.505 mm.

TABLE 4B
Optical data for photography optical system at the first
photography state and the second photography state

| | first photography | | second photography |
|---|---|---|---|
| | state | | state |
| fL [mm] | 54.07 | fS [mm] | 53.40 |
| FnoL | 2.70 | FnoS | 2.67 |
| HFOVL [deg.] | 4.3 | HFOVS [deg.] | 4.3 |
| Object distance | infinity | Object distance | 9000.000 |
| [mm] | | [mm] | |
| D0 [mm] | infinity | D0 [mm] | 9000.000 |
| D1 [mm] | 5.858 | D1 [mm] | 5.131 |
| D2 [mm] | 3.992 | D2 [mm] | 4.719 |

In Table 4B, except for D1 being an axial distance between the stop S1 and the object-side surface of the eighth lens element E8, and the finite object distance corresponded by fS, FnoS and HFOVS being 9000.000 mm, the other optical data is the same as the data of the 1st embodiment. Moreover, photography optical system of this embodiment can further have other focal lengths corresponding to other photography states in other focus conditions besides the first photography state and the second photography state for different object distances.

It can be known from Table 4A and Table 4B, the eighth lens element E8 moves along a direction parallel to the optical axis during the focus process.

TABLE 4C
Aspheric Coefficients

| Surface # | 11 | 12 | 16 | 17 |
|---|---|---|---|---|
| k= | −1.31972E+01 | 1.34498E+01 | −9.74313E−01 | 1.99020E+01 |
| A4= | −5.6087E−04 | −5.1090E−04 | −1.5805E−04 | −5.1155E−04 |
| A6= | −1.1798E−05 | 2.5127E−05 | 8.3552E−05 | 1.0006E−04 |
| A8= | 3.0565E−06 | 1.8560E−06 | −1.5081E−05 | −2.1299E−05 |
| A10= | −4.5278E−07 | −4.9968E−07 | 2.7502E−06 | 3.6739E−06 |
| A12= | 2.9674E−08 | 4.7557E−08 | −2.8074E−07 | −3.6245E−07 |
| A14= | −7.5974E−10 | −1.9927E−09 | 1.6312E−08 | 2.0158E−08 |
| A16= | 5.4755E−13 | 2.9638E−11 | −4.8914E−10 | −5.6362E−10 |
| A18= | — | — | 5.8739E−12 | 5.9299E−12 |

Moreover, these parameters shown in Table 4D can be calculated from Table 4A to Table 4C as the following values and satisfy the following conditions:

TABLE 4D
Schematic Parameters

| | | | |
|---|---|---|---|
| fL [mm] | 54.07 | f4/f2 | 0.41 |
| FnoL | 2.70 | flast2/f3 | 0.18 |
| HFOVL [deg.] | 4.3 | f12/f23 | 0.08 |
| FOVL [deg.] | 8.6 | f12/f56 | −0.27 |
| fS [mm] | 53.40 | (R5 + R6)/fL | 0.66 |
| FnoS | 2.67 | (R1 − R3)/(R1 + R3) | 0.15 |
| HFOVS [deg.] | 4.3 | R5/Rlast2 | 1.81 |
| FOVS [deg.] | 8.6 | CTmax/ATLmax | 0.51 |
| EPD [mm] | 20.03 | CTlast2/CT1 | 0.24 |
| ImgH [mm] | 4.15 | T12/T23 | 0.10 |
| fA1 [mm] | 32.59 | (T56 + CT6)/(CT4 + CT5) | 0.48 |
| fA2 [mm] | −23.46 | ATLmax/ImgH | 1.64 |
| fL/EPD | 2.70 | V6/N6 | 8.21 |
| MIN(fL/fi) | −7.45 | 2 × ImgH/EPD | 0.41 |
| MIN(fL/f5, fL/f6) | −5.39 | fL/(CRAL + HFOVL) [mm/deg.] | 4.13 |
| fL/TL | 1.44 | ETL3/CT3 | 1.70 |
| fL/fA1 | 1.66 | ETLlast/CTlast | 0.58 |
| fL/f2 | 1.37 | 10 × T12/ETL12 | 0.80 |
| \|fL/f3\| | 1.37 | YL1R1/YL8R2 | 2.41 |
| fL/f4 | 3.32 | (YLA1Rlast − | 0.32 |
| | | YLA2R1)/ETLA12 | |

In the 4th embodiment, the equation of the aspheric surface profiles of the aforementioned lens elements is the same as the equation of the 1st embodiment.

### 5th Embodiment

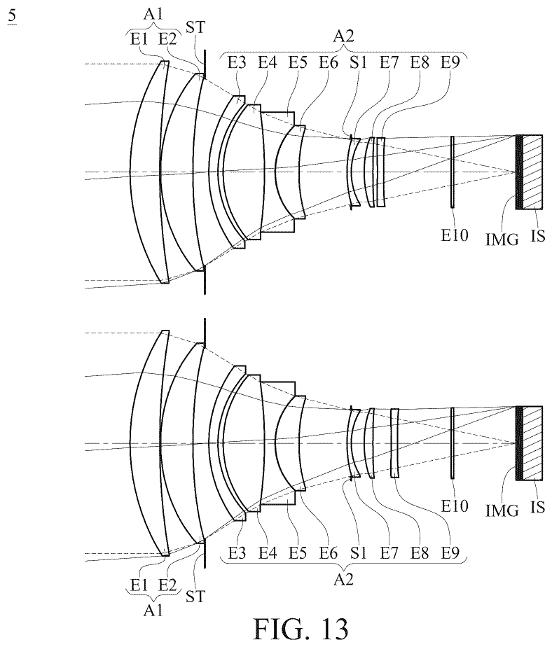

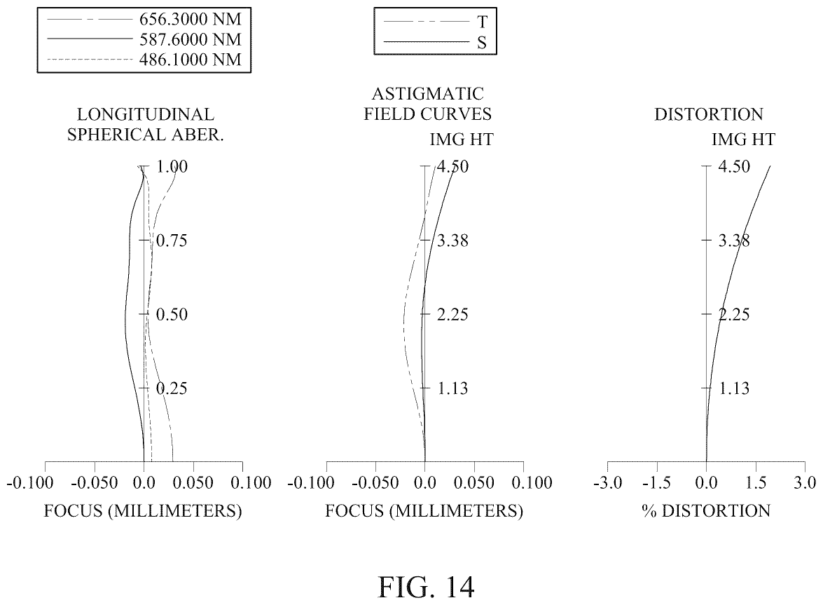

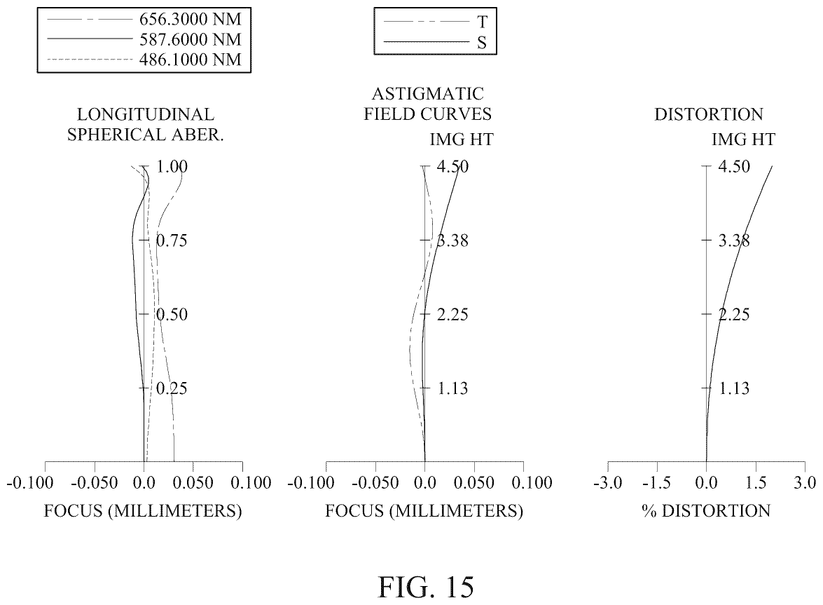

FIG. 13 is a schematic view of an image capturing unit at a first photography state and at a second photography state according to the 5th embodiment of the present disclosure. FIG. 14 shows, in order from left to right, spherical aberration curves, astigmatic field curves and a distortion curve of the image capturing unit at the first photography state according to the 5th embodiment. FIG. 15 shows, in order from left to right, spherical aberration curves, astigmatic field curves and a distortion curve of the image capturing unit at the second photography state according to the 5th embodiment. The upper part of FIG. 13 shows the photography optical system at the first photography state, and the lower part of FIG. 13 shows the photography optical system at the second photography state. In FIG. 13, the image capturing unit 5 includes the photography optical system (its reference numeral is omitted) of the present disclosure and an image sensor IS. The photography optical system includes, in order from an object side to an image side along an optical path, a first lens element E1, a second lens element E2, an aperture stop ST, a third lens element E3, a fourth lens element E4, a fifth lens element E5, a sixth lens element E6, a stop S1, a seventh lens element E7, an eighth lens element E8, a ninth lens element E9, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1 and the second lens element E2, and the second lens assembly A2 includes the third lens element E3, the fourth lens element E4, the fifth lens element E5, the sixth lens element E6, the seventh lens element E7, the eighth lens element E8 and the ninth lens element E9. The photography optical system includes nine lens elements (E1, E2, E3, E4, E5, E6, E7, E8 and E9) with no additional lens element disposed between each of the adjacent nine lens elements.

In the photography optical system of the 5th embodiment, first through ninth lens elements counting from the object side are respectively the first lens element E1 through the ninth lens element E9, and first through ninth lens elements counting from the image side are respectively the ninth lens element E9 through the first lens element E1, wherein the ninth lens element E9 is also be considered as a last lens element.

The photography optical system of the 5th embodiment perform a focus process for focusing by moving at least one lens element thereof. Through the focusing process, the photography optical system has a first photography state corresponding to an infinite object distance and a second photography state corresponding to a finite object distance as being 9000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the ninth lens element E9 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both aspheric.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical. The object-side surface of the fifth lens element E5 is cemented to the image-side surface of the fourth lens element E4.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with negative refractive power has an object-side surface being convex in a paraxial region thereof and an image-side surface being concave in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric.

The ninth lens element E9 with negative refractive power has an object-side surface being concave in a paraxial region thereof and an image-side surface being convex in a paraxial region thereof. The ninth lens element E9 is made of plastic material and has the object-side surface and the image-side surface being both aspheric.

The filter E10 is made of glass material and located between the ninth lens element E9 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the sixth lens element E6 and the seventh lens element E7.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 5th embodiment are shown in Table 5A and Table 5B, and the aspheric surface data are shown in Table 5C below.

TABLE 5A
5th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 26.0145 | (SPH) | 3.623 | Glass | 1.729 | 54.7 | 51.13 |
| 2 | | 81.0200 | (SPH) | 0.110 | | | | |
| 3 | Lens 2 | 20.1290 | (ASP) | 3.947 | Glass | 1.530 | 60.5 | 53.76 |
| 4 | | 63.8336 | (ASP) | 1.458 | | | | |
| 5 | Ape. Stop | Plano | | 0.470 | | | | |
| 6 | Lens 3 | 15.7597 | (SPH) | 1.125 | Glass | 1.904 | 31.4 | −76.79 |
| 7 | | 12.4078 | (SPH) | 0.620 | | | | |
| 8 | Lens 4 | 12.7326 | (SPH) | 5.057 | Glass | 1.511 | 60.5 | 20.83 |
| 9 | Lens 5 | −56.2589 | (SPH) | 1.278 | Glass | 1.904 | 31.4 | −7.72 |
| 10 | | 8.0441 | (SPH) | 0.051 | | | | |
| 11 | Lens 6 | 8.5350 | (ASP) | 2.881 | Plastic | 1.511 | 56.8 | 25.70 |
| 12 | | 21.6003 | (ASP) | 6.358 | | | | |
| 13 | Stop | Plano | | −0.500 | | | | |
| 14 | Lens 7 | 14.7560 | (SPH) | 0.514 | Glass | 1.847 | 23.8 | −20.42 |
| 15 | | 7.8346 | (SPH) | 1.591 | | | | |
| 16 | Lens 8 | 14.7839 | (ASP) | 1.062 | Plastic | 1.705 | 14.0 | 24.06 |
| 17 | | 111.9371 | (ASP) | D1 | | | | |
| 18 | Lens 9 | −54.6896 | (ASP) | 0.770 | Plastic | 1.511 | 56.8 | −117.03 |
| 19 | | −644.5955 | (ASP) | D2 | | | | |

| | | | | | | | |
|---|---|---|---|---|---|---|---|
| 20 | Filter | Plano | 0.300 | Glass | 1.517 | 64.2 | — |
| 21 | | Plano | 7.595 | | | | |
| 22 | Image | Plano | — | | | | |

Note:
Reference wavelength is 587.6 nm (d-line).
An effective radius of the stop S1 (Surface 13) is 4.118 mm.

TABLE 5B
Optical data for photography optical system at the first
photography state and the second photography state

| | first photography | | second photography |
|---|---|---|---|
| | state | | state |
| fL [mm] | 66.23 | fS [mm] | 65.16 |
| FnoL | 2.50 | FnoS | 2.46 |
| HFOVL [deg.] | 3.8 | HFOVS [deg.] | 3.8 |
| Object distance | infinity | Object distance | 9000.000 |
| [mm] | | [mm] | |
| D0 [mm] | infinity | D0 [mm] | 9000.000 |
| D1 [mm] | 0.549 | D1 [mm] | 2.239 |
| D2 [mm] | 8.240 | D2 [mm] | 6.550 |

In Table 5B, except for D1 being an axial distance between the image-side surface of the eighth lens element E8 and the object-side surface of the ninth lens element E9, D2 being an axial distance between the image-side surface of the ninth lens element E9 and the filter E10, and the finite object distance corresponded by fS, FnoS and HFOVS being 9000.000 mm, the other optical data is the same as the data of the 1st embodiment. Moreover, photography optical system of this embodiment can further have other focal lengths corresponding to other photography states in other focus conditions besides the first photography state and the second photography state for different object distances.

It can be known from Table 5A and Table 5B, the ninth lens element E9 moves along a direction parallel to the optical axis during the focus process.

TABLE 5C
Aspheric Coefficients

| Surface # | 3 | 4 | 11 | 12 |
|---|---|---|---|---|
| k= | 2.48880E−01 | 1.61206E+01 | 3.38102E−02 | −4.47643E+00 |
| A4= | 3.8470E−06 | 1.2479E−05 | 1.6569E−04 | 2.0179E−04 |
| A6= | 1.3877E−08 | −4.3461E−08 | 8.2993E−07 | −1.9529E−06 |
| A8= | 8.3690E−11 | −8.1920E−10 | −1.4155E−07 | −5.7933E−08 |
| A10= | −1.9402E−12 | 6.8728E−12 | 4.4846E−09 | 3.9432E−09 |
| A12= | 1.1551E−14 | −1.7740E−14 | −3.6257E−11 | −4.5946E−11 |
| Surface # | 16 | 17 | 18 | 19 |
| k= | 4.21003E−02 | −9.90000E+01 | −5.20561E+01 | −9.90000E+01 |
| A4= | 3.6548E−04 | 2.8508E−04 | 4.4295E−04 | 4.0803E−04 |
| A6= | −1.7408E−05 | −2.6624E−05 | 8.2779E−06 | 3.1870E−05 |
| A8= | 9.4713E−07 | 1.5429E−06 | −2.0372E−06 | −4.9738E−06 |
| A10= | 3.9074E−08 | 2.6243E−08 | 1.9074E−07 | 4.0311E−07 |
| A12= | −4.4995E−09 | −5.2868E−09 | −8.9663E−09 | −1.7184E−08 |
| A14= | 1.4338E−10 | 1.8159E−10 | 1.6941E−10 | 3.0124E−10 |

Moreover, these parameters shown in Table 5D can be calculated from Table 5A to Table 5C as the following values and satisfy the following conditions:

TABLE 5D
Schematic Parameters

| | | | |
|---|---|---|---|
| fL [mm] | 66.23 | f4/f2 | 0.39 |
| FnoL | 2.50 | flast2/f3 | −0.31 |
| HFOVL [deg.] | 3.8 | f12/f23 | 0.21 |
| FOVL [deg.] | 7.6 | f12/f56 | −2.56 |
| fS [mm] | 65.16 | (R5 + R6)/fL | 0.43 |
| FnoS | 2.46 | (R1 − R3)/(R1 + R3) | 0.13 |
| HFOVS [deg.] | 3.8 | R5/Rlast2 | −0.29 |
| FOVS [deg.] | 7.6 | CTmax/ATLmax | 0.86 |
| EPD [mm] | 26.49 | CTlast2/CT1 | 0.29 |
| ImgH [mm] | 4.50 | T12/T23 | 0.06 |
| fA1 [mm] | 26.71 | (T56 + CT6)/(CT4 + CT5) | 0.46 |
| fA2 [mm] | −15.71 | ATLmax/ImgH | 1.30 |
| fL/EPD | 2.50 | V6/N6 | 37.59 |
| MIN(fL/fi) | −8.58 | 2 × ImgH/EPD | 0.34 |
| MIN(fL/f5, fL/f6) | −8.58 | fL/(CRAL + HFOVL) [mm/deg.] | 5.31 |
| fL/TL | 1.41 | ETL3/CT3 | 1.22 |
| fL/fA1 | 2.48 | ETLlast/CTlast | 1.20 |
| fL/f2 | 1.23 | 10 × T12/ETL12 | 0.33 |
| \|fL/f3\| | 0.86 | YL1R1/YL8R2 | 3.23 |
| fL/f4 | 3.18 | (YLA1Rlast − | 0.60 |
| | | YLA2R1)/ETLA12 | |

In the 5th embodiment, the equation of the aspheric surface profiles of the aforementioned lens elements is the same as the equation of the 1st embodiment.

### 6th Embodiment

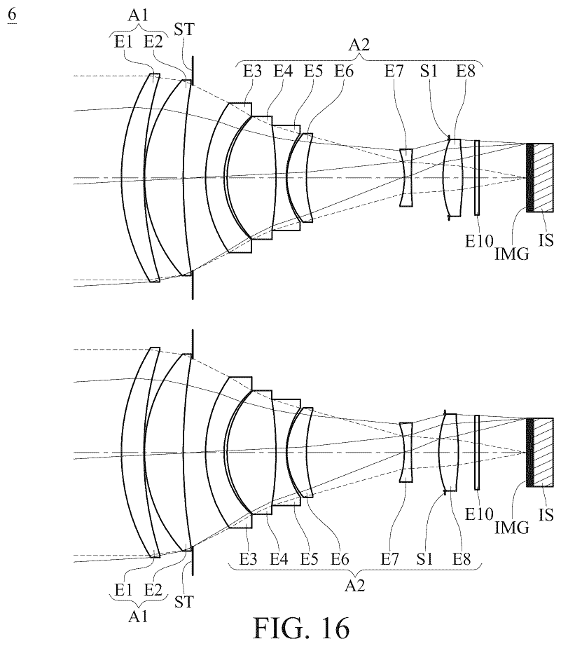

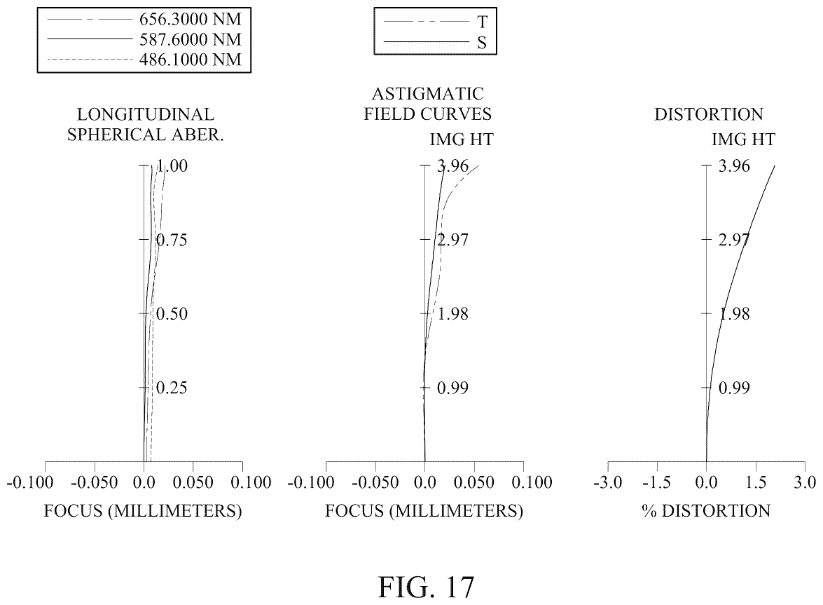

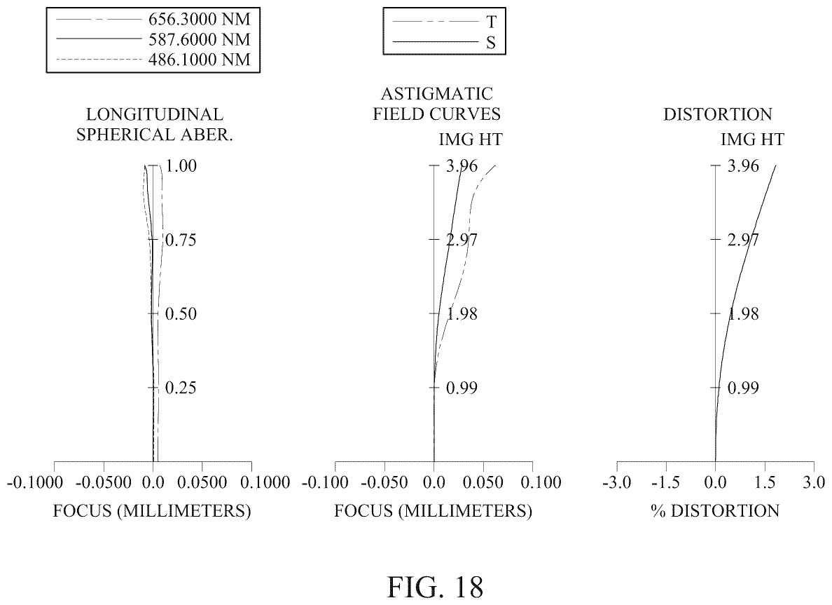

FIG. 16 is a schematic view of an image capturing unit at a first photography state and at a second photography state according to the 6th embodiment of the present disclosure. FIG. 17 shows, in order from left to right, spherical aberration curves, astigmatic field curves and a distortion curve of the image capturing unit at the first photography state according to the 6th embodiment. FIG. 18 shows, in order from left to right, spherical aberration curves, astigmatic field curves and a distortion curve of the image capturing unit at the second photography state according to the 6th embodiment. The upper part of FIG. 16 shows the photography optical system at the first photography state, and the lower part of FIG. 16 shows the photography optical system at the second photography state. In FIG. 16, the image capturing unit 6 includes the photography optical system (its reference numeral is omitted) of the present disclosure and an image sensor IS. The photography optical system includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, a stop S1, an eighth lens element E8, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1 and the second lens element E2, and the second lens assembly A2 includes the third lens element E3, the fourth lens element E4, the fifth lens element E5, the sixth lens element E6, the seventh lens element E7 and the eighth lens element E8. The photography optical system includes eight lens elements (E1, E2, E3, E4, E5, E6, E7 and E8) with no additional lens element disposed between each of the adjacent eight lens elements.

In the photography optical system of the 6th embodiment, first through eighth lens elements counting from the object side are respectively the first lens element E1 through the eighth lens element E8, and first through eighth lens elements counting from the image side are respectively the eighth lens element E8 through the first lens element E1, wherein the eighth lens element E8 is also be considered as a last lens element.

The photography optical system of the 6th embodiment perform a focus process for focusing by moving at least one lens element thereof. Through the focusing process, the photography optical system has a first photography state corresponding to an infinite object distance and a second photography state corresponding to a finite object distance as being 10000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the eighth lens element E8 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical. The object-side surface of the fifth lens element E5 is cemented to the image-side surface of the fourth lens element E4.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with negative refractive power has an object-side surface being concave in a paraxial region thereof and an image-side surface being concave in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being convex in a paraxial region thereof. The eighth lens element E8 is made of plastic material and has the object-side surface and the image-side surface being both aspheric.

The filter E10 is made of glass material and located between the eighth lens element E8 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the sixth lens element E6 and the seventh lens element E7.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 6th embodiment are shown in Table 6A and Table 6B, and the aspheric surface data are shown in Table 6C below.

TABLE 6A
6th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 23.4853 | (SPH) | 2.603 | Glass | 1.497 | 81.6 | 112.35 |
| 2 | | 39.0418 | (SPH) | 0.075 | | | | |
| 3 | Lens 2 | 16.9160 | (SPH) | 4.503 | Glass | 1.550 | 75.2 | 39.68 |
| 4 | | 68.0123 | (SPH) | 1.090 | | | | |
| 5 | Ape. Stop | Plano | | 1.482 | | | | |
| 6 | Lens 3 | 15.1239 | (SPH) | 2.150 | Glass | 1.911 | 35.2 | −35.99 |
| 7 | | 9.6477 | (SPH) | 0.343 | | | | |
| 8 | Lens 4 | 10.1033 | (SPH) | 5.688 | Glass | 1.497 | 81.6 | 16.85 |
| 9 | Lens 5 | −39.8129 | (SPH) | 1.190 | Glass | 1.904 | 31.3 | −8.08 |
| 10 | | 9.0635 | (SPH) | 0.071 | | | | |
| 11 | Lens 6 | 7.7216 | (ASP) | 2.259 | Plastic | 1.661 | 20.4 | 19.18 |
| 12 | | 17.4391 | (ASP) | 11.371 | | | | |
| 13 | Lens 7 | −10.0405 | (SPH) | 0.792 | Glass | 1.847 | 23.8 | −9.69 |
| 14 | | 46.5259 | (SPH) | D1 | | | | |
| 15 | Stop | Plano | | −0.700 | | | | |
| 16 | Lens 8 | 14.5637 | (ASP) | 2.274 | Plastic | 1.661 | 20.4 | 13.76 |
| 17 | | −22.7550 | (ASP) | D2 | | | | |

| | | | | | | | |
|---|---|---|---|---|---|---|---|
| 18 | Filter | Plano | 0.510 | Glass | 1.517 | 64.2 | — |
| 19 | | Plano | 5.511 | | | | |
| 20 | Image | Plano | — | | | | |

Note:
Reference wavelength is 587.6 nm (d-line).
An effective radius of the stop S1 (Surface 15) is 4.430 mm.

TABLE 6B
Optical data for photography optical system at the first
photography state and the second photography state

| | first photography | | second photography |
|---|---|---|---|
| | state | | state |
| fL [mm] | 65.66 | fS [mm] | 64.72 |
| FnoL | 2.77 | FnoS | 2.73 |
| HFOVL [deg.] | 3.4 | HFOVS [deg.] | 3.4 |
| Object distance | infinity | Object distance | 10000.000 |
| [mm] | | [mm] | |
| D0 [mm] | infinity | D0 [mm] | 10000.000 |
| D1 [mm] | 4.381 | D1 [mm] | 3.897 |
| D2 [mm] | 1.416 | D2 [mm] | 1.900 |

In Table 6B, except for D1 being an axial distance between the image-side surface of the seventh lens element E7 and the stop S1, the other optical data is the same as the data of the 1st embodiment. Moreover, photography optical system of this embodiment can further have other focal lengths corresponding to other photography states in other focus conditions besides the first photography state and the second photography state for different object distances.

It can be known from Table 6A and Table 6B, the stop S1 and the eighth lens element E8 move along a direction parallel to the optical axis during the focus process.

TABLE 6C
Aspheric Coefficients

| Surface # | 11 | 12 | 16 | 17 |
|---|---|---|---|---|
| k= | −3.36083E−01 | −1.97890E+00 | 1.05560E+00 | 8.98945E−01 |
| A4= | 4.9331E−05 | 1.2765E−04 | 7.2966E−05 | 2.7357E−04 |
| A6= | −6.0791E−07 | −1.9031E−06 | 5.2332E−06 | 1.0698E−05 |
| A8= | −5.9617E−10 | 6.3077E−08 | 3.1041E−07 | −1.7168E−07 |
| A10= | 6.1987E−10 | −9.1492E−10 | −2.8634E−08 | 2.3100E−09 |
| A12= | −3.6305E−11 | −2.3296E−11 | 6.7528E−10 | −2.7112E−10 |
| A14= | 8.5437E−13 | −3.2826E−13 | 3.5631E−11 | 4.7718E−11 |
| A16= | −2.9386E−14 | −4.6518E−15 | −1.1027E−12 | −1.0335E−12 |

Moreover, these parameters shown in Table 6D can be calculated from Table 6A to Table 6C as the following values and satisfy the following conditions:

TABLE 6D
Schematic Parameters

| | | | |
|---|---|---|---|
| fL [mm] | 65.66 | f4/f2 | 0.42 |
| FnoL | 2.77 | flast2/f3 | 0.27 |
| HFOVL [deg.] | 3.4 | f12/f23 | 0.14 |
| FOVL [deg.] | 6.8 | f12/f56 | −2.30 |
| fS [mm] | 64.72 | (R5 + R6)/fL | 0.38 |
| FnoS | 2.73 | (R1 − R3)/(R1 + R3) | 0.16 |
| HFOVS [deg.] | 3.4 | R5/Rlast2 | 1.04 |
| FOVS [deg.] | 6.8 | CTmax/ATLmax | 0.50 |
| EPD [mm] | 23.69 | CTlast2/CT1 | 0.30 |
| ImgH [mm] | 3.96 | T12/T23 | 0.03 |
| fA1 [mm] | 29.97 | (T56 + CT6)/(CT4 + CT5) | 0.34 |
| fA2 [mm] | −53.76 | ATLmax/ImgH | 2.87 |
| fL/EPD | 2.77 | V6/N6 | 12.28 |
| MIN(fL/fi) | −8.13 | 2 × ImgH/EPD | 0.33 |
| MIN(fL/f5, fL/f6) | −8.13 | fL/(CRAL + HFOVL) [mm/deg.] | 9.47 |
| fL/TL | 1.40 | ETL3/CT3 | 1.24 |
| fL/fA1 | 2.19 | ETLlast/CTlast | 0.53 |
| fL/f2 | 1.65 | 10 × T12/ETL12 | 0.29 |
| \|fL/f3\| | 1.82 | YL1R1/YL8R2 | 2.74 |
| fL/f4 | 3.90 | (YLA1Rlast − | 0.45 |
| | | YLA2R1)/ETLA12 | |

In the 6th embodiment, the equation of the aspheric surface profiles of the aforementioned lens elements is the same as the equation of the 1st embodiment.

### 7th Embodiment

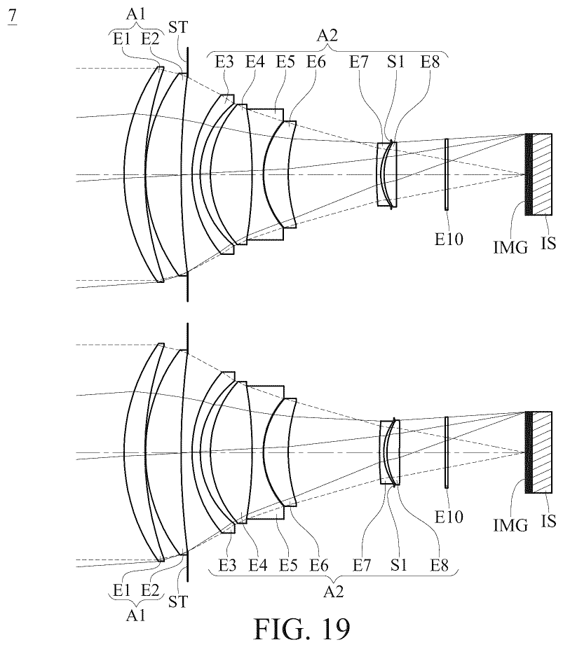

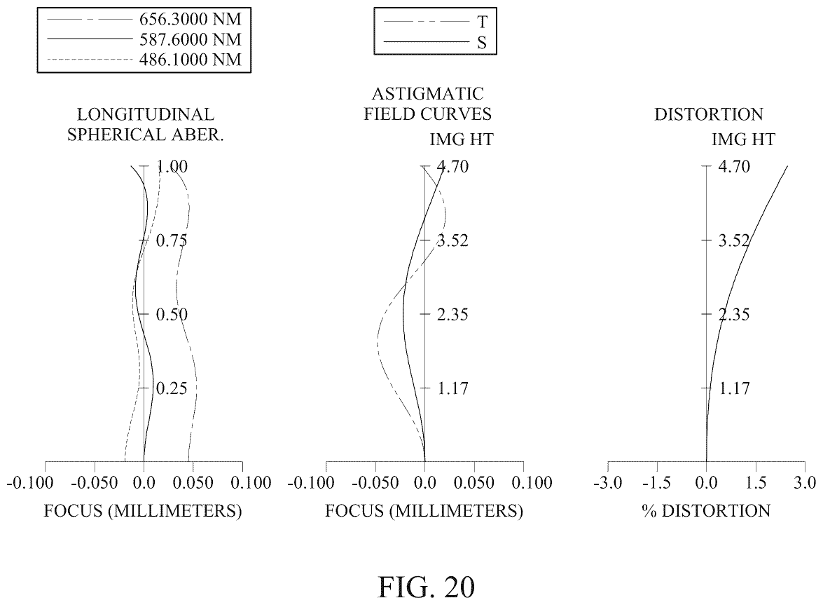

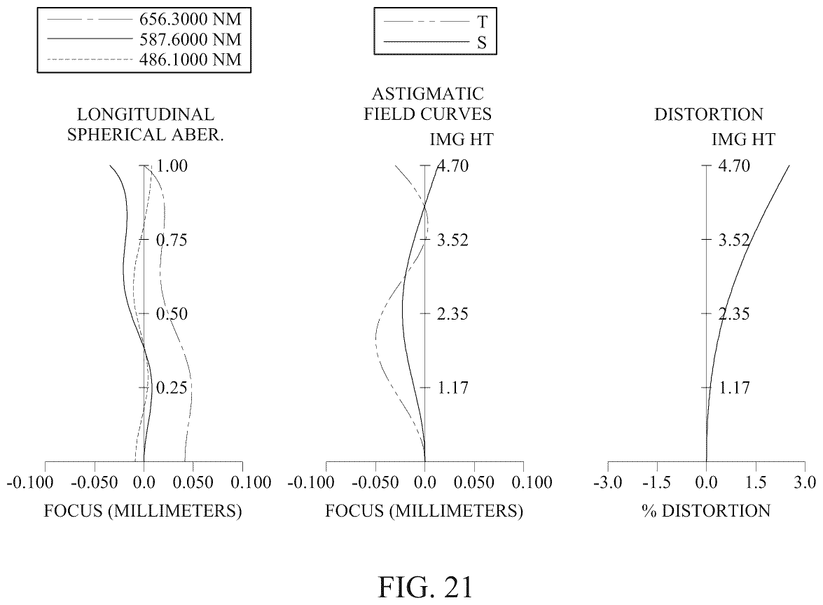

FIG. 19 is a schematic view of an image capturing unit at a first photography state and at a second photography state according to the 7th embodiment of the present disclosure. FIG. 20 shows, in order from left to right, spherical aberration curves, astigmatic field curves and a distortion curve of the image capturing unit at the first photography state according to the 7th embodiment. FIG. 21 shows, in order from left to right, spherical aberration curves, astigmatic field curves and a distortion curve of the image capturing unit at the second photography state according to the 7th embodiment. The upper part of FIG. 19 shows the photography optical system at the first photography state, and the lower part of FIG. 19 shows the photography optical system at the second photography state. In FIG. 19, the image capturing unit 7 includes the photography optical system (its reference numeral is omitted) of the present disclosure and an image sensor IS. The photography optical system includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, a stop S1, an eighth lens element E8, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1 and the second lens element E2, and the second lens assembly A2 includes the third lens element E3, the fourth lens element E4, the fifth lens element E5, the sixth lens element E6, the seventh lens element E7 and the eighth lens element E8. The photography optical system includes eight lens elements (E1, E2, E3, E4, E5, E6, E7 and E8) with no additional lens element disposed between each of the adjacent eight lens elements.

In the photography optical system of the 7th embodiment, first through eighth lens elements counting from the object side are respectively the first lens element E1 through the eighth lens element E8, and first through eighth lens elements counting from the image side are respectively the eighth lens element E8 through the first lens element E1, wherein the eighth lens element E8 is also be considered as a last lens element.

The photography optical system of the 7th embodiment perform a focus process for focusing by moving at least one lens element thereof. Through the focusing process, the photography optical system has a first photography state corresponding to an infinite object distance and a second photography state corresponding to a finite object distance as being 12000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the seventh lens element E7 and the eighth lens element E8 move along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical. The object-side surface of the fifth lens element E5 is cemented to the image-side surface of the fourth lens element E4.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with negative refractive power has an object-side surface being convex in a paraxial region thereof and an image-side surface being concave in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric.

The filter E10 is made of glass material and located between the eighth lens element E8 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the sixth lens element E6 and the seventh lens element E7.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 7th embodiment are shown in Table 7A and Table 7B, and the aspheric surface data are shown in Table 7C below.

TABLE 7A
7th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 21.9554 | (SPH) | 2.435 | Glass | 1.767 | 49.2 | 68.64 |
| 2 | | 35.8454 | (SPH) | 0.063 | | | | |
| 3 | Lens 2 | 19.7362 | (SPH) | 4.120 | Glass | 1.511 | 60.5 | 48.40 |
| 4 | | 90.7286 | (SPH) | 0.760 | | | | |
| 5 | Ape. Stop | Plano | | 0.510 | | | | |
| 6 | Lens 3 | 14.3086 | (SPH) | 0.947 | Glass | 1.904 | 31.4 | −52.95 |
| 7 | | 10.6685 | (SPH) | 1.174 | | | | |
| 8 | Lens 4 | 12.2055 | (SPH) | 4.846 | Glass | 1.511 | 60.5 | 19.45 |
| 9 | Lens 5 | −46.3513 | (SPH) | 1.261 | Glass | 1.847 | 23.8 | −9.07 |
| 10 | | 9.3216 | (SPH) | 0.059 | | | | |
| 11 | Lens 6 | 9.0989 | (ASP) | 2.860 | Plastic | 1.686 | 18.4 | 22.92 |
| 12 | | 18.8336 | (ASP) | D1 | | | | |
| 13 | Lens 7 | 43.7560 | (SPH) | 0.491 | Glass | 1.804 | 46.6 | −9.32 |
| 14 | | 6.3653 | (SPH) | 1.211 | | | | |
| 15 | Stop | Plano | | −0.830 | | | | |
| 16 | Lens 8 | 7.5076 | (ASP) | 1.451 | Plastic | 1.614 | 26.0 | 12.79 |
| 17 | | 158.6940 | (ASP) | D2 | | | | |

| | | | | | | | |
|---|---|---|---|---|---|---|---|
| 18 | Filter | Plano | 0.300 | Glass | 1.517 | 64.2 | — |
| 19 | | Plano | 8.994 | | | | |
| 20 | Image | Plano | — | | | | |

Note:
Reference wavelength is 587.6 nm (d-line).
An effective radius of the stop S1 (Surface 15) is 3.625 mm.

TABLE 7B
Optical data for photography optical system at the first
photography state and the second photography state

| | first photography | | second photography |
|---|---|---|---|
| | state | | state |
| fL [mm] | 66.00 | fS [mm] | 65.15 |
| FnoL | 2.68 | FnoS | 2.65 |
| HFOVL [deg.] | 4.0 | HFOVS [deg.] | 4.0 |
| Object distance | infinity | Object distance | 12000.000 |
| [mm] | | [mm] | |
| D0 [mm] | infinity | D0 [mm] | 12000.000 |
| D1 [mm] | 10.221 | D1 [mm] | 10.558 |
| D2 [mm] | 5.646 | D2 [mm] | 5.309 |

In Table 7B, except for D1 being an axial distance between the image-side surface of the sixth lens element E6 and the object-side surface of the seventh lens element E7, and the finite object distance corresponded by fS, FnoS and HFOVS being 12000.000 mm, the other optical data is the same as the data of the 1st embodiment. Moreover, photography optical system of this embodiment can further have other focal lengths corresponding to other photography states in other focus conditions besides the first photography state and the second photography state for different object distances.

It can be known from Table 7A and Table 7B, the seventh lens element E7, the stop S1 and the eighth lens element E8 move along a direction parallel to the optical axis during the focus process.

TABLE 7C
Aspheric Coefficients

| Surface # | 11 | 12 | 16 | 17 |
|---|---|---|---|---|
| k= | −1.97732E−01 | −6.52270E+00 | −5.26864E−01 | 8.66773E+01 |
| A4= | 2.6925E−05 | 1.3555E−04 | 1.0761E−05 | −3.5409E−04 |
| A6= | 9.4388E−08 | −1.7930E−06 | 5.2750E−05 | 7.1182E−05 |
| A8= | −1.2062E−08 | 3.0584E−08 | −7.7271E−06 | −1.1191E−05 |
| A10= | 3.5066E−10 | −8.2130E−10 | 5.4332E−07 | 7.6666E−07 |
| A12= | −8.1044E−12 | 3.7131E−12 | −1.5571E−08 | −2.1773E−08 |

Moreover, these parameters shown in Table 7D can be calculated from Table 7A to Table 7C as the following values and satisfy the following conditions:

TABLE 7D
Schematic Parameters

| | | | |
|---|---|---|---|
| fL [mm] | 66.00 | f4/f2 | 0.40 |
| FnoL | 2.68 | flast2/f3 | 0.18 |
| HFOVL [deg.] | 4.0 | f12/f23 | 0.13 |
| FOVL [deg.] | 8.0 | f12/f56 | −2.11 |
| fS [mm] | 65.15 | (R5 + R6)/fL | 0.38 |
| FnoS | 2.65 | (R1 − R3)/(R1 + R3) | 0.05 |
| HFOVS [deg.] | 4.0 | R5/Rlast2 | 1.91 |
| FOVS [deg.] | 8.0 | CTmax/ATLmax | 0.47 |
| EPD [mm] | 24.63 | CTlast2/CT1 | 0.20 |
| ImgH [mm] | 4.70 | T12/T23 | 0.05 |
| fA1 [mm] | 29.04 | (T56 + CT6)/(CT4 + CT5) | 0.48 |
| fA2 [mm] | −15.87 | ATLmax/ImgH | 2.17 |
| fL/EPD | 2.68 | V6/N6 | 10.91 |
| MIN(fL/fi) | −7.28 | 2 × ImgH/EPD | 0.38 |
| MIN(fL/f5, fL/f6) | −7.28 | fL/(CRAL + HFOVL) [mm/deg.] | 4.83 |
| fL/TL | 1.42 | ETL3/CT3 | 1.59 |
| fL/fA1 | 2.27 | ETLlast/CTlast | 0.32 |
| fL/f2 | 1.36 | 10 × T12/ETL12 | 0.35 |
| \|fL/f3\| | 1.25 | YL1R1/YL8R2 | 3.34 |
| fL/f4 | 3.39 | (YLA1Rlast − YLA2R1)/ETLA12 | 0.50 |

In the 7th embodiment, the equation of the aspheric surface profiles of the aforementioned lens elements is the same as the equation of the 1st embodiment.

### 8th Embodiment

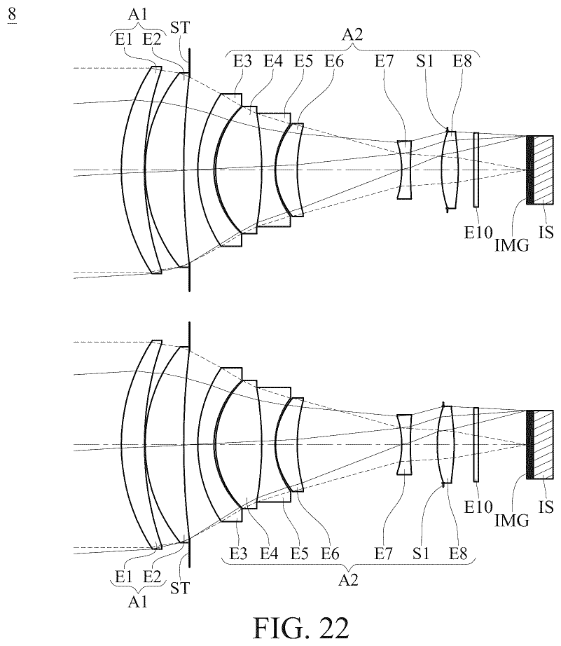

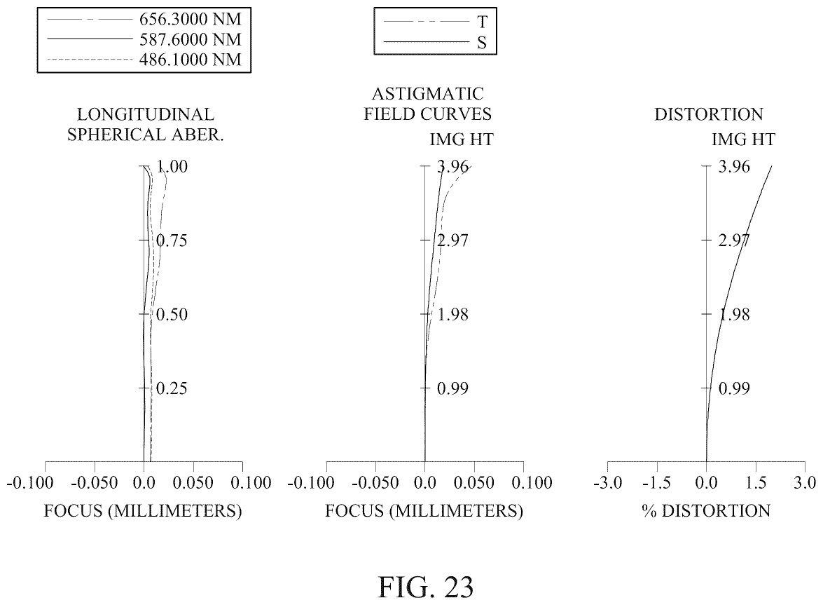

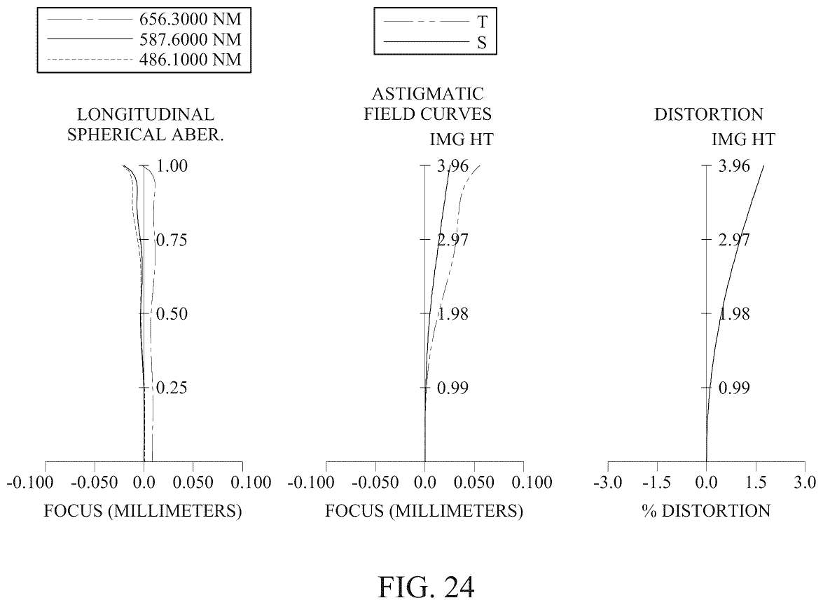

FIG. 22 is a schematic view of an image capturing unit at a first photography state and at a second photography state according to the 8th embodiment of the present disclosure. FIG. 23 shows, in order from left to right, spherical aberration curves, astigmatic field curves and a distortion curve of the image capturing unit at the first photography state according to the 8th embodiment. FIG. 24 shows, in order from left to right, spherical aberration curves, astigmatic field curves and a distortion curve of the image capturing unit at the second photography state according to the 8th embodiment. The upper part of FIG. 22 shows the photography optical system at the first photography state, and the lower part of FIG. 22 shows the photography optical system at the second photography state. In FIG. 22, the image capturing unit 8 includes the photography optical system (its reference numeral is omitted) of the present disclosure and an image sensor IS. The photography optical system includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, a stop S1, an eighth lens element E8, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1 and the second lens element E2, and the second lens assembly A2 includes the third lens element E3, the fourth lens element E4, the fifth lens element E5, the sixth lens element E6, the seventh lens element E7 and the eighth lens element E8. The photography optical system includes eight lens elements (E1, E2, E3, E4, E5, E6, E7 and E8) with no additional lens element disposed between each of the adjacent eight lens elements.

In the photography optical system of the 8th embodiment, first through eighth lens elements counting from the object side are respectively the first lens element E1 through the eighth lens element E8, and first through eighth lens elements counting from the image side are respectively the eighth lens element E8 through the first lens element E1, wherein the eighth lens element E8 is also be considered as a last lens element.

The photography optical system of the 8th embodiment perform a focus process for focusing by moving at least one lens element thereof. Through the focusing process, the photography optical system has a first photography state corresponding to an infinite object distance and a second photography state corresponding to a finite object distance as being 10000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the eighth lens element E8 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of glass material and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical. The object-side surface of the fifth lens element E5 is cemented to the image-side surface of the fourth lens element E4.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with negative refractive power has an object-side surface being concave in a paraxial region thereof and an image-side surface being concave in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being convex in a paraxial region thereof. The eighth lens element E8 is made of plastic material and has the object-side surface and the image-side surface being both aspheric.

The filter E10 is made of glass material and located between the eighth lens element E8 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the sixth lens element E6 and the seventh lens element E7.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 8th embodiment are shown in Table 8A and Table 8B, and the aspheric surface data are shown in Table 8C below.

TABLE 8A
8th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 22.0835 | (SPH) | 2.677 | Glass | 1.569 | 63.1 | 94.82 |
| 2 | | 35.7555 | (SPH) | 0.078 | | | | |
| 3 | Lens 2 | 17.8400 | (SPH) | 4.478 | Glass | 1.569 | 71.3 | 37.97 |
| 4 | | 93.0089 | (SPH) | 0.675 | | | | |
| 5 | Ape. Stop | Plano | | 0.957 | | | | |
| 6 | Lens 3 | 15.8849 | (SPH) | 1.878 | Glass | 1.911 | 35.2 | −36.46 |
| 7 | | 10.1398 | (SPH) | 0.190 | | | | |
| 8 | Lens 4 | 10.3685 | (SPH) | 5.353 | Glass | 1.497 | 81.6 | 17.01 |
| 9 | Lens 5 | −37.8898 | (SPH) | 1.521 | Glass | 1.904 | 31.3 | −7.90 |
| 10 | | 8.9596 | (SPH) | 0.078 | | | | |
| 11 | Lens 6 | 8.0218 | (ASP) | 2.514 | Plastic | 1.661 | 20.4 | 19.43 |
| 12 | | 18.6869 | (ASP) | 12.126 | | | | |
| 13 | Lens 7 | −10.2940 | (SPH) | 0.987 | Glass | 1.847 | 23.8 | −9.85 |
| 14 | | 45.8229 | (SPH) | D1 | | | | |
| 15 | Stop | Plano | | −0.700 | | | | |
| 16 | Lens 8 | 15.7909 | (ASP) | 1.958 | Plastic | 1.661 | 20.4 | 13.95 |
| 17 | | −21.1086 | (ASP) | D2 | | | | |

| | | | | | | | |
|---|---|---|---|---|---|---|---|
| 18 | Filter | Plano | 0.510 | Glass | 1.517 | 64.2 | — |
| 19 | | Plano | 5.623 | | | | |
| 20 | Image | Plano | — | | | | |

Note:
Reference wavelength is 587.6 nm (d-line).
An effective radius of the stop S1 (Surface 15) is 4.445 mm.

TABLE 8B
Optical data for photography optical system at the first
photography state and the second photography state

| | first photography | | second photography |
|---|---|---|---|
| | state | | state |
| fL [mm] | 65.73 | fS [mm] | 64.85 |
| FnoL | 2.78 | FnoS | 2.74 |
| HFOVL [deg.] | 3.4 | HFOVS [deg.] | 3.4 |
| Object distance | infinity | Object distance | 10000.000 |
| [mm] | | [mm] | |
| D0 [mm] | infinity | D0 [mm] | 10000.000 |
| D1 [mm] | 4.304 | D1 [mm] | 3.826 |
| D2 [mm] | 1.812 | D2 [mm] | 2.290 |

In Table 8B, except for D1 being an axial distance between the image-side surface of the seventh lens element E7 and the stop S1, the other optical data is the same as the data of the 1st embodiment. Moreover, photography optical system of this embodiment can further have other focal lengths corresponding to other photography states in other focus conditions besides the first photography state and the second photography state for different object distances.

It can be known from Table 8A and Table 8B, the stop S1 and the eighth lens element E8 move along a direction parallel to the optical axis during the focus process.

TABLE 8C
Aspheric Coefficients

| Surface # | 11 | 12 | 16 | 17 |
|---|---|---|---|---|
| k= | −5.53348E−01 | −4.12789E+00 | 1.19255E−01 | −9.92134E−02 |
| A4= | 7.7774E−05 | 1.0000E−04 | 9.2119E−05 | 2.3742E−04 |
| A6= | −3.6801E−07 | −2.6836E−06 | 1.3691E−06 | 3.4884E−06 |
| A8= | −8.5969E−09 | 6.4231E−08 | 4.8054E−07 | 2.6904E−07 |
| A10= | 7.8772E−10 | −1.7965E−09 | −2.3768E−08 | −7.2206E−09 |
| A12= | −2.3492E−11 | −7.5245E−12 | −8.9867E−11 | −9.3299E−10 |
| A14= | −2.9541E−13 | 6.7061E−14 | 7.1135E−11 | 9.9401E−11 |
| A16= | 1.5478E−15 | −1.0307E−15 | −1.5130E−12 | −1.8222E−12 |

Moreover, these parameters shown in Table 8D can be calculated from Table 8A to Table 8C as the following values and satisfy the following conditions:

TABLE 8D
Schematic Parameters

| | | | |
|---|---|---|---|
| fL [mm] | 65.73 | f4/f2 | 0.45 |
| FnoL | 2.78 | flast2/f3 | 0.27 |
| HFOVL [deg.] | 3.4 | f12/f23 | 0.14 |
| FOVL [deg.] | 6.8 | f12/f56 | −2.24 |
| fS [mm] | 64.85 | (R5 + R6)/fL | 0.40 |
| FnoS | 2.74 | (R1 − R3)/(R1 + R3) | 0.11 |
| HFOVS [deg.] | 3.4 | R5/Rlast2 | 1.01 |
| FOVS [deg.] | 6.8 | CTmax/ATLmax | 0.44 |
| EPD [mm] | 23.64 | CTlast2/CT1 | 0.37 |
| ImgH [mm] | 3.96 | T12/T23 | 0.05 |
| fA1 [mm] | 27.86 | (T56 + CT6)/(CT4 + CT5) | 0.38 |
| fA2 [mm] | −46.19 | ATLmax/ImgH | 3.06 |
| fL/EPD | 2.78 | V6/N6 | 12.28 |
| MIN(fL/fi) | −8.32 | 2 × ImgH/EPD | 0.34 |
| MIN(fL/f5, fL/f6) | −8.32 | fL/(CRAL + HFOVL) [mm/deg.] | 9.45 |
| fL/TL | 1.40 | ETL3/CT3 | 1.32 |
| fL/fA1 | 2.36 | ETLlast/CTlast | 0.46 |
| fL/f2 | 1.73 | 10 × T12/ETL12 | 0.37 |
| \|fL/f3\| | 1.80 | YL1R1/YL8R2 | 2.71 |
| fL/f4 | 3.86 | (YLA1Rlast − YLA2R1)/ETLA12 | 0.48 |

In the 8th embodiment, the equation of the aspheric surface profiles of the aforementioned lens elements is the same as the equation of the 1st embodiment.

### 9th Embodiment

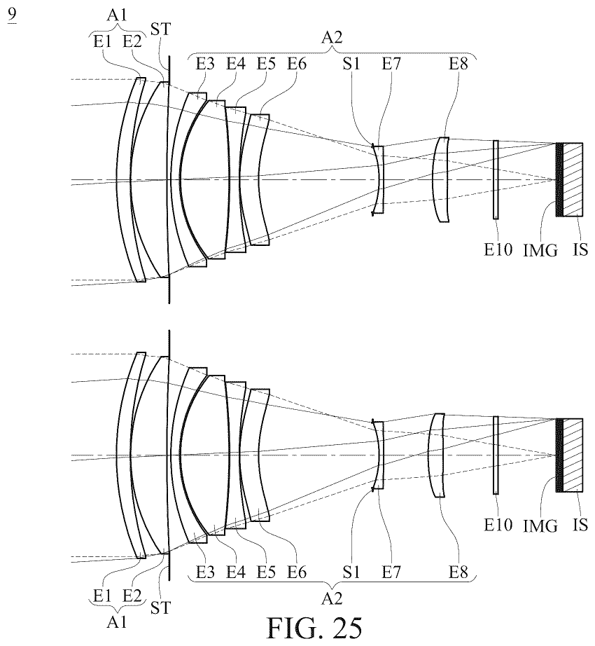

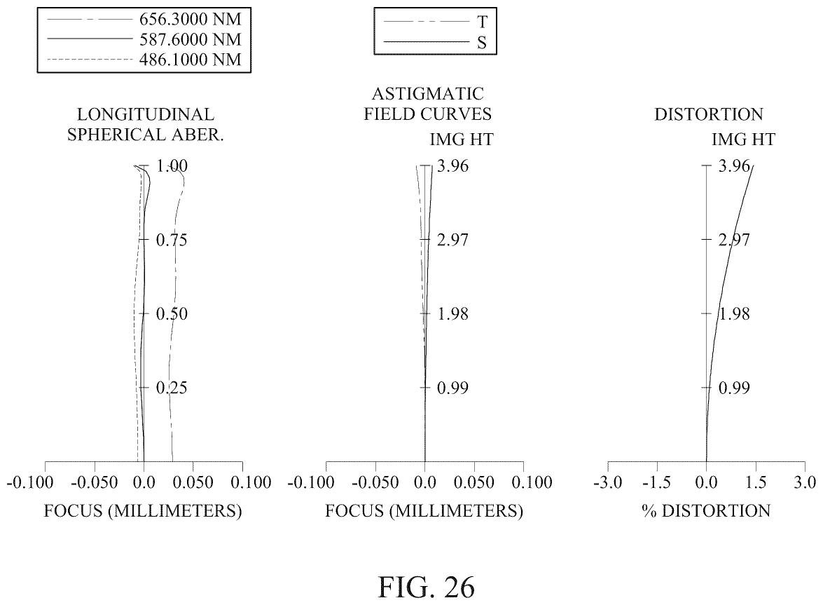

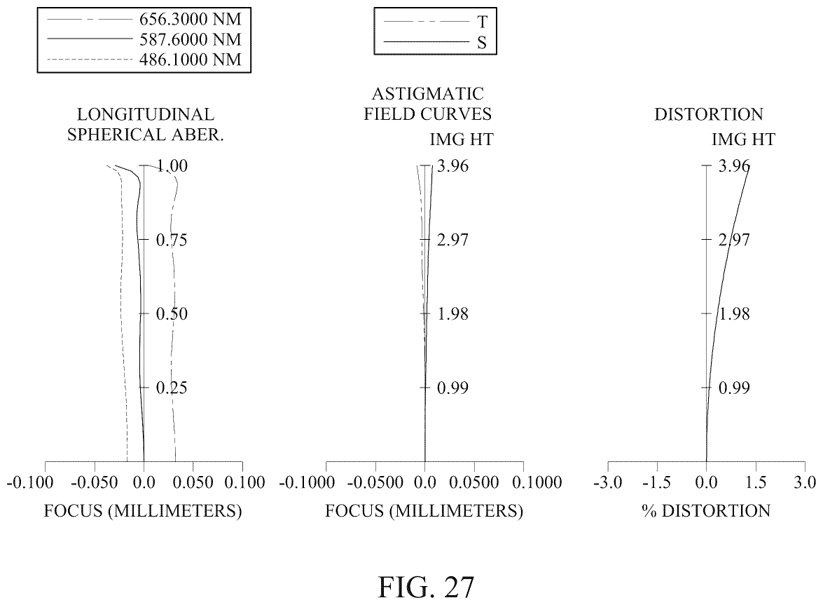

FIG. 25 is a schematic view of an image capturing unit at a first photography state and at a second photography state according to the 9th embodiment of the present disclosure. FIG. 26 shows, in order from left to right, spherical aberration curves, astigmatic field curves and a distortion curve of the image capturing unit at the first photography state according to the 9th embodiment. FIG. 27 shows, in order from left to right, spherical aberration curves, astigmatic field curves and a distortion curve of the image capturing unit at the second photography state according to the 9th embodiment. The upper part of FIG. 25 shows the photography optical system at the first photography state, and the lower part of FIG. 25 shows the photography optical system at the second photography state. In FIG. 25, the image capturing unit 9 includes the photography optical system (its reference numeral is omitted) of the present disclosure and an image sensor IS. The photography optical system includes, in order from an object side to an image side along an optical path, a first lens element E1, a second lens element E2, an aperture stop ST, a third lens element E3, a fourth lens element E4, a fifth lens element E5, a sixth lens element E6, a stop S1, a seventh lens element E7, an eighth lens element E8, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1 and the second lens element E2, and the second lens assembly A2 includes the third lens element E3, the fourth lens element E4, the fifth lens element E5, the sixth lens element E6, the seventh lens element E7 and the eighth lens element E8. The photography optical system includes eight lens elements (E1, E2, E3, E4, E5, E6, E7 and E8) with no additional lens element disposed between each of the adjacent eight lens elements.

In the photography optical system of the 9th embodiment, first through eighth lens elements counting from the object side are respectively the first lens element E1 through the eighth lens element E8, and first through eighth lens elements counting from the image side are respectively the eighth lens element E8 through the first lens element E1, wherein the eighth lens element E8 is also be considered as a last lens element.

The photography optical system of the 9th embodiment perform a focus process for focusing by moving at least one lens element thereof. Through the focusing process, the photography optical system has a first photography state corresponding to an infinite object distance and a second photography state corresponding to a finite object distance as being 10000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the eighth lens element E8 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with negative refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with negative refractive power has an object-side surface being concave in a paraxial region thereof and an image-side surface being convex in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being convex in a paraxial region thereof. The eighth lens element E8 is made of plastic material and has the object-side surface and the image-side surface being both aspheric.

The filter E10 is made of glass material and located between the eighth lens element E8 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the sixth lens element E6 and the seventh lens element E7.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 9th embodiment are shown in Table 9A and Table 9B, and the aspheric surface data are shown in Table 9C below.

TABLE 9A
9th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 28.7149 | (SPH) | 1.500 | Glass | 1.946 | 17.9 | 131.60 |
| 2 | | 36.3765 | (SPH) | 0.037 | | | | |
| 3 | Lens 2 | 18.8745 | (SPH) | 3.930 | Glass | 1.511 | 60.5 | 40.08 |
| 4 | | 222.9112 | (SPH) | 0.271 | | | | |
| 5 | Ape. Stop | Plano | | 0.170 | | | | |
| 6 | Lens 3 | 23.7014 | (SPH) | 0.938 | Glass | 1.847 | 23.8 | −43.40 |
| 7 | | 14.1467 | (SPH) | 0.110 | | | | |
| 8 | Lens 4 | 13.6227 | (ASP) | 5.260 | Plastic | 1.544 | 56.0 | 21.32 |
| 9 | | −67.4051 | (ASP) | 0.071 | | | | |
| 10 | Lens 5 | −67.4544 | (SPH) | 1.050 | Glass | 1.904 | 31.4 | −26.96 |
| 11 | | 38.4173 | (SPH) | 0.041 | | | | |
| 12 | Lens 6 | 16.6320 | (ASP) | 2.046 | Plastic | 1.697 | 16.3 | −301.88 |
| 13 | | 14.6350 | (ASP) | 12.383 | | | | |
| 14 | Stop | Plano | | 0.700 | | | | |
| 15 | Lens 7 | −9.9050 | (SPH) | 0.480 | Glass | 1.923 | 18.9 | −11.82 |
| 16 | | −110.3588 | (SPH) | D1 | | | | |
| 17 | Lens 8 | 19.0625 | (ASP) | 1.620 | Plastic | 1.705 | 14.0 | 21.56 |
| 18 | | −72.2821 | (ASP) | D2 | | | | |

| | | | | | | | |
|---|---|---|---|---|---|---|---|
| 19 | Filter | Plano | 0.510 | Glass | 1.517 | 64.2 | — |
| 20 | | Plano | 6.305 | | | | |
| 21 | Image | Plano | — | | | | |

Note:
Reference wavelength is 587.6 nm (d-line).
An effective radius of the stop S1 (Surface 14) is 3.536 mm.

TABLE 9B
Optical data for photography optical system at the first
photography state and the second photography state

| | first photography | | second photography |
|---|---|---|---|
| | state | | state |
| fL [mm] | 62.78 | fS [mm] | 62.20 |
| FnoL | 2.88 | FnoS | 2.85 |
| HFOVL [deg.] | 3.6 | HFOVS [deg.] | 3.6 |
| Object distance | infinity | Object distance | 10000.000 |
| [mm] | | [mm] | |
| D0 [mm] | infinity | D0 [mm] | 10000.000 |
| D1 [mm] | 5.305 | D1 [mm] | 4.834 |
| D2 [mm] | 4.995 | D2 [mm] | 5.466 |

In Table 9B, the optical data is the same as the data of the 1st embodiment. Moreover, photography optical system of this embodiment can further have other focal lengths corresponding to other photography states in other focus conditions besides the first photography state and the second photography state for different object distances.

It can be known from Table 9A and Table 9B, the eighth lens element E8 moves along a direction parallel to the optical axis during the focus process.

TABLE 9C
Aspheric Coefficients

| Surface # | 8 | 9 | 12 | 13 |
|---|---|---|---|---|
| k= | −4.67450E−02 | 5.63101E+00 | −6.47633E+00 | −8.45969E+00 |
| A4= | 8.7925E−06 | 1.2158E−05 | 5.1271E−05 | 1.6167E−04 |
| A6= | −3.5281E−07 | 1.5538E−07 | 1.0225E−06 | −3.2502E−06 |
| A8= | 1.1191E−08 | −1.5329E−08 | −1.3666E−07 | −5.5884E−08 |
| A10= | −1.6122E−10 | 2.9173E−10 | 3.3305E−09 | 2.1010E−09 |
| A12= | 1.0059E−12 | −1.7014E−12 | −4.4052E−11 | −2.7413E−11 |
| A14= | — | — | 3.3409E−13 | 1.1367E−13 |
| A16= | — | — | −1.4620E−15 | — |

| Surface # | 17 | 18 |
|---|---|---|
| k= | 7.51662E+00 | −9.90000E+01 |
| A4= | 1.9142E−04 | 3.9477E−04 |
| A6= | 1.7241E−06 | 4.9517E−06 |
| A8= | 7.3647E−07 | 6.3828E−07 |
| A10= | −4.5925E−08 | −7.4134E−09 |
| A12= | 1.4249E−09 | −2.1446E−09 |
| A14= | 1.3937E−11 | 1.7869E−10 |
| A16= | −8.3423E−13 | −3.5111E−12 |

Moreover, these parameters shown in Table 9D can be calculated from Table 9A to Table 9C as the following values and satisfy the following conditions:

TABLE 9D
Schematic Parameters

| | | | |
|---|---|---|---|
| fL [mm] | 62.78 | f4/f2 | 0.53 |
| FnoL | 2.88 | flast2/f3 | 0.27 |
| HFOVL [deg.] | 3.6 | f12/f23 | 0.14 |
| FOVL [deg.] | 7.2 | f12/f56 | −1.33 |
| fS [mm] | 62.20 | (R5 + R6)/fL | 0.60 |
| FnoS | 2.85 | (R1 − R3)/(R1 + R3) | 0.21 |
| HFOVS [deg.] | 3.6 | R5/Rlast2 | 1.24 |
| FOVS [deg.] | 7.2 | CTmax/ATLmax | 0.40 |
| EPD [mm] | 21.80 | CTlast2/CT1 | 0.32 |
| ImgH [mm] | 3.96 | T12/T23 | 0.08 |
| fA1 [mm] | 31.30 | (T56 + CT6)/(CT4 + CT5) | 0.33 |
| fA2 [mm] | −37.24 | ATLmax/ImgH | 3.30 |
| fL/EPD | 2.88 | V6/N6 | 9.61 |
| MIN(fL/fi) | −5.31 | 2 × ImgH/EPD | 0.36 |
| MIN(fL/f5, fL/f6) | −2.33 | fL/(CRAL + HFOVL) [mm/deg.] | 7.26 |
| fL/TL | 1.32 | ETL3/CT3 | 2.09 |
| fL/fA1 | 2.01 | ETLlast/CTlast | 0.59 |
| fL/f2 | 1.57 | 10 × T12/ETL12 | 0.23 |
| \|fL/f3\| | 1.45 | YL1R1/YL8R2 | 2.49 |
| fL/f4 | 2.95 | (YLA1Rlast − YLA2R1)/ETLA12 | 0.37 |

In the 9th embodiment, the equation of the aspheric surface profiles of the aforementioned lens elements is the same as the equation of the 1st embodiment.

### 10th Embodiment

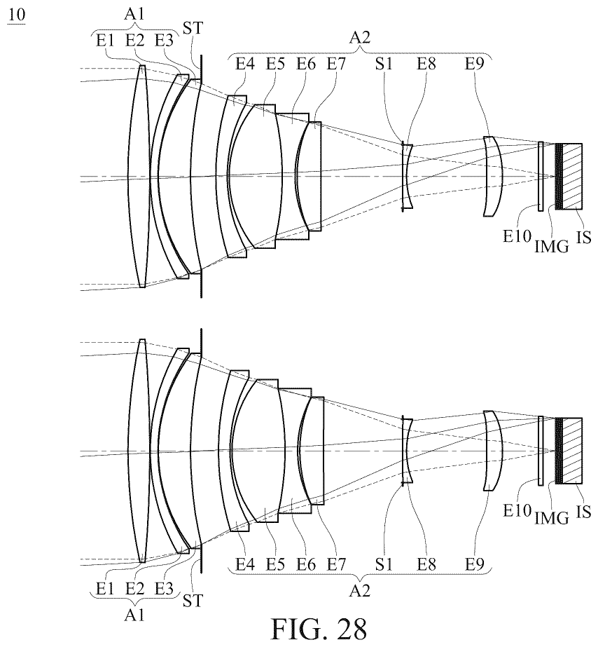

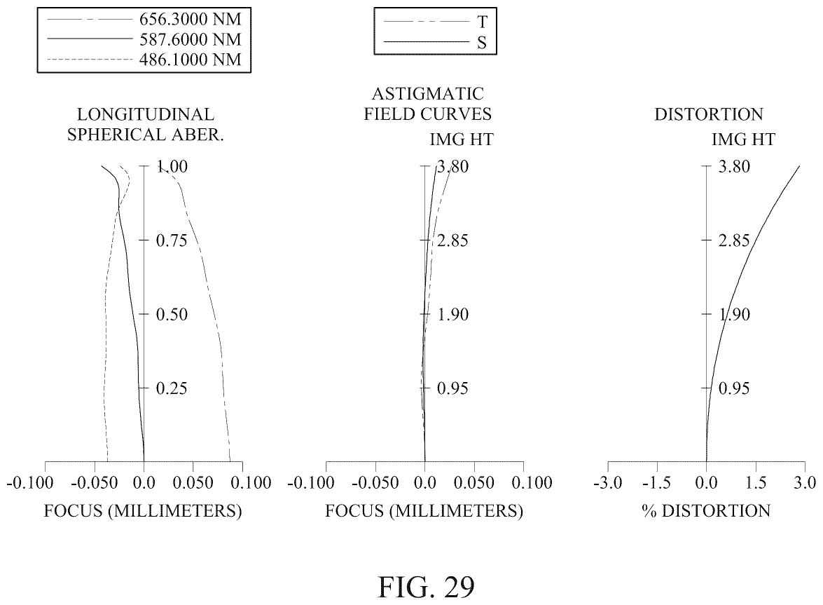

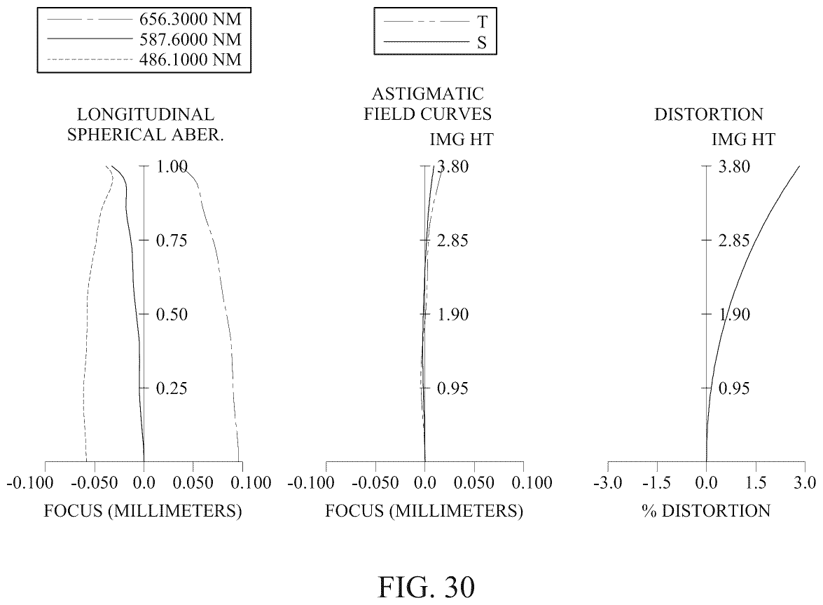

FIG. 28 is a schematic view of an image capturing unit at a first photography state and at a second photography state according to the 10th embodiment of the present disclosure. FIG. 29 shows, in order from left to right, spherical aberration curves, astigmatic field curves and a distortion curve of the image capturing unit at the first photography state according to the 10th embodiment. FIG. 30 shows, in order from left to right, spherical aberration curves, astigmatic field curves and a distortion curve of the image capturing unit at the second photography state according to the 10th embodiment. The upper part of FIG. 28 shows the photography optical system at the first photography state, and the lower part of FIG. 28 shows the photography optical system at the second photography state. In FIG. 28, the image capturing unit 10 includes the photography optical system (its reference numeral is omitted) of the present disclosure and an image sensor IS. The photography optical system includes, in order from an object side to an image side along an optical path, a first lens element E1, a second lens element E2, a third lens element E3, an aperture stop ST, a fourth lens element E4, a fifth lens element E5, a sixth lens element E6, a seventh lens element E7, a stop S1, an eighth lens element E8, a ninth lens element E9, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1, the second lens element E2 and the third lens element E3, and the second lens assembly A2 includes the fourth lens element E4, the fifth lens element E5, the sixth lens element E6, the seventh lens element E7, the eighth lens element E8 and the ninth lens element E9. The photography optical system includes nine lens elements (E1, E2, E3, E4, E5, E6, E7, E8 and E9) with no additional lens element disposed between each of the adjacent nine lens elements.

In the photography optical system of the 10th embodiment, first through ninth lens elements counting from the object side are respectively the first lens element E1 through the ninth lens element E9, and first through ninth lens elements counting from the image side are respectively the ninth lens element E9 through the first lens element E1, wherein the ninth lens element E9 is also be considered as a last lens element.

The photography optical system of the 10th embodiment perform a focus process for focusing by moving at least one lens element thereof. Through the focusing process, the photography optical system has a first photography state corresponding to an infinite object distance and a second photography state corresponding to a finite object distance as being 8000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the fourth lens element E4, the fifth lens element E5, the sixth lens element E6 and the seventh lens element E7 move along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with negative refractive power has an object-side surface being convex in a paraxial region thereof and an image-side surface being concave in a paraxial region thereof. The fourth lens element E4 is made of glass material and has the object-side surface and the image-side surface being both spherical.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both spherical.

The sixth lens element E6 with negative refractive power has an object-side surface being concave in a paraxial region thereof and an image-side surface being concave in a paraxial region thereof. The sixth lens element E6 is made of glass material and has the object-side surface and the image-side surface being both spherical. The object-side surface of the sixth lens element E6 is cemented to the image-side surface of the fifth lens element E5.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric.

The eighth lens element E8 with negative refractive power has an object-side surface being convex in a paraxial region thereof and an image-side surface being concave in a paraxial region thereof. The eighth lens element E8 is made of glass material and has the object-side surface and the image-side surface being both aspheric.

The ninth lens element E9 with positive refractive power has an object-side surface being concave in a paraxial region thereof and an image-side surface being convex in a paraxial region thereof. The ninth lens element E9 is made of plastic material and has the object-side surface and the image-side surface being both aspheric.

The filter E10 is made of glass material and located between the ninth lens element E9 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the eighth lens element E8.

The maximum axial distance among axial distances between each of all adjacent lens elements of the photography optical system is located between the seventh lens element E7 and the eighth lens element E8 or between the eighth lens element E8 and the ninth lens element E9.

In the second lens assembly A2, the fourth lens element E4 is a convex-concave lens element. The fifth lens element E5 as being a biconvex positive lens element and the sixth lens element E6 as being a biconcave negative lens element form a chromatic-aberration-correction lens assembly having negative refractive power. The seventh lens element E7 is an aspheric lens element.

The detailed optical data of the 10th embodiment are shown in Table 10A and Table 10B, and the aspheric surface data are shown in Table 10C below.

TABLE 10A
10th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 60.7093 | (SPH) | 2.530 | Glass | 1.652 | 58.4 | 66.55 |
| 2 | | −149.2537 | (SPH) | 0.050 | | | | |
| 3 | Lens 2 | 23.7119 | (SPH) | 0.897 | Glass | 1.923 | 18.9 | −141.27 |
| 4 | | 19.6987 | (SPH) | 0.038 | | | | |
| 5 | Lens 3 | 18.6065 | (SPH) | 3.742 | Glass | 1.729 | 54.7 | 39.51 |
| 6 | | 48.0889 | (SPH) | 1.261 | | | | |
| 7 | Ape. Stop | Plano | | D1 | | | | |
| 8 | Lens 4 | 31.4511 | (SPH) | 1.330 | Glass | 1.855 | 36.6 | −48.72 |
| 9 | | 17.5752 | (SPH) | 0.230 | | | | |
| 10 | Lens 5 | 13.1371 | (SPH) | 6.160 | Glass | 1.530 | 60.5 | 18.57 |
| 11 | Lens 6 | −32.9641 | (SPH) | 1.458 | Glass | 1.883 | 39.2 | −10.47 |
| 12 | | 13.1153 | (SPH) | 0.257 | | | | |
| 13 | Lens 7 | 15.7397 | (ASP) | 2.750 | Plastic | 1.587 | 28.3 | 27.78 |
| 14 | | 419.0944 | (ASP) | D2 | | | | |
| 15 | Stop | Plano | | 0.000 | | | | |
| 16 | Lens 8 | 1356.9299 | (ASP) | 0.443 | Glass | 1.855 | 36.6 | −12.03 |
| 17 | | 10.2135 | (ASP) | 9.302 | | | | |
| 18 | Lens 9 | −175.4386 | (ASP) | 1.818 | Plastic | 1.656 | 21.3 | 21.53 |
| 19 | | −13.1236 | (ASP) | 4.190 | | | | |

| | | | | | | | |
|---|---|---|---|---|---|---|---|
| 20 | Filter | Plano | 0.510 | Glass | 1.517 | 64.2 | — |
| 21 | | Plano | 1.474 | — | | | |
| 22 | Image | Plano | | | | | |

Note:
Reference wavelength is 587.6 nm (d-line).
An effective radius of the stop S1 (Surface 15) is 3.675 mm.

TABLE 10B
Optical data for photography optical system at the first
photography state and the second photography state

| | first photography | | second photography |
|---|---|---|---|
| | state | | state |
| fL [mm] | 70.52 | fS [mm] | 70.10 |
| FnoL | 2.82 | FnoS | 2.80 |
| HFOVL [deg.] | 3.0 | HFOVS [deg.] | 3.0 |
| Object distance | infinity | Object distance | 8000.000 |
| [mm] | | [mm] | |
| D0 [mm] | infinity | D0 [mm] | 8000.000 |
| D1 [mm] | 1.666 | D1 [mm] | 1.981 |
| D2 [mm] | 9.500 | D2 [mm] | 9.185 |

In Table 10B, except for D1 being an axial distance between the aperture stop ST and the object-side surface of the fourth lens element E4, D2 being an axial distance between the image-side surface of the seventh lens element E7 and the stop S1, and the finite object distance corresponded by fS, FnoS and HFOVS being 8000.000 mm, the other optical data is the same as the data of the 1st embodiment. Moreover, photography optical system of this embodiment can further have other focal lengths corresponding to other photography states in other focus conditions besides the first photography state and the second photography state for different object distances.

It can be known from Table 10A and Table 10B, the fourth lens element E4, the fifth lens element E5, the sixth lens element E6 and the seventh lens element E7 move along a direction parallel to the optical axis during the focus process.

TABLE 10C
Aspheric Coefficients

| Surface # | 13 | 14 | 16 | 17 |
|---|---|---|---|---|
| k= | 5.73724E−01 | 9.90000E+01 | 9.90000E+01 | 1.72922E+00 |
| A4= | −1.8379E−05 | −5.5606E−05 | −1.9139E−05 | −1.0035E−05 |
| A6= | −1.1257E−06 | −1.3037E−06 | 6.1354E−06 | 5.7369E−06 |
| A8= | 1.5472E−07 | 1.9892E−07 | −8.3671E−08 | −6.6136E−08 |
| A10= | −8.2030E−09 | −1.0841E−08 | — | — |
| A12= | 2.8178E−10 | 3.8583E−10 | — | — |
| A14= | −5.0273E−12 | −7.2992E−12 | — | — |
| A16= | 3.9095E−14 | 6.0623E−14 | — | — |

| Surface # | 18 | 19 |
|---|---|---|
| k= | 9.90000E+01 | 3.92747E+00 |
| A4= | −4.2742E−04 | −1.4920E−04 |
| A6= | −4.1365E−05 | −2.3930E−05 |
| A8= | 5.7187E−06 | 3.3104E−06 |
| A10= | −5.9884E−07 | −3.0339E−07 |
| A12= | 3.4785E−08 | 1.5844E−08 |
| A14= | −1.0977E−09 | −4.5205E−10 |
| A16= | 1.4124E−11 | 5.3449E−12 |

Moreover, these parameters shown in Table 10D can be calculated from Table 10A to Table 10C as the following values and satisfy the following conditions:

TABLE 10D
Schematic Parameters

| | | | |
|---|---|---|---|
| fL [mm] | 70.52 | f4/f2 | 0.34 |
| FnoL | 2.82 | flast2/f3 | −0.30 |
| HFOVL [deg.] | 3.0 | f12/f23 | 2.09 |
| FOVL [deg.] | 6.0 | f12/f56 | −2.78 |
| fS [mm] | 70.10 | (R5 + R6)/fL | 0.95 |
| FnoS | 2.80 | (R1 − R3)/(R1 + R3) | 0.44 |
| HFOVS [deg.] | 3.0 | R5/Rlast2 | −0.11 |
| FOVS [deg.] | 6.0 | CTmax/ATLmax | 0.65 |
| EPD [mm] | 25.01 | CTlast2/CT1 | 0.18 |
| ImgH [mm] | 3.80 | T12/T23 | 1.32 |
| fA1 [mm] | 30.38 | (T56 + CT6)/(CT4 + CT5) | 0.19 |
| fA2 [mm] | −195.03 | ATLmax/ImgH | 2.50 |
| fL/EPD | 2.82 | V6/N6 | 20.82 |
| MIN(fL/fi) | −6.74 | 2 × ImgH/EPD | 0.30 |
| MIN(fL/f5, fL/f6) | −6.74 | fL/(CRAL + HFOVL) [mm/deg.] | 13.64 |
| fL/TL | 1.42 | ETL3/CT3 | 0.31 |
| fL/fA1 | 2.32 | ETLlast/CTlast | 0.57 |
| fL/f2 | −0.50 | 10 × T12/ETL12 | 0.13 |
| \|fL/f3\| | 1.78 | YL1R1/YL8R2 | 3.66 |
| fL/f4 | −1.45 | (YLA1Rlast − YLA2R1)/ETLA12 | 0.39 |

In the 10th embodiment, the equation of the aspheric surface profiles of the aforementioned lens elements is the same as the equation of the 1st embodiment.

### 11th Embodiment

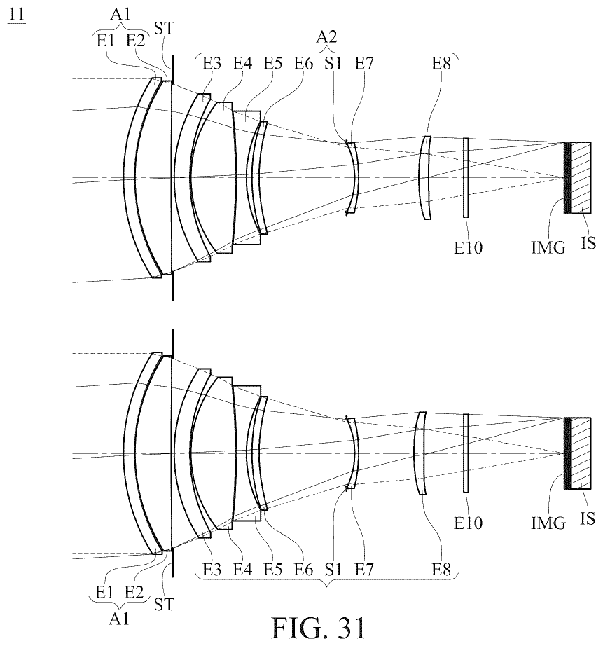

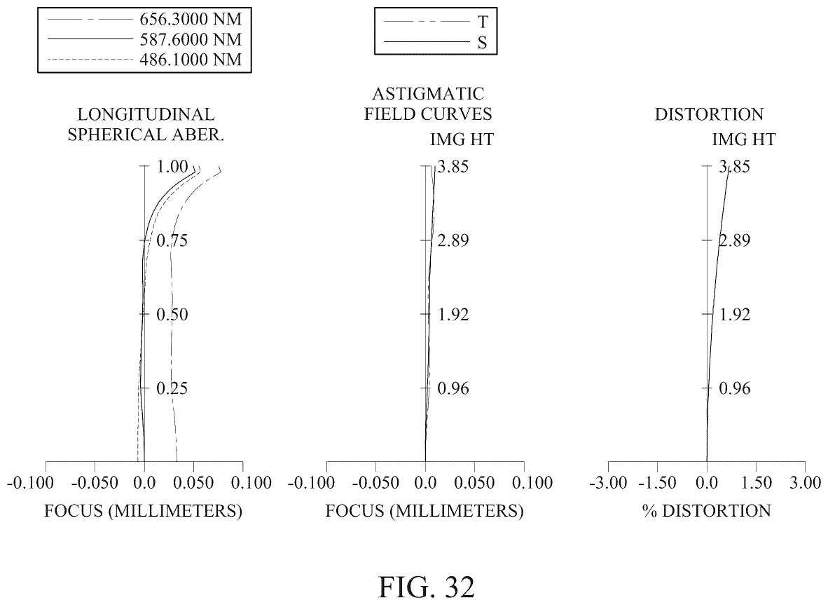

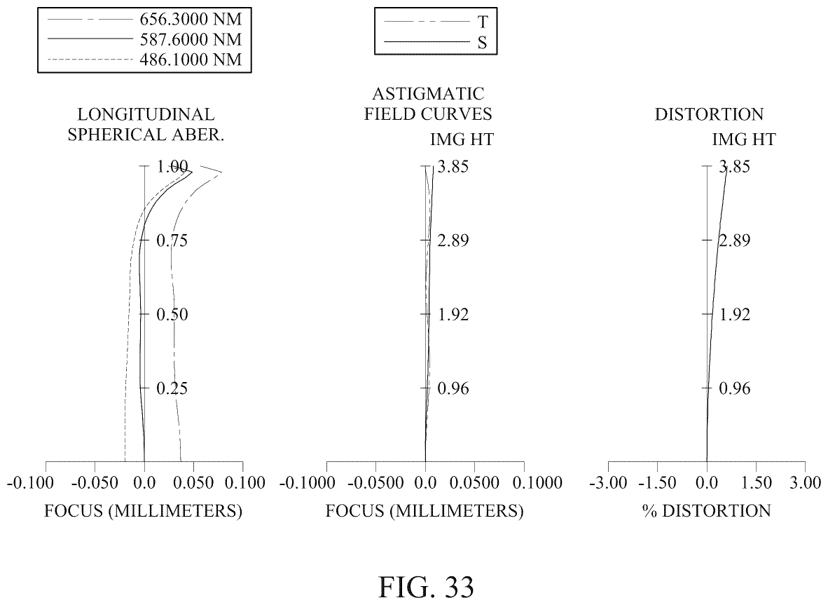

FIG. 31 is a schematic view of an image capturing unit at a first photography state and at a second photography state according to the 11th embodiment of the present disclosure. FIG. 32 shows, in order from left to right, spherical aberration curves, astigmatic field curves and a distortion curve of the image capturing unit at the first photography state according to the 11th embodiment. FIG. 33 shows, in order from left to right, spherical aberration curves, astigmatic field curves and a distortion curve of the image capturing unit at the second photography state according to the 11th embodiment. The upper part of FIG. 31 shows the photography optical system at the first photography state, and the lower part of FIG. 31 shows the photography optical system at the second photography state. In FIG. 31, the image capturing unit 11 includes the photography optical system (its reference numeral is omitted) of the present disclosure and an image sensor IS. The photography optical system includes, in order from an object side to an image side along an optical path, a first lens element E1, a second lens element E2, an aperture stop ST, a third lens element E3, a fourth lens element E4, a fifth lens element E5, a sixth lens element E6, a stop S1, a seventh lens element E7, an eighth lens element E8, a filter E10 and an image surface IMG. Further, the photography optical system includes, in order from the object side to the image side along the optical path, a first lens assembly A1, the aperture stop ST and a second lens assembly A2. The first lens assembly A1 includes the first lens element E1 and the second lens element E2, and the second lens assembly A2 includes the third lens element E3, the fourth lens element E4, the fifth lens element E5, the sixth lens element E6, the seventh lens element E7 and the eighth lens element E8. The photography optical system includes eight lens elements (E1, E2, E3, E4, E5, E6, E7 and E8) with no additional lens element disposed between each of the adjacent eight lens elements.

In the photography optical system of the 11th embodiment, first through eighth lens elements counting from the object side are respectively the first lens element E1 through the eighth lens element E8, and first through eighth lens elements counting from the image side are respectively the eighth lens element E8 through the first lens element E1, wherein the eighth lens element E8 is also be considered as a last lens element.

The photography optical system of the 11th embodiment perform a focus process for focusing by moving at least one lens element thereof. Through the focusing process, the photography optical system has a first photography state corresponding to an infinite object distance and a second photography state corresponding to a finite object distance as being 10000.000 mm. The first photography state refers to a state of the photography optical system with an imaged object at an infinite distance (the infinite object distance), and the second photography state refers to a state of the photography optical system with an imaged object at a finite distance (the finite object distance). When an imaged object at the infinite object distance moves to the finite object distance, the photography optical system performs a focus process to change the first photography state to the second photography state thereof. Conversely, when an imaged object at the finite object distance moves to the infinite object distance, the photography optical system also performs the focus process to change the second photography state to the first photography state thereof. Moreover, during the focus process of the photography optical system, the eighth lens element E8 moves along a direction parallel to the optical axis.

The first lens assembly A1 has positive refractive power, and the second lens assembly A2 has negative refractive power.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of glass material and has the object-side surface and the image-side surface being both spherical.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with negative refractive power has an object-side surface being concave in a paraxial region thereof and an image-side surface being convex in a paraxial region thereof. The seventh lens element E7 is made of glass material and has the object-side surface and the image-side surface being both spherical.

The eighth lens element E8 with positive refractive power has an object-side surface being convex in a paraxial region thereof and an image-side surface being concave in a paraxial region thereof. The eighth lens element E8 is made of plastic material and has the object-side surface and the image-side surface being both aspheric.

The filter E10 is made of glass material and located between the eighth lens element E8 and the image surface IMG, and will not affect the focal length of the photography optical system. The image sensor IS is disposed on or near the image surface IMG.

A lens element having the minimum effective radius among all lens elements of the photography optical system when corresponding to the infinite object distance is the seventh lens element E7.

The maximum axial distance among axial distances between each of all adjacent lens elements of the photography optical system is located between the sixth lens element E6 and the seventh lens element E7.

In the second lens assembly A2, the third lens element E3 is a convex-concave lens element. The fourth lens element E4 as being a biconvex positive lens element and the fifth lens element E5 as being a biconcave negative lens element form a chromatic-aberration-correction lens assembly having negative refractive power. The sixth lens element E6 is an aspheric lens element.

The detailed optical data of the 11th embodiment are shown in Table 11A and Table 11B, and the aspheric surface data are shown in Table 11C below.

TABLE 11A
11th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Lens 1 | 20.4020 | (SPH) | 1.223 | Glass | 1.946 | 17.9 | 713.05 |
| 2 | | 20.4253 | (SPH) | 0.038 | | | | |
| 3 | Lens 2 | 19.5184 | (SPH) | 3.930 | Glass | 1.593 | 67.3 | 33.40 |
| 4 | | 1185.7157 | (SPH) | 0.160 | | | | |
| 5 | Ape. Stop | Plano | | 0.160 | | | | |
| 6 | Lens 3 | 17.2925 | (ASP) | 1.700 | Plastic | 1.544 | 56.0 | 617.84 |
| 7 | | 17.5989 | (ASP) | 0.110 | | | | |
| 8 | Lens 4 | 13.0175 | (ASP) | 4.852 | Plastic | 1.515 | 56.4 | 21.39 |
| 9 | | −62.7845 | (ASP) | 0.071 | | | | |
| 10 | Lens 5 | −71.8152 | (SPH) | 1.088 | Glass | 1.904 | 31.4 | −12.10 |
| 11 | | 12.9901 | (SPH) | 0.607 | | | | |
| 12 | Lens 6 | 18.7541 | (ASP) | 0.772 | Glass | 1.656 | 21.3 | −630.24 |
| 13 | | 17.6478 | (ASP) | 9.479 | | | | |
| 14 | Stop | Plano | | 0.900 | | | | |
| 15 | Lens 7 | −8.5735 | (SPH) | 0.420 | Glass | 1.923 | 18.9 | −21.36 |
| 16 | | −15.5318 | (SPH) | D1 | | | | |
| 17 | Lens 8 | 22.4995 | (ASP) | 1.073 | Plastic | 1.705 | 14.0 | 32.55 |
| 18 | | 1143.0526 | (ASP) | D2 | | | | |

| | | | | | | | |
|---|---|---|---|---|---|---|---|
| 19 | Filter | Plano | 0.510 | Glass | 1.517 | 64.2 | — |
| 20 | | Plano | 10.427 | | | | |
| 21 | Image | Plano | — | | | | |

Note:
Reference wavelength is 587.6 nm (d-line).
An effective radius of the stop S1 (Surface 14) is 3.682 mm.

TABLE 11B
Optical data for photography optical system at the first
photography state and the second photography state

| | first photography | | second photography |
|---|---|---|---|
| | state | | state |
| fL [mm] | 62.38 | fS [mm] | 61.84 |
| FnoL | 2.90 | FnoS | 2.87 |
| HFOVL [deg.] | 3.5 | HFOVS [deg.] | 3.5 |
| Object distance | infinity | Object distance | 10000.000 |
| [mm] | | [mm] | |
| D0 [mm] | infinity | D0 [mm] | 10000.000 |
| D1 [mm] | 6.526 | D1 [mm] | 5.995 |
| D2 [mm] | 3.774 | D2 [mm] | 4.305 |

In Table 11B, the optical data is the same as the data of the 1st embodiment. Moreover, photography optical system of this embodiment can further have other focal lengths corresponding to other photography states in other focus conditions besides the first photography state and the second photography state for different object distances.

It can be known from Table 11A and Table 11B, the eighth lens element E8 moves along a direction parallel to the optical axis during the focus process.

TABLE 11C
Aspheric Coefficients

| Surface # | 6 | 7 | 8 | 9 |
|---|---|---|---|---|
| k= | 1.36260E−01 | 1.07273E−01 | −1.92273E−01 | −1.13776E+01 |
| A4= | −1.6472E−05 | −2.0914E−05 | 3.1077E−05 | 4.5446E−05 |
| A6= | 1.9539E−06 | 2.5962E−06 | −2.0812E−06 | −2.7209E−06 |
| A8= | −6.2095E−08 | −9.6466E−08 | 7.4242E−08 | 1.5166E−07 |
| A10= | 8.0148E−10 | 1.4062E−09 | −1.1768E−09 | −4.1096E−09 |
| A12= | −3.7215E−12 | −7.0755E−12 | 6.8436E−12 | 4.9585E−11 |
| A14= | — | — | — | −2.2280E−13 |
| Surface # | 12 | 13 | 17 | 18 |
| k= | −1.90657E+00 | −1.03665E+01 | 8.00970E+00 | 9.90000E+01 |
| A4= | −3.3299E−04 | −2.0184E−04 | 2.3603E−04 | 3.8800E−04 |
| A6= | 5.5489E−05 | 5.1657E−05 | −6.6055E−06 | −9.2727E−06 |
| A8= | −4.8661E−06 | −5.0927E−06 | 2.4898E−06 | 3.4099E−06 |
| A10= | 2.3373E−07 | 2.6117E−07 | −2.6480E−07 | −3.7197E−07 |
| A12= | −5.9773E−09 | −7.0836E−09 | 1.6295E−08 | 2.3493E−08 |
| A14= | 7.7407E−11 | 9.6924E−11 | −5.0010E−10 | −7.4493E−10 |
| A16= | −4.0757E−13 | −5.3568E−13 | 6.2101E−12 | 9.6041E−12 |

Moreover, these parameters shown in Table 11D can be calculated from Table 11A to Table 11C as the following values and satisfy the following conditions:

TABLE 11D
Schematic Parameters

| | | | |
|---|---|---|---|
| fL [mm] | 62.38 | f4/f2 | 0.64 |
| FnoL | 2.90 | flast2/f3 | −0.03 |
| HFOVL [deg.] | 3.5 | f12/f23 | 1.06 |
| FOVL [deg.] | 7.0 | f12/f56 | −2.81 |
| fS [mm] | 61.84 | (R5 + R6)/fL | 0.56 |
| FnoS | 2.87 | (R1 − R3)/(R1 + R3) | 0.02 |
| HFOVS [deg.] | 3.5 | R5/Rlast2 | 0.77 |
| FOVS [deg.] | 7.0 | CTmax/ATLmax | 0.47 |
| EPD [mm] | 21.51 | CTlast2/CT1 | 0.34 |
| ImgH [mm] | 3.85 | T12/T23 | 0.12 |
| fA1 [mm] | 32.82 | (T56 + CT6)/(CT4 + CT5) | 0.23 |
| fA2 [mm] | −42.39 | ATLmax/ImgH | 2.70 |
| fL/EPD | 2.90 | V6/N6 | 12.86 |
| MIN(fL/fi) | −5.16 | 2 × ImgH/EPD | 0.36 |
| MIN(fL/f5, fL/f6) | −5.16 | fL/(CRAL + HFOVL) [mm/deg.] | 7.52 |
| fL/TL | 1.30 | ETL3/CT3 | 0.77 |
| fL/fA1 | 1.90 | ETLlast/CTlast | 0.60 |
| fL/f2 | 1.87 | 10 × T12/ETL12 | 2.03 |
| \|fL/f3\| | 0.10 | YL1R1/YL8R2 | 2.46 |
| fL/f4 | 2.92 | (YLA1Rlast − YLA2R1)/ETLA12 | 0.37 |

In the 11th embodiment, the equation of the aspheric surface profiles of the aforementioned lens elements is the same as the equation of the 1st embodiment.

### 12th Embodiment

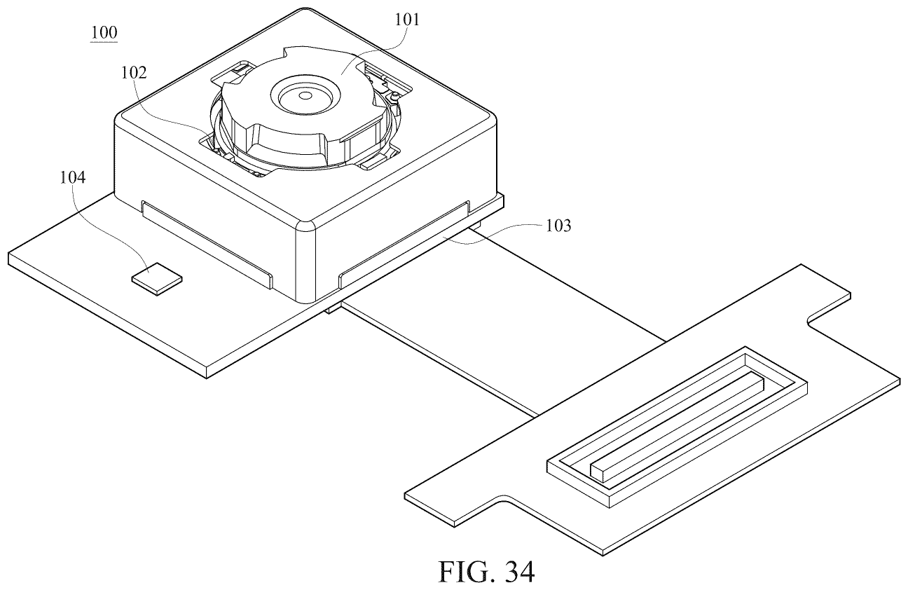

FIG. 34 is a perspective view of an image capturing unit according to the 12th embodiment of the present disclosure. In this embodiment, an image capturing unit 100 is a camera module including a lens unit 101, a driving device 102, an image sensor 103 and an image stabilizer 104. The lens unit 101 includes the photography optical system disclosed in the 1st embodiment, a barrel and a holder member (their reference numerals are omitted) for holding the photography optical system. However, the lens unit 101 may alternatively be provided with the photography optical system disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have internal-focusing or auto focusing functionality, and different driving configurations can be obtained through the usages of stepping motor, piezo motor, screw, voice coil motors (VCM), spring type, ball type. micro electro-mechanical systems (MEMS), piezoelectric systems, or shape memory alloy materials. However, the present disclosure is not limited thereto. The driving device 102 is favorable for obtaining a better imaging position of the lens unit 101, so that a clear image of the imaged object can be captured by the lens unit 101 with different object distances. Moreover, movable elements in the image capturing unit 100 (for example, but not limited to, movable optical elements in the lens assembly or image sensor) can also be driven by the driving device 102, such that the movable elements can have movement parallel with, angled to, or perpendicular to the optical axis. However, the present disclosure is not limited to the abovementioned driving manner. The image sensor 103 (for example, CCD or CMOS), which can feature high photosensitivity and low noise, is disposed on the image surface of the photography optical system to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions. Moreover, several elements in the image capturing unit 100 can also be driven by the driving device 102 so as to timely compensate for image tilt, thereby also achieving OIS.

### 13th Embodiment

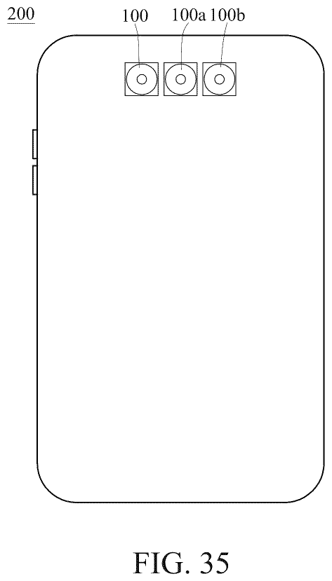

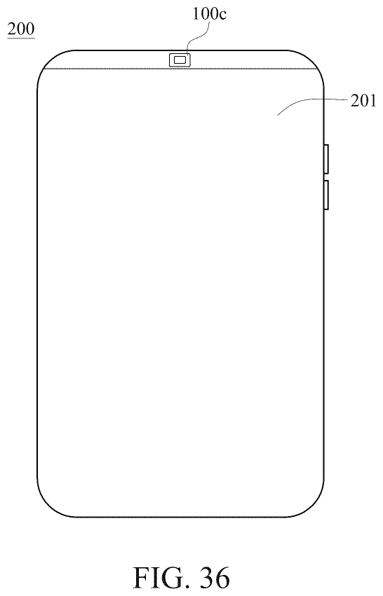

FIG. 35 is one perspective view of an electronic device according to the 13th embodiment of the present disclosure. FIG. 36 is another perspective view of the electronic device in FIG. 35.

In this embodiment, an electronic device 200 is a smartphone including the image capturing unit 100 disclosed in the 12th embodiment, an image capturing unit 100a, an image capturing unit 100b, an image capturing unit 100c and a display unit 201. As shown in FIG. 35, the image capturing unit 100, the image capturing unit 100a and the image capturing unit 100b are disposed on the same side of the electronic device 200 and face the same side. As shown in FIG. 36, the image capturing unit 100c and the display unit 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the photography optical system of the present disclosure and can have a configuration similar to that of the image capturing unit 100. In detail, each of the image capturing units 100a, 100b and 100c can include a lens unit, a driving device, an image sensor, an image stabilizer and a reflective element for deflecting the optical path, and each of the lens unit can include an optical lens assembly such as the photography optical system of the present disclosure, a barrel and a holder member for holding the photography optical system.

The image capturing unit 100 is a telephoto image capturing unit, the image capturing unit 100a is a wide-angle image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 36, the image capturing unit 100c can have a non-circular opening, and the lens barrel or the lens elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display unit 201 with respect to the electronic device 200, reducing the thickness of the electronic device 200, and achieving compactness of the overall module. In this embodiment, the electronic device 200 includes multiple image capturing units 100, 100a, 100b and 100c, but the present disclosure is not limited to the number and arrangement of image capturing units.

### 14th Embodiment

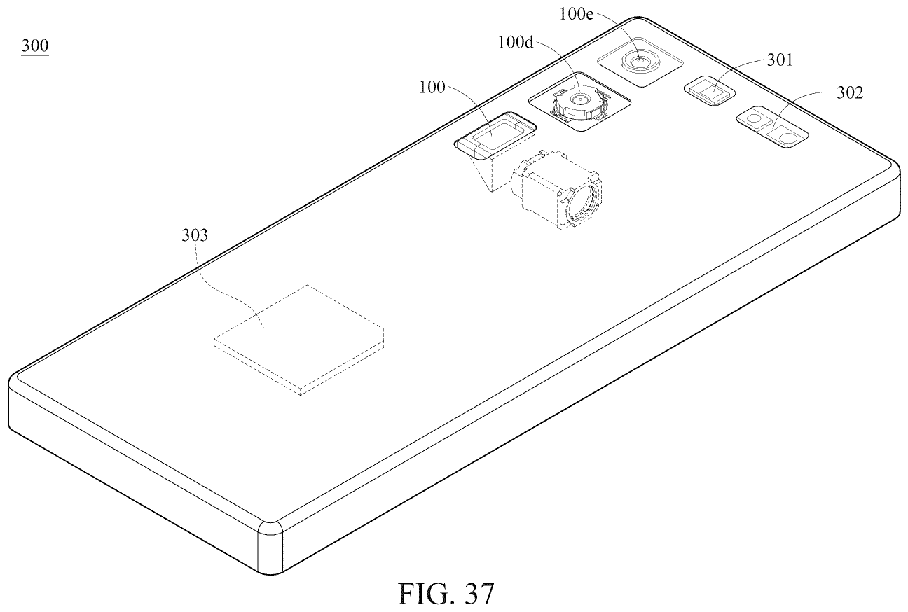

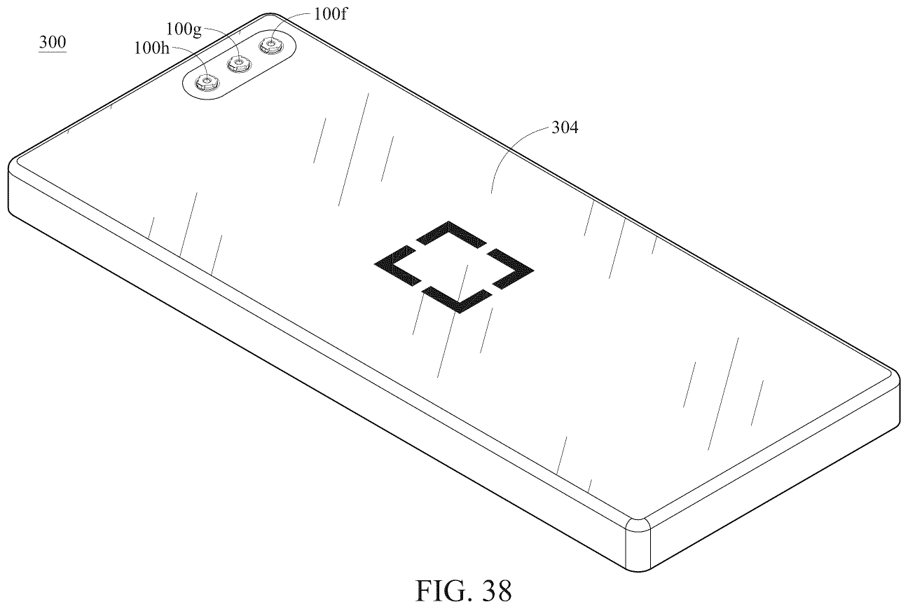

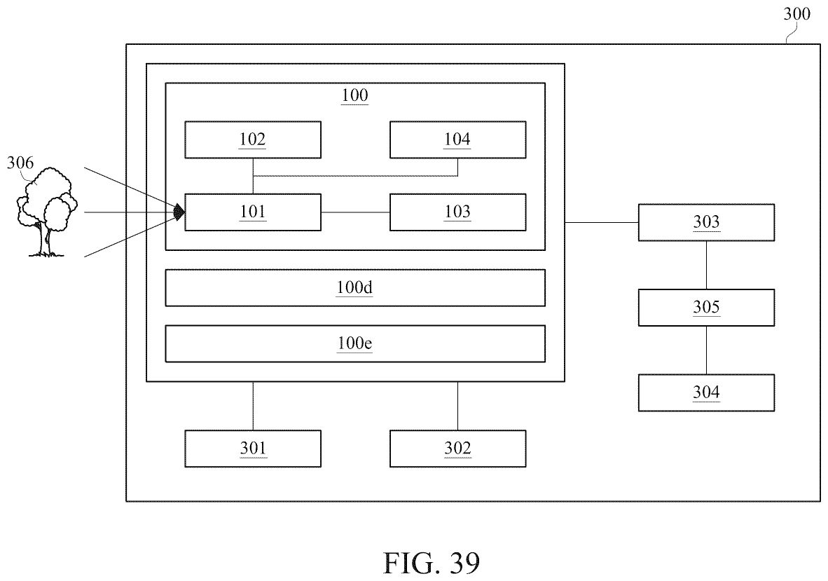

FIG. 37 is one perspective view of an electronic device according to the 14th embodiment of the present disclosure. FIG. 38 is another perspective view of the electronic device in FIG. 37. FIG. 39 is a block diagram of the electronic device in FIG. 37.

In this embodiment, an electronic device 300 is a smartphone including the image capturing unit 100 disclosed in the 12th embodiment, an image capturing unit 100d, an image capturing unit 100e, an image capturing unit 100f, an image capturing unit 100g, an image capturing unit 100h, a flash module 301, a focus assist module 302, an image signal processor 303, a display module 304 and an image software processor 305. The image capturing unit 100, the image capturing unit 100d and the image capturing unit 100e are disposed on the same side of the electronic device 300. The focus assist module 302 can be a laser rangefinder or a ToF (time of flight) module, but the present disclosure is not limited thereto. The image capturing unit 100f, the image capturing unit 100g, the image capturing unit 100h and the display module 304 are disposed on the opposite side of the electronic device 300, and the display module 304 can be a user interface, such that the image capturing units 100f, 100g, 100h can be front-facing cameras of the electronic device 300 for taking selfies, but the present disclosure is not limited thereto. Furthermore, each of the image capturing units 100d, 100e, 100f, 100g and 100h can include the photography optical system of the present disclosure and can have a configuration similar to that of the image capturing unit 100. In detail, each of the image capturing units 100d, 100e, 100f, 100g and 100h can include a lens unit, a driving device, an image sensor, an image stabilizer and a reflective element for deflecting the optical path, and each of the lens unit can include an optical lens assembly such as the photography optical system of the present disclosure, a barrel and a holder member for holding the photography optical system.

The image capturing unit 100 is a telephoto image capturing unit, the image capturing unit 100d is a wide-angle image capturing unit, the image capturing unit 100e is an ultra-wide-angle image capturing unit, the image capturing unit 100f is a wide-angle image capturing unit, the image capturing unit 100g is an ultra-wide-angle image capturing unit, and the image capturing unit 100h is a ToF image capturing unit. In this embodiment, the image capturing units 100, 100d and 100e have different fields of view, such that the electronic device 300 can have various magnification ratios so as to meet the requirement of optical zoom functionality. Moreover, the image capturing unit 100 can be a telephoto image capturing unit having an optical path folding element configuration such as a reflective element configuration, such that the total track length of the image capturing unit 100 is not limited by the thickness of the electronic device 300. Moreover, the optical path folding element configuration such as the reflective element configuration of the image capturing unit 100 can be similar to, for example, one of the structures shown in FIG. 44 to FIG. 48, which can be referred to foregoing descriptions corresponding to FIG. 44 to FIG. 48, and the details in this regard will not be provided again. In addition, the image capturing unit 100h can determine depth information of an imaged object. In this embodiment, the electronic device 300 includes multiple image capturing units 100, 100d, 100e, 100f, 100g and 100h, but the present disclosure is not limited to the number and arrangement of image capturing units.

When a user captures images of an object 306, the light rays converge in the image capturing unit 100, the image capturing unit 100d or the image capturing unit 100e to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100f, 100g or 100h to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 15th Embodiment

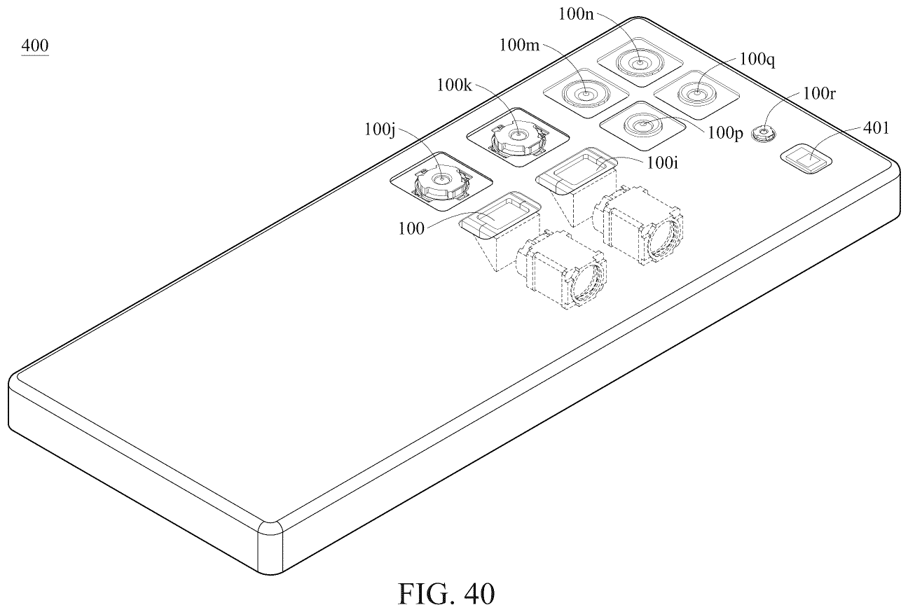

FIG. 40 is one perspective view of an electronic device according to the 15th embodiment of the present disclosure.

In this embodiment, an electronic device 400 is a smartphone including the image capturing unit 100 disclosed in the 12th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the photography optical system of the present disclosure and can have a configuration similar to that of the image capturing unit 100, and the details in this regard will not be provided again.

The image capturing unit 100 is a telephoto image capturing unit, the image capturing unit 100i is a telephoto image capturing unit, the image capturing unit 100j is a wide-angle image capturing unit, the image capturing unit 100k is a wide-angle image capturing unit, the image capturing unit 100m is an ultra-wide-angle image capturing unit, the image capturing unit 100n is an ultra-wide-angle image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p, and 100q have different fields of view, such that the electronic device 400 can have various magnification ratios so as to meet the requirement of optical zoom functionality. Moreover, each of the image capturing units 100 and 100i can be a telephoto image capturing unit having an optical path folding element configuration such as a reflective element configuration. Moreover, the optical path folding element configuration of each of the image capturing unit 100 and 100i can be similar to, for example, one of the structures shown in FIG. 44 to FIG. 48, which can be referred to foregoing descriptions corresponding to FIG. 44 to FIG. 48, and the details in this regard will not be provided again. In addition, the image capturing unit 100r can determine depth information of the imaged object. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

### 16th Embodiment

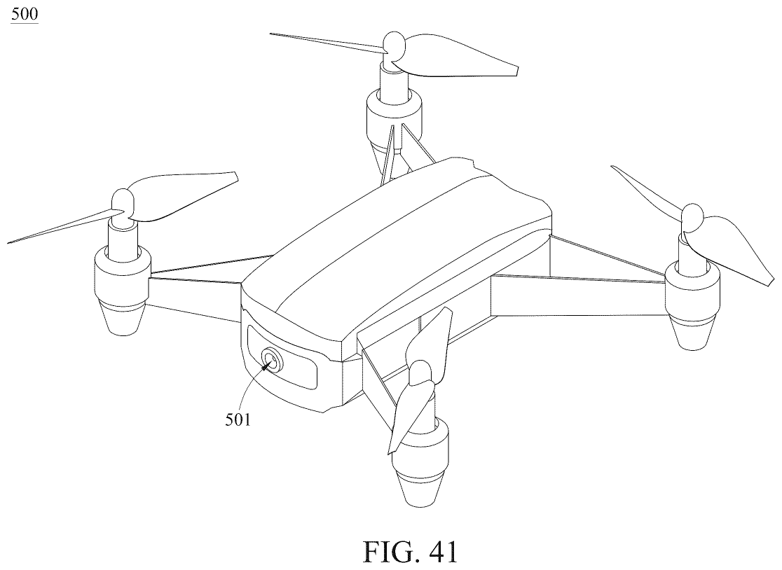

FIG. 41 is a schematic view of an electronic device according to the 16th embodiment of the present disclosure.

In this embodiment, an electronic device 500 may be a lightweight unmanned aerial vehicle, such as a drone camera. The electronic device 500 includes an image capturing unit 501. The image capturing unit 501 includes the photography optical system disclosed in the 1 st embodiment. The image capturing unit 501 can be a telephoto image capturing unit. The image capturing unit 501, which is similar to the image capturing unit 100, can further include a barrel, a holder member or a combination thereof. The electronic device 500 captures an image by the image capturing unit 501. Preferably, the electronic device may further include a control unit, a display unit, a storage unit, a random access memory unit (RAM) or a combination thereof.

The smartphone, movable carrier or unmanned aerial carrier in the embodiments are only exemplary for showing the image capturing unit of the present disclosure installed in an electronic device, and the present disclosure is not limited thereto. The image capturing unit can be optionally applied to optical systems with a movable focus. Furthermore, the photography optical system of the image capturing unit features good capability in aberration corrections and high image quality, and can be applied to 3D (three-dimensional) image capturing applications, in products such as handheld telescope, digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that TABLES 1A-11D show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photography optical system comprising, in order from an object side to an image side along an optical path, a first lens assembly, an aperture stop and a second lens assembly, each lens element of the photography optical system having an object-side surface facing toward the object side and an image-side surface facing toward the image side;
wherein a total number of lens elements of the first lens assembly is one to three, a total number of lens elements of the second lens assembly is five to eight, and there is no additional lens element disposed between the first lens assembly and the second lens assembly;
wherein the first lens assembly comprises a first lens element closest to the object side, the second lens assembly comprises a last lens element closest to the image side, the photography optical system further comprises, in order from the first lens element to the last lens element along the optical path, a second lens element, a third lens element, a fourth lens element and a fifth lens element, and there is no additional lens element disposed between the first lens element and the fifth lens element;
wherein the first lens assembly has positive refractive power, and the second lens assembly has negative refractive power;
wherein the object-side surface of the first lens element is convex in a paraxial region thereof, the object-side surface of the second lens element is convex in a paraxial region thereof, the object-side surface of the third lens element is convex in a paraxial region thereof, the image-side surface of the third lens element is concave in a paraxial region thereof, and at least one of the fifth lens element and a sixth lens element counting from the object side among the photography optical system is a negative lens element;
wherein a focal length of the photography optical system when corresponding to an infinite object distance is fL, a focal length of i-th lens element counting from the object side among the photography optical system is fi, a minimum value of fL/fi is MIN (fL/fi), a curvature radius of the object-side surface of the third lens element is R5, a curvature radius of the image-side surface of the third lens element is R6, a maximum value among axial distances between each of all adjacent lens elements of the photography optical system when corresponding to the infinite object distance is ATLmax, a maximum image height of the photography optical system is ImgH, and the following conditions are satisfied:
−13.80<MIN (fL/fi)<−3.80, wherein i is a positive integer, and 1≤i≤a total number of lens elements of the photography optical system;
$$0 < ( R 5 + R 6 ) / fL < 3.5 ;$$
$$and$$
$$1. < ATL max / ImgH < 6. .$$

2. The photography optical system of claim 1, wherein the first lens element has positive refractive power, all lens elements of the photography optical system comprise at least two glass lens elements and at least one plastic lens element, and a maximum axial distance among axial distances between each of all adjacent lens elements of the photography optical system is located in the second lens assembly.

3. The photography optical system of claim 1, wherein at least two adjacent lens elements of the second lens assembly are cemented to each other;
wherein the focal length of the photography optical system when corresponding to the infinite object distance is fL, an entrance pupil diameter of the photography optical system is EPD, a composite focal length of the first lens element and the second lens element is f12, a composite focal length of the second lens element and the third lens element is f23, and the following conditions are satisfied:
$$1.4 < fL / EPD < 3.5 ;$$
$$and$$
$$- 0.25 < f 12 / f 23 < 2.4 .$$

4. The photography optical system of claim 1, wherein a curvature radius of the object-side surface of the first lens element is R1, a curvature radius of the object-side surface of the second lens element is R3, the focal length of the photography optical system when corresponding to the infinite object distance is fL, a focal length of the fifth lens element is f5, a focal length of the sixth lens element counting from the object side among the photography optical system is f6, a minimum value of fL/f5 and fL/f6 is MIN (fL/f5,fL/f6), and the following conditions are satisfied:
$$- 0.5 \; 0 < ( R 1 - R 3 ) / ( R 1 + R 3 ) < 0 \text{.70} ;$$
$$and$$
$$- 11.2 < MIN ( fL / f 5 , fL / f 6 ) < - 2. .$$

5. The photography optical system of claim 1, wherein a central thickness of the first lens element is CT1, a central thickness of a second lens element counting from the image side among the photography optical system is CTlast2, the curvature radius of the object-side surface of the third lens element is R5, the curvature radius of the image-side surface of the third lens element is R6, the focal length of the photography optical system when corresponding to the infinite object distance is fL, and the following conditions are satisfied:
$$0.03 < CTlast 2 / CT 1 < 0.8 ;$$
$$and$$
$$0.2 < ( R 5 + R 6 ) / fL < 1.2 .$$

6. The photography optical system of claim 1, wherein the focal length of the photography optical system when corresponding to the infinite object distance is fL, an axial distance between the object-side surface of the first lens element and an image surface is TL, and the following condition is satisfied:
$$1.15 < fL / TL < 2.00 .$$

7. The photography optical system of claim 1, wherein all lens elements of the photography optical system comprise at least one spherical lens element and at least one aspheric lens element, and the photography optical system focuses by moving at least one lens element thereof;
wherein the focal length of the photography optical system when corresponding to the infinite object distance is fL, the focal length of i-th lens element counting from the object side among the photography optical system is fi, the minimum value of fL/fi is MIN (fL/fi), and the following condition is satisfied:
−11.70<MIN (fL/fi)<−5.00, wherein i is a positive integer, and 1≤i≤the total number of lens elements of the photography optical system.

8. The photography optical system of claim 1, wherein the focal length of the photography optical system when corresponding to the infinite object distance is fL, a focal length of the third lens element is f3, the maximum value among axial distances between each of all adjacent lens elements of the photography optical system when corresponding to the infinite object distance is ATLmax, the maximum image height of the photography optical system is ImgH, and the following conditions are satisfied:
$$0 < \vert fL / f 3 \vert < 2.2 ;$$
$$and$$
$$1.15 < ATL max / ImgH < 4.5 .$$

9. The photography optical system of claim 1, wherein the total number of lens elements of the photography optical system is at least seven, and a seventh lens element counting from the object side among the photography optical system has negative refractive power;
wherein a focal length of the third lens element is f3, a focal length of a second lens element counting from the image side among the photography optical system is flast2, an axial distance between the first lens element and the second lens element is T12, an axial distance between the second lens element and the third lens element is T23, and the following conditions are satisfied:
$$- 6.5 \; 0 < flast 2 / f 3 < 0 \text{.70} ;$$
$$and$$
$$0.01 < T 12 / T 23 < 2.00 .$$

10. The photography optical system of claim 1, wherein the focal length of the photography optical system when corresponding to the infinite object distance is fL, the maximum image height of the photography optical system is ImgH, and the following conditions are satisfied:
$$50. mm < fL < 80. mm ;$$
$$and$$
$$3. mm < ImgH < 5.5 mm .$$

11. The photography optical system of claim 1, wherein a composite focal length of the first lens element and the second lens element is f12, a composite focal length of the fifth lens element and the sixth lens element counting from the object side among the photography optical system is f56, the focal length of the photography optical system when corresponding to the infinite object distance is fL, a chief ray angle at the maximum image height of the photography optical system when corresponding to the infinite object distance is CRAL, half of a maximum field of view of the photography optical system when corresponding to the infinite object distance is HFOVL, and the following conditions are satisfied:
$$- 4.3 \; 0 < f 12 / f 56 < 0 \text{.30} ;$$
$$and$$
$$3. [ mm / degrees ] < fL / ( CRAL + HFOVL ) < 15. [ mm / degrees ] .$$

12. The photography optical system of claim 1, wherein the total number of lens elements of the second lens assembly is six;
wherein a maximum effective radius of a lens surface of the first lens assembly closest to the image side among the photography optical system when corresponding to the infinite object distance is YLA1Rlast, a maximum effective radius of a lens surface of the second lens assembly closest to the object side among the photography optical system when corresponding to the infinite object distance is YLA2R1, a distance in parallel with an optical axis between a maximum effective radius position of the lens surface of the first lens assembly closest to the image side and a maximum effective radius position of the lens surface of the second lens assembly closest to the object side among the photography optical system when corresponding to the infinite object distance is ETLA12, and the following condition is satisfied:
$$0.27 < ( YLA 1 Rlast - YLA 2 R 1 ) / ETLA 12 < 0.75 .$$

13. The photography optical system of claim 1, wherein a lens element having a minimum effective radius among all lens elements of the photography optical system when corresponding to the infinite object distance is a second lens element counting from the image side among the photography optical system or a third lens element counting from the image side among the photography optical system;
wherein a maximum value among central thicknesses of all lens elements of the photography optical system is CTmax, the maximum value among axial distances between each of all adjacent lens elements of the photography optical system when corresponding to the infinite object distance is ATLmax, and the following condition is satisfied:
$$0. 25 < CT max / ATL max < 1. .$$

14. An image capturing unit comprising:
the photography optical system of claim 1; and
an image sensor disposed on an image surface of the photography optical system.

15. A photography optical system comprising, in order from an object side to an image side along an optical path, a first lens assembly, an aperture stop and a second lens assembly, each lens element of the photography optical system having an object-side surface facing toward the object side and an image-side surface facing toward the image side;
wherein a total number of lens elements of the first lens assembly is one to three, a total number of lens elements of the second lens assembly is five to eight, and there is no additional lens element disposed between the first lens assembly and the second lens assembly;
wherein the first lens assembly comprises a first lens element closest to the object side, the second lens assembly comprises a last lens element closest to the image side, the photography optical system further comprises, in order from the first lens element to the last lens element along the optical path, a second lens element, a third lens element, a fourth lens element and a fifth lens element, and there is no additional lens element disposed between the first lens element and the fifth lens element;
wherein the first lens assembly has positive refractive power, and the second lens assembly has negative refractive power;
wherein the object-side surface of the first lens element is convex in a paraxial region thereof, the object-side surface of the second lens element is convex in a paraxial region thereof, the object-side surface of the third lens element is convex in a paraxial region thereof, the image-side surface of the third lens element is concave in a paraxial region thereof, and the object-side surface of the fourth lens element is convex in a paraxial region thereof;
wherein a focal length of the photography optical system when corresponding to an infinite object distance is fL, a focal length of i-th lens element counting from the object side among the photography optical system is fi, a minimum value of fL/fi is MIN (fL/fi), a focal length of the first lens assembly is fA1, a maximum value among central thicknesses of all lens elements of the photography optical system is CTmax, a maximum value among axial distances between each of all adjacent lens elements of the photography optical system when corresponding to the infinite object distance is ATLmax, and the following conditions are satisfied:
−15.00<MIN (fL/fi)<−2.80, wherein i is a positive integer, and 1≤i≤a total number of lens elements of the photography optical system;
$$1.2 < fL / fA 1 < 3. ;$$
$$and$$
$$0.2 < CT max / ATL max < 1.5 .$$

16. The photography optical system of claim 15, wherein the total number of lens elements of the second lens assembly is at least six;
wherein the focal length of the photography optical system when corresponding to the infinite object distance is fL, the focal length of i-th lens element counting from the object side among the photography optical system is fi, the minimum value of fL/fi is MIN (fL/fi), and the following condition is satisfied:
−12.50<MIN (fL/fi)<−4.30, wherein i is a positive integer, and 1≤i≤the total number of lens elements of the photography optical system.

17. The photography optical system of claim 15, wherein the focal length of the photography optical system when corresponding to the infinite object distance is fL, an axial distance between the object-side surface of the first lens element and an image surface is TL, and the following condition is satisfied:
$$1.2 < fL / TL < 1.8 .$$

18. The photography optical system of claim 15, wherein the focal length of the photography optical system when corresponding to the infinite object distance is fL, the focal length of the first lens assembly is fA1, a focal length of the second lens element is f2, a focal length of the fourth lens element is f4, and the following conditions are satisfied:
$$1.35 < fL / fA 1 < 2.65 ;$$
$$and$$
$$- 0.2 < f 4 / f 2 < 0.85 .$$

19. The photography optical system of claim 15, wherein a composite focal length of the first lens element and the second lens element is f12, a composite focal length of the second lens element and the third lens element is f23, and the following condition is satisfied:
$$- 0.35 < f 12 / f 23 < 3. .$$

20. The photography optical system of claim 15, wherein all lens elements of the photography optical system comprise at least two glass lens elements and at least two plastic lens elements;
wherein the focal length of the photography optical system when corresponding to the infinite object distance is fL, a focal length of the fifth lens element is f5, a focal length of a sixth lens element counting from the object side among the photography optical system is f6, a minimum value of fL/f5 and fL/f6 is MIN (fL/f5,fL/f6), and the following condition is satisfied:
$$- 13.5 < MIN ( fL / f 5 , f L / f 6 ) < - 1. .$$

21. The photography optical system of claim 15, wherein a curvature radius of the object-side surface of the third lens element is R5, a curvature radius of the image-side surface of the third lens element is R6, the focal length of the photography optical system when corresponding to the infinite object distance is fL, a composite focal length of the first lens element and the second lens element is f12, a composite focal length of the fifth lens element and a sixth lens element counting from the object side among the photography optical system is f56, and the following conditions are satisfied:
$$0.05 < ( R 5 + R 6 ) / f L < 3. ; and$$
$$- 3.3 < f 12 / f 56 < 0 .$$

22. The photography optical system of claim 15, wherein a curvature radius of the object-side surface of the third lens element is R5, a curvature radius of the object-side surface of a first lens element counting from the image side among the photography optical system is Rlast2, and the following condition is satisfied:
$$- 1.5 < R 5 / R last 2 < 5. .$$

23. The photography optical system of claim 15, wherein half of a maximum field of view of the photography optical system when corresponding to the infinite object distance is HFOVL, the focal length of the photography optical system when corresponding to the infinite object distance is fL, a focal length of the third lens element is f3, and the following conditions are satisfied:
$$1.5 degrees < HFOVL << 6. degrees ; and$$
$$0.01 < \vert fL / f 3 \vert < 2.1 .$$

24. The photography optical system of claim 15, wherein the second lens assembly comprises, in order from the object side to the image side along the optical path, a convex-concave lens element, a chromatic-aberration-correction lens assembly and an aspheric lens element, the chromatic-aberration-correction lens assembly has negative refractive power, and the chromatic-aberration-correction lens assembly consists of, in order from the object side to the image side along the optical path, a biconvex positive lens element and a biconcave negative lens element.

25. The photography optical system of claim 15, wherein the total number of lens elements of the first lens assembly is two, the photography optical system performs a focus process for focusing by moving at least one lens element of the second lens assembly, the photography optical system has at least two photography states through the focus process, and an object distance corresponding to the photography optical system in one of the at least two photography states is 15000 mm or less;
wherein an entrance pupil diameter of the photography optical system is EPD, the following condition is satisfied:
$$15. mm < EPD < 32. mm .$$

26. The photography optical system of claim 15, wherein a distance in parallel with an optical axis between a maximum effective radius position of the object-side surface of the third lens element and a maximum effective radius position of the image-side surface of the third lens element among the photography optical system when corresponding to the infinite object distance is ETL3, a distance in parallel with the optical axis between a maximum effective radius position of the object-side surface of the last lens element and a maximum effective radius position of the image-side surface of the last lens element among the photography optical system when corresponding to the infinite object distance is ETLlast, a central thickness of the third lens element is CT3, a central thickness of the last lens element is CTlast, and the following conditions are satisfied:
$$0.15 < ETL 3 / CT 3 < 3. ; and$$
$$0.15 < ETLlast / CTlast < 2. .$$

27. The photography optical system of claim 15, wherein an axial distance between the first lens element and the second lens element is T12, a distance in parallel with an optical axis between a maximum effective radius position of the image-side surface of the first lens element and a maximum effective radius position of the object-side surface of the second lens element among the photography optical system when corresponding to the infinite object distance is ETL12, and the following condition is satisfied:
$$0.05 < 10 \times T 12 / ETL 12 < 3.5 .$$

28. The photography optical system of claim 15, wherein the focal length of the photography optical system when corresponding to the infinite object distance is fL, the focal length of i-th lens element counting from the object side among the photography optical system is fi, the minimum value of fL/fi is MIN (fL/fi), a focal length of the second lens element is f2, a focal length of the fifth lens element is f5, a focal length of a sixth lens element counting from the object side among the photography optical system is f6, a minimum value of fL/f5 and fL/f6 is MIN (fL/f5,fL/f6), a curvature radius of the object-side surface of the third lens element is R5, a curvature radius of the image-side surface of the third lens element is R6, a curvature radius of the object-side surface of a first lens element counting from the image side among the photography optical system is Rlast2, the maximum value among axial distances between each of all adjacent lens elements of the photography optical system when corresponding to the infinite object distance is ATLmax, a maximum image height of the photography optical system is ImgH, the focal length of the first lens assembly is fA1, the maximum value among central thicknesses of all lens elements of the photography optical system is CTmax, half of a maximum field of view of the photography optical system when corresponding to the infinite object distance is HFOVL, and the following conditions are satisfied:
−11.51≤MIN (fL/fi)≤−5.16, wherein i is a positive integer, and 1≤i≤the total number of lens elements of the photography optical system;
$$- 11.51 \leq MIN ( fL / f 5 , fL / f 6 ) \leq - 2.33 ;$$
$$0.32 \leq ( R 5 + R 6 ) / fL \leq 0.95 ;$$
$$1.3 \leq AT Lmax / ImgH \leq 3.3 ;$$
$$1. 49 \leq fL / fA 1 \leq 2.48 ;$$
$$0.38 \leq CTmax / ATLmax \leq 0 \text{.86} ;$$
$$- 0.2 \; 9 \leq R 5 / Rlast 2 \leq 1.91 ;$$
$$- 0.5 \; 0 \leq fL / f 2 \leq 1.87 ; and$$
$$3. degrees \leq HFOVL \leq 4.9 degrees .$$

29. A photography optical system comprising a plurality of lens elements, a total number of the plurality of lens elements being eight to nine, the plurality of lens elements comprising, in order from an object side to an image side along an optical path, a first lens element, a second lens element, a third lens element, a fourth lens element, a fifth lens element, a sixth lens element, a seventh lens element and an eighth lens element, and each lens element of the plurality of lens elements having an object-side surface facing toward the object side and an image-side surface facing toward the image side;
wherein the first lens element is a lens element closest to the object side among all lens elements of the photography optical system, and there is no additional lens element disposed between the first lens element through the eighth lens element;
wherein the first lens element has positive refractive power, the object-side surface of the second lens element is convex in a paraxial region thereof, the object-side surface of the third lens element is convex in a paraxial region thereof, the image-side surface of the third lens element is concave in a paraxial region thereof, and the object-side surface of the fourth lens element is convex in a paraxial region thereof;
wherein the photography optical system further comprises an aperture stop located between the first lens element and the fourth lens element;
wherein a focal length of the photography optical system when corresponding to an infinite object distance is fL, a focal length of i-th lens element counting from the object side among the photography optical system is fi, a minimum value of fL/fi is MIN (fL/fi), a focal length of the second lens element is f2, a curvature radius of the object-side surface of the third lens element is R5, a curvature radius of the object-side surface of a first lens element counting from the image side among the photography optical system is Rlast2, half of a maximum field of view of the photography optical system when corresponding to the infinite object distance is HFOVL, and the following conditions are satisfied:
−13.80<MIN (fL/fi)<−3.80, wherein i is a positive integer, and 1≤i≤a total number of lens elements of the photography optical system;
$$- 1. < R 5 / R l a s t 2 < 4.5 ;$$
$$- 1.5 < fL / f 2 < 4.5 ; and$$
$$1. degrees < HFOVL < 7.5 degrees .$$

30. The photography optical system of claim 29, wherein the total number of the plurality of lens elements is eight;
wherein a maximum image height of the photography optical system is ImgH, an entrance pupil diameter of the photography optical system is EPD, a maximum effective radius of the object-side surface of the first lens element of the photography optical system when corresponding to the infinite object distance is YL1R1, a maximum effective radius of the image-side surface of the eighth lens element of the photography optical system when corresponding to the infinite object distance is YL8R2, and the following conditions are satisfied:
$$0. 10 < 2 \times ImgH / EPD < 0.7 ; and$$
$$2. < YL 1 R 1 / YL 8 R 2 < 4.00 .$$

31. The photography optical system of claim 30, wherein the image-side surface of the fifth lens element is concave in a paraxial region thereof;
wherein the curvature radius of the object-side surface of the third lens element is R5, the curvature radius of the object-side surface of a first lens element counting from the image side among the photography optical system is Rlast2, and the following condition is satisfied:
$$- 0.60 < R 5 / R l a s t 2 < 2.30 .$$

32. The photography optical system of claim 30, wherein an Abbe number of the sixth lens element is V6, a refractive index of the sixth lens element is N6, the focal length of the photography optical system when corresponding to the infinite object distance is fL, a focal length of the fourth lens element is f4, and the following conditions are satisfied:
$$5. < V 6 / N 6 < 14.8 ; and$$
$$2.5 < fL / f 4 < 5.2 .$$

33. The photography optical system of claim 30, wherein the second lens element has positive refractive power, the fourth lens element has positive refractive power, the fifth lens element has negative refractive power, the seventh lens element has negative refractive power, and the eighth lens element has positive refractive power.

34. The photography optical system of claim 29, wherein the total number of the plurality of lens elements is nine;
wherein an axial distance between the first lens element and the second lens element is T12, an axial distance between the second lens element and the third lens element is T23, and the following condition is satisfied:
$$0 < T 12 / T 23 < 4.00 .$$

35. The photography optical system of claim 34, wherein a maximum value among axial distances between each of all adjacent lens elements of the photography optical system when corresponding to the infinite object distance is ATLmax, a maximum image height of the photography optical system is ImgH, the focal length of the photography optical system when corresponding to the infinite object distance is fL, the focal length of the second lens element is f2, and the following conditions are satisfied:
$$1.2 < A T Lmax / ImgH < 3.5 ; and$$
$$- 0.8 \; 0 < f L / f 2 < 2.2 .$$

36. The photography optical system of claim 34, wherein an axial distance between the fifth lens element and the sixth lens element is T56, a central thickness of the fourth lens element is CT4, a central thickness of the fifth lens element is CT5, a central thickness of the sixth lens element is CT6, and the following condition is satisfied:
$$0.05 < ( T 56 + C T 6 ) / ( C T 4 + C T 5 ) < 0.75 .$$
